(19) United States
(12) Patent Application Publication
(10) Pub. No.: US 2018/0223184 A1
(43) Pub. Date: Aug. 9, 2018

(54) ORGANIC ELECTROLUMINESCENT COMPOUNDS AND ORGANIC ELECTROLUMINESCENT DEVICE COMPRISING THE SAME

(71) Applicant: Rohm and Haas Electronic Materials Korea Ltd., Cheonan (KR)

(72) Inventors: Doo-Hyeon Moon, Hwaseong (KR); Jae-Hoon Shim, Seoul (KR)

(21) Appl. No.: 15/747,893

(22) PCT Filed: Aug. 2, 2016
(86) PCT No.: PCT/KR16/08476

§ 371 Date: Jan. 26, 2018

(30) Foreign Application Priority Data
Sep. 10, 2015 (KR) 10-2015-0128139
Jul. 14, 2016 (KR) 10-2016-0089063

(51) Int. Cl. C09K 11/06

(52) U.S. Cl. CPC C09K 11/06; C09K 2211/1029; C09K 2211/1092; C09K 2211/1059; C09K 2211/1088; C09K 2211/1044

(57) ABSTRACT

The present disclosure relates to an organic electroluminescent compound and an organic electroluminescent device comprising the same. The organic electroluminescent compound of the present disclosure is effective in preparing an organic electroluminescent device having low driving voltage and good current and power efficiencies.

### TECHNICAL FIELD

The present disclosure relates to an organic electroluminescent compound and an organic electroluminescent device comprising the same.

### BACKGROUND ART

An electroluminescent (EL) device is a self-light-emitting device which has advantages in that it provides a wider viewing angle, a greater contrast ratio, and a faster response time. An organic EL device was first developed by Eastman Kodak, by using small aromatic diamine molecules and aluminum complexes as materials to form a light-emitting layer [Appl. Phys. Lett. 51, 913, 1987].

The organic EL device(OLED) converts electric energy into light when electricity is applied to an organic light-emitting material(s). Generally, the organic EL device has a structure comprising an anode, a cathode, and an organic layer disposed between the anode and the cathode. The organic layer of the organic EL device comprises a hole injection layer, a hole transport layer, an electron blocking layer, a light-emitting layer (comprising a host material and a dopant material), an electron buffering layer, a hole blocking layer, an electron transport layer, an electron injection layer, etc. Depending on its function, materials for forming the organic layer can be classified as a hole injection material, a hole transport material, an electron blocking material, a light-emitting material, an electron buffering material, a hole blocking material, an electron transport material, an electron injection material, etc. When a voltage is applied to the organic EL device, holes and electrons are injected from an anode and a cathode, respectively, to the light-emitting layer. Excitons having high energy are formed by recombinations between the holes and the electrons, the energy puts the organic light-emitting compound in an excited state, and the decay of the excited state results in a relaxation of the energy level into a ground state, accompanied by light-emission.

The most important factor determining luminous efficiency in the organic EL device is light-emitting materials. The light-emitting material needs to have high quantum efficiency, high electron mobility, and high hole mobility. Furthermore, the light-emitting layer formed by the light-emitting material needs to be uniform and stable. Depending on the colors visualized by light-emission, the light-emitting materials can be classified as a blue-, green-, or red-emitting material, and can additionally include a yellow- or orange-emitting material. Furthermore, the light-emitting material can be classified according to its function, as a host material and a dopant material. Recently, the development of OLED providing high efficiency and a long lifespan is urgent. In particular, considering EL requirements for a middle or large-sized OLED panel, materials showing better performance than conventional ones must be urgently developed. In order to achieve the development, a host material which plays a role as a solvent in a solid state and transfers energy, should have high purity, and an appropriate molecular weight for being deposited under a vacuum. In addition, a host material should have high glass transition temperature and high thermal decomposition temperature to ensure thermal stability; high electrochemical stability to have a long lifespan; ease of preparation for amorphous thin film; and good adhesion to materials of adjacent layers. Furthermore, a host material should not move to an adjacent layer.

Japanese Patent Application Laying-Open No. 2014-160813 discloses a nitrogen-containing heterocyclic compound formed by condensing a pyrrole ring, an aromatic ring, and a 7-membered ring, and an organic electroluminescent element comprising the same. However, it does not disclose the compounds of the present disclosure, but discloses the compounds wherein aryl is fused to the backbone or that have the fusion positions different from those of the compounds of the present disclosure.

As a result of a study for finding new compounds that can provide an organic electroluminescent device with superior performance compared to the conventional organic light-emitting compounds, the present inventors found that compounds of the present disclosure can provide good device performances including high luminous and power efficiencies.

### DISCLOSURE OF THE INVENTION

### Problems to be Solved

The objective of the present disclosure is to provide an organic electroluminescent compound, which is effective in preparing an organic electroluminescent device having low driving voltage, good luminous and power efficiencies, and a remarkably improved lifespan.

### Solution to Problems

As a result of an earnest study for solving the above-described problems, the present inventors found that the above objective can be achieved by an organic electroluminescent compound represented by the following formula 1 and have come to complete the present disclosure.

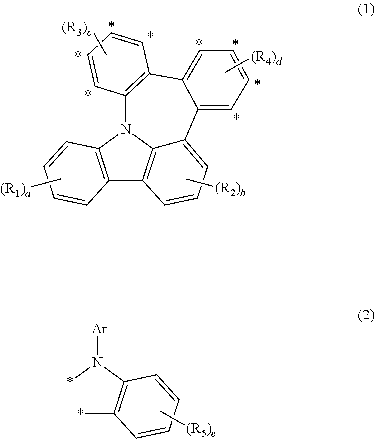

In formula 1,

each of two adjacent * of one phenyl ring of formula 1 is bonded to each of two * of formula 2, and

in formulae 1 and 2,

R₁ to R₅, each independently, represent hydrogen, deuterium, a halogen, a cyano, a carboxy, a nitro, a hydroxy, a substituted or unsubstituted (C1-C30)alkyl, a substituted or unsubstituted (C3-C30)cycloalkyl, a substituted or unsubstituted (C3-C30)cycloalkenyl, a substituted or unsubstituted (3 to 7-membered)heterocycloalkyl, a substituted or unsubstituted (C6-C30)aryl, a substituted or unsubstituted (3 to 30-membered)heteroaryl, —NR₆R₇ or —SiR₈R₉R₁₀, or may be linked to an adjacent substituent(s) to form a substituted or unsubstituted (C3-C30), mono- or polycyclic, alicyclic or aromatic ring, whose carbon atom(s) may be replaced with at least one hetero atom selected from nitrogen, oxygen, and sulfur; and

R₆ to R₁₀, each independently, represent hydrogen, deuterium, a halogen, a cyano, a carboxy, a nitro, a hydroxy, a substituted or unsubstituted (C1-C30)alkyl, a substituted or unsubstituted (C3-C30)cycloalkyl, a substituted or unsubstituted (C3-C30)cycloalkenyl, a substituted or unsubstituted (3 to 7-membered)heterocycloalkyl, a substituted or unsubstituted (C6-C30)aryl, or a substituted or unsubstituted (3 to 30-membered)heteroaryl;

Ar₁ represents a substituted or unsubstituted (C6-C30)aryl, or a substituted or unsubstituted (3 to 30-membered)heteroaryl;

a, c, d and e, each independently, represent an integer of 1 to 4; b represents an integer of 1 to 3; and

the heteroaryl contains at least one hetero atom selected from B, N, O, S, Si and P.

### Effects of the Invention

The organic electroluminescent compounds of the present disclosure have an advantage in that when they are used as a host of a light-emitting layer, they can provide an organic electroluminescent device having low driving voltage, and remarkably improved luminous efficiency and lifespan, compared to conventional organic light-emitting compounds. In particular, the organic electroluminescent compounds of the present disclosure can provide an organic electroluminescent device having low driving voltage and high current and power efficiencies.

### Embodiments of the Invention

Hereinafter, the present disclosure will be described in detail. However, the following description is intended to explain the disclosure, and is not meant in any way to restrict the scope of the disclosure.

The present disclosure provides the organic electroluminescent compound of formula 1 above, an organic electroluminescent material comprising the same, and an organic electroluminescent device comprising the material.

In formulae 1 and 2, R₁ to R₅, each independently, represent hydrogen, deuterium, a halogen, a cyano, a carboxy, a nitro, a hydroxy, a substituted or unsubstituted (C1-C30)alkyl, a substituted or unsubstituted (C3-C30)cycloalkyl, a substituted or unsubstituted (C3-C30) cycloalkenyl, a substituted or unsubstituted (3 to 7-membered)heterocycloalkyl, a substituted or unsubstituted (C6-C30)aryl, a substituted or unsubstituted (3 to 30-membered)heteroaryl, —NR₆R₇ or —SiR₈R₉R₁₀, or may be linked to an adjacent substituent(s) to form a substituted or unsubstituted (C3-C30), mono- or polycyclic, alicyclic or aromatic ring, whose carbon atom(s) may be replaced with at least one hetero atom selected from nitrogen, oxygen, and sulfur; preferably, each independently, may represent hydrogen, deuterium, a substituted or unsubstituted (C1-C20)alkyl, a substituted or unsubstituted (C3-C20)cycloalkyl, a substituted or unsubstituted (C3-C20)cycloalkenyl, a substituted or unsubstituted (C6-C20)aryl, a substituted or unsubstituted (3 to 20-membered)heteroaryl, or —NR₆R₇, or may be linked to an adjacent substituent(s) to form a substituted or unsubstituted (C3-C20), mono- or polycyclic, alicyclic or aromatic ring, whose carbon atom(s) may be replaced with at least one hetero atom selected from nitrogen, oxygen, and sulfur; more preferably, each independently, may represent hydrogen, or an unsubstituted (C6-C18)aryl, or may be linked to an adjacent substituent(s) to form an unsubstituted (C3-C18) mono- or polycyclic, aromatic ring; and specifically, each independently, may represent hydrogen or an unsubstituted phenyl, or may be linked to an adjacent substituent(s) to form an unsubstituted benzene ring.

In formulae 1 and 2, R₆to R₁₀, each independently, represent hydrogen, deuterium, a halogen, a cyano, a carboxy, a nitro, a hydroxy, a substituted or unsubstituted (C1-C30)alkyl, a substituted or unsubstituted (C3-C30)cycloalkyl, a substituted or unsubstituted (C3-C30)cycloalkenyl, a substituted or unsubstituted (3 to 7-membered)heterocycloalkyl, a substituted or unsubstituted (C6-C30)aryl, or a substituted or unsubstituted (3 to 30-membered)heteroaryl; preferably, each independently, may represent a substituted or unsubstituted (C1-C20)alkyl, a substituted or unsubstituted (C3-C20)cycloalkyl, a substituted or unsubstituted (C3-C20)cycloalkenyl, a substituted or unsubstituted (C6-C20)aryl, or a substituted or unsubstituted (3 to 20-membered)heteroaryl.

In formula 2, Ar₁ represents a substituted or unsubstituted (C6-C30)aryl, or a substituted or unsubstituted (3 to 30-membered)heteroaryl; preferably, a substituted or unsubstituted (C6-C25)aryl, or a substituted or unsubstituted (3 to 25-membered)heteroaryl; more preferably, a substituted or unsubstituted (C6-C25)aryl, or a substituted or unsubstituted, nitrogen-, oxygen- or sulfur-containing (5 to 20-membered)heteroaryl; specifically, a substituted or unsubstituted phenyl, a substituted or unsubstituted naphthyl, a substituted or unsubstituted biphenyl, a substituted or unsubstituted anthracenyl, a substituted or unsubstituted terphenyl, a substituted or unsubstituted phenylnaphthyl, a substituted or unsubstituted naphthylphenyl, a substituted or unsubstituted fluorenyl, a substituted or unsubstituted spiro bifluorenyl, a substituted or unsubstituted pyridyl, a substituted or unsubstituted pyrimidinyl, a substituted or unsubstituted triazinyl, a substituted or unsubstituted quinolyl, a substituted or unsubstituted isoquinolyl, a substituted or unsubstituted quinoxalinyl, a substituted or unsubstituted quinazolinyl, a substituted or unsubstituted dibenzofuranyl, or a substituted or unsubstituted dibenzothiophenyl, wherein the substituents thereof may be at least one selected from a (C1-C10)alkyl, phenyl, biphenyl, naphthyl, anthracenyl, terphenyl, phenylnaphthyl, naphthylphenyl, fluorenyl substituted or unsubstituted with a (C1-C10)alkyl or a (C6-C30)aryl, pyridyl substituted or unsubstituted with a (C1-C10)alkyl or a (C6-C30)aryl, pyrimidinyl substituted or unsubstituted with a (C1-C10)alkyl or a (C6-C30)aryl, triazinyl substituted or unsubstituted with a (C1-C10)alkyl or a (C6-C30)aryl, quinolyl substituted or unsubstituted with a (C1-C10)alkyl or a (C6-C30)aryl, isoquinolyl substituted or unsubstituted with a (C1-C10)alkyl or a (C6-C30)aryl, quinoxalinyl substituted or unsubstituted with a (C1-C10)alkyl or a (C6-C30)aryl, quinazolinyl substituted or unsubstituted with a (C1-C10)alkyl or a (C6-C30)aryl, and a di(C6-C30)arylamino.

In formulae 1 and 2, a, c, d and e, each independently, represent an integer of 1 to 4, and b represents an integer of 1 to 3. Preferably, a to e, each independently, may represent 1 or 2.

The compound of formula 1 of the present disclosure may be represented by the following formulae 3 to 6:

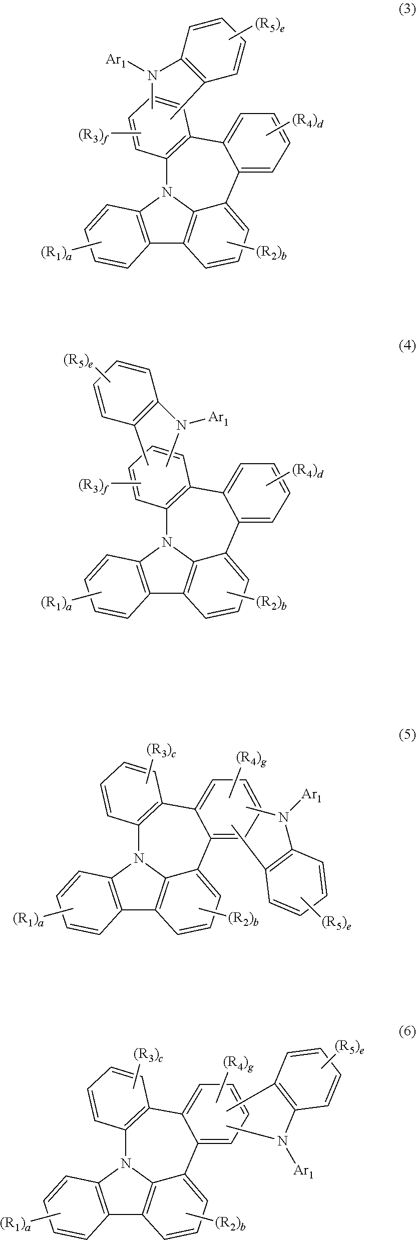

In formulae 3 to 6, f and g, each independently, represent an integer of 1 or 2.

In formulae 3 to 6, R₁ to R₅, Ar₁, a, b, c, d and e are as defined in formula 1 above.

Herein, “(C1-C30)alkyl” indicates a linear or branched alkyl having 1 to 30, preferably 1 to 20, and more preferably 1 to 10 carbon atoms, and includes methyl, ethyl, n-propyl, isopropyl, n-butyl, isobutyl, tert-butyl, etc. “(C2-C30) alkenyl” indicates a linear or branched alkenyl having 2 to 30, preferably 2 to 20, and more preferably 2 to 10 carbon atoms and includes vinyl, 1-propenyl, 2-propenyl, 1-butenyl, 2-butenyl, 3-butenyl, 2-methylbut-2-enyl, etc. “(C2-C30)alkynyl” indicates a linear or branched alkynyl having 2 to 30, preferably 2 to 20, and more preferably 2 to 10 carbon atoms and includes ethynyl, 1-propynyl, 2-propynyl, 1-butynyl, 2-butynyl, 3-butynyl, 1-methylpent-2-ynyl, etc. Herein, “(C1-C30)alkoxy” indicates a linear or branched alkoxy having 1 to 30, preferably 1 to 20, and more preferably 1 to 10 carbon atoms, and includes methoxy, ethoxy, propoxy, isopropoxy, 1-ethylpropoxy, etc. Herein, “(C3-C30)cycloalkyl” indicates a mono- or polycyclic hydrocarbon having 3 to 30, preferably 3 to 20, more preferably 3 to 7 ring backbone carbon atoms. The cycloalkyl includes cyclopropyl, cyclobutyl, cyclopentyl, cyclohexyl, etc. Herein, “(3 to 7-membered)heterocycloalkyl” indicates a cycloalkyl having 3 to 7 ring backbone atoms including at least one hetero atom selected from B, N, O, S, Si, and P, preferably O, S, and N, and includes pyrrolidine, thiolan, tetrahydropyran, etc. Herein, “(C6-C30)aryl(ene)” indicates a monocyclic ring-type or fused ring-type radical derived from aromatic hydrocarbon having 6 to 30, preferably 6 to 20, more preferably 6 to 15 ring backbone carbon atoms. The aryl may include aryl having a spiro structure. The aryl includes phenyl, biphenyl, terphenyl, naphthyl, fluorenyl, phenanthrenyl, anthracenyl, indenyl, triphenylenyl, pyrenyl, tetracenyl, perylenyl, chrysenyl, naphthacenyl, fluoranthenyl, etc. Herein, “(3 to 30-membered)heteroaryl(ene)” indicates an aryl group having 3 to 30, preferably 3 to 20, more preferably 3 to 15 ring backbone atoms including at least one, preferably 1 to 4, hetero atom selected from the group consisting of B, N, O, S, Si, and P; may be a monocyclic ring, or a fused ring condensed with at least one benzene ring; may be partially saturated; may be one formed by linking at least one heteroaryl or aryl group to a heteroaryl group via a single bond(s); and includes a monocyclic ring-type heteroaryl such as furyl, thiophenyl, pyrrolyl, imidazolyl, pyrazolyl, thiazolyl, thiadiazolyl, isothiazolyl, isoxazolyl, oxazolyl, oxadiazolyl, triazinyl, tetrazinyl, triazolyl, tetrazolyl, furazanyl, pyridyl, pyrazinyl, pyrimidinyl, pyridazinyl, etc., and a fused ring-type heteroaryl such as benzofuranyl, benzothiophenyl, isobenzofuranyl, dibenzofuranyl, dibenzothiophenyl, benzoimidazolyl, benzothiazolyl, benzoisothiazolyl, benzoisoxazolyl, benzoxazolyl, isoindolyl, indolyl, indazolyl, benzothiadiazolyl, quinolyl, isoquinolyl, cinnolinyl, quinazolinyl, quinoxalinyl, carbazolyl, phenoxazinyl, phenanthridinyl, benzodioxolyl, etc. Further, “halogen” includes F, Cl, Br, and I.

Furthermore, herein, “substituted” in the expression, “substituted or unsubstituted,” means that a hydrogen atom in a certain functional group is replaced with another atom or group, i.e. a substituent. In R₁ to R₁₀ and Ar₁, the substituent of the substituted (C1-C30)alkyl, the substituted (C3-C30)cycloalkyl, the substituted (C3-C30)cycloalkenyl, the substituted (3 to 7-membered)heterocycloalkyl, the substituted (C6-C30)aryl, the substituted (3 to 30-membered)heteroaryl, and the substituted (C3-C30) mono- or polycyclic alicyclic or aromatic ring, each independently, is at least one selected from the group consisting of deuterium, a halogen, a cyano, a carboxy, a nitro, a hydroxy, a (C1-C30)alkyl, a halo(C1-C30)alkyl, a (C2-C30)alkenyl, a (C2-C30) alkynyl, a (C1-C30)alkoxy, a (C1-C30)alkylthio, a (C3-C30)cycloalkyl, a (C3-C30)cycloalkenyl, a (3 to 7-membered)heterocycloalkyl, a (C6-C30)aryloxy, a (C6-C30)arylthio, a (5 to 30-membered)heteroaryl substituted or unsubstituted with a (C6-C30)aryl, a (C6-C30)aryl substituted or unsubstituted with a (5 to 30-membered)heteroaryl, a tri(C1-C30)alkylsilyl, a tri(C6-C30)arylsilyl, a di(C1-C30)alkyl(C6-C30)arylsilyl, a (C1-C30)alkyldi(C6-C30)arylsilyl, an amino, a mono- or di-(C1-C30)alkylamino, a mono- or di-(C6-C30)arylamino, a (C1-C30)alkyl(C6-C30)arylamino, a (C1-C30)alkylcarbonyl, a (C1-C30)alkoxycarbonyl, a (C6-C30)arylcarbonyl, a di(C6-C30)arylboronyl, a di(C1-C30)alkylboronyl, a (C1-C30)alkyl(C6-C30)arylboronyl, a (C6-C30)aryl(C1-C30)alkyl, and a (C1-C30)alkyl(C6-C30)aryl; preferably, each independently, may be an unsubstituted (C6-C20)aryl, a (5 to 20-membered)heteroaryl substituted with a (C6-C20)aryl, a di(C6-C20)arylamino, or a di(C1-C20)alkyl(C6-C20)aryl; more preferably, each independently, may be an unsubstituted (C6-C18)aryl, a (5 to 18-membered)heteroaryl substituted with a (C6-C12)aryl, a di(C6-C18)arylamino, or a di(C1-C10)alkyl(C6-C18)ary; and more specifically, each independently, may be an unsubstituted phenyl, an unsubstituted biphenyl, triazinyl substituted with phenyl, quinoxalinyl substituted with phenyl, a di(C6-C18)arylamino, or dimethylfluorenyl.

According to one embodiment of the present disclosure, in formulae 1 and 2, R₁ to R₅, each independently, may represent hydrogen, deuterium, a substituted or unsubstituted (C1-C20)alkyl, a substituted or unsubstituted (C3-C20)cycloalkyl, a substituted or unsubstituted (C3-C20)cycloalkenyl, a substituted or unsubstituted (C6-C20)aryl, a substituted or unsubstituted (3 to 20-membered)heteroaryl, or —NR₆R₇, or may be linked to an adjacent substituent(s) to form a substituted or unsubstituted (C3-C20), mono- or polycyclic, alicyclic or aromatic ring, whose carbon atom(s) may be replaced with at least one hetero atom selected from nitrogen, oxygen, and sulfur; wherein R₆ and R₇, each independently, may represent a substituted or unsubstituted (C1-C20)alkyl, a substituted or unsubstituted (C3-C20)cycloalkyl, a substituted or unsubstituted (C3-C20)cycloalkenyl, a substituted or unsubstituted (C6-C20)aryl, or a substituted or unsubstituted (3 to 20-membered)heteroaryl; Ar₁ may represent a substituted or unsubstituted (C6-C25)aryl, or a substituted or unsubstituted (3 to 25-membered)heteroaryl; and a to e, each independently, may be 1 or 2.

According to another embodiment of the present disclosure, in formulae 1 and 2, R₁ to R₄, each independently, may represent hydrogen; R₅ may represent hydrogen, or an unsubstituted (C6-C18)ary, or may be linked to an adjacent substituent(s) to form an unsubstituted (C3-C18) mono- or polycyclic, aromatic ring; Ar₁ may represent a substituted or unsubstituted (C6-C25)aryl, or a substituted or unsubstituted (5 to 20-membered)heteroaryl; a, c, d and e may be 1; and b may be 2.

More specifically, the organic electroluminescent compound of formula 1 of the present disclosure includes the following, but is not limited thereto:

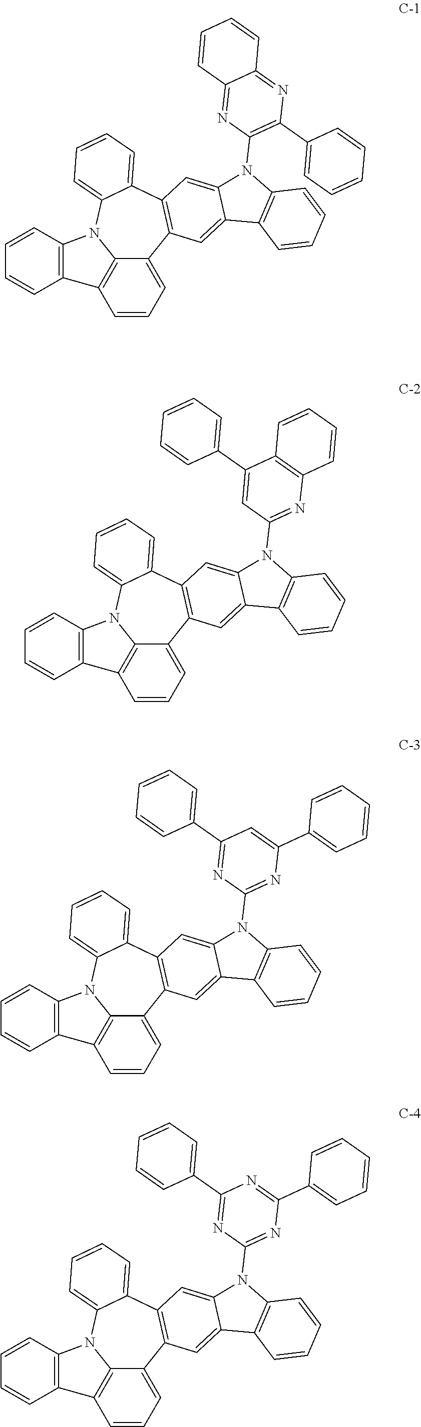 [SMILES: c1ccc(-c2nc3ccccc3nc2-n2c3ccccc3c3cc4c(cc32)-c2ccccc2-n2c3ccccc3c3cccc-4c32)cc1 ; c1ccc(-c2cc(-n3c4ccccc4c4cc5c(cc43)-c3ccccc3-n3c4ccccc4c4cccc-5c43)nc3ccccc23)cc1 ; c1ccc(-c2cc(-c3ccccc3)nc(-n3c4ccccc4c4cc5c(cc43)-c3ccccc3-n3c4ccccc4c4cccc-5c43)n2)cc1 ; c1ccc(-c2nc(-c3ccccc3)nc(-n3c4ccccc4c4cc5c(cc43)-c3ccccc3-n3c4ccccc4c4cccc-5c43)n2)cc1]

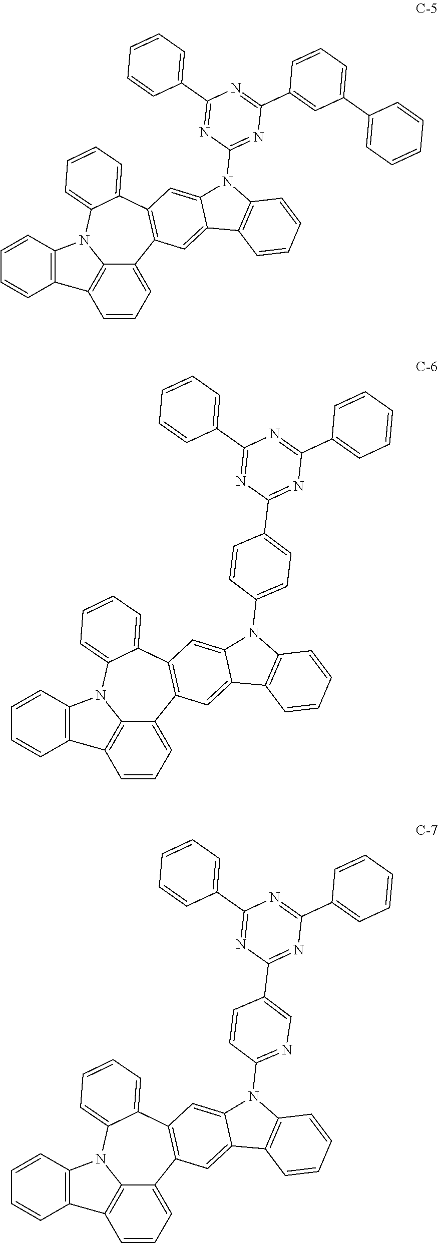 [SMILES: c1ccc(-c2cccc(-c3nc(-c4ccccc4)nc(-n4c5ccccc5c5cc6c(cc54)-c4ccccc4-n4c5ccccc5c5cccc-6c54)n3)c2)cc1 ; c1ccc(-c2nc(-c3ccccc3)nc(-c3ccc(-n4c5ccccc5c5cc6c(cc54)-c4ccccc4-n4c5ccccc5c5cccc-6c54)cc3)n2)cc1 ; c1ccc(-c2nc(-c3ccccc3)nc(-c3ccc(-n4c5ccccc5c5cc6c(cc54)-c4ccccc4-n4c5ccccc5c5cccc-6c54)nc3)n2)cc1]

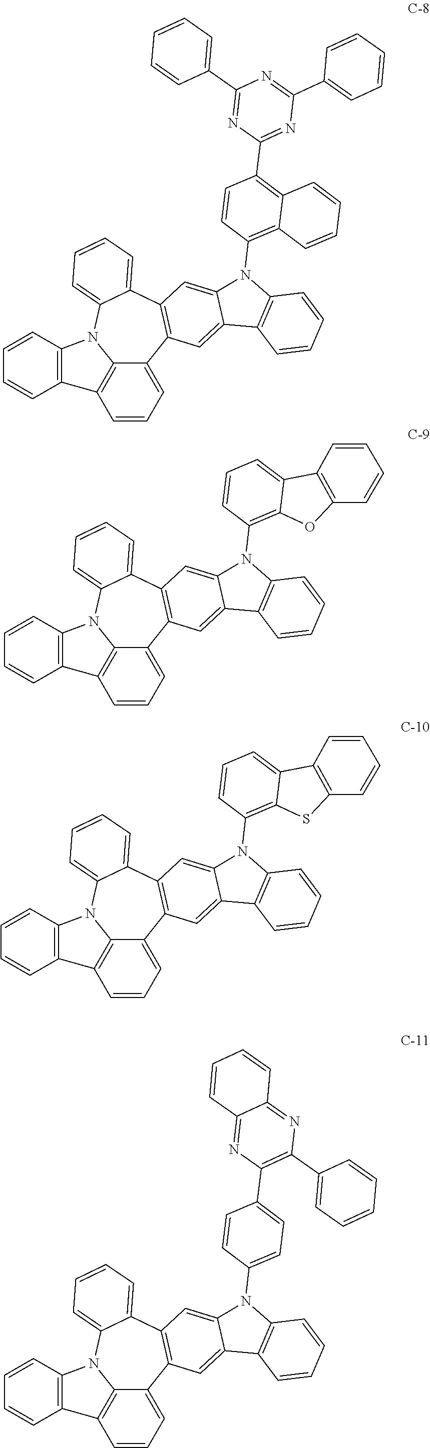 [SMILES: c1ccc(-c2nc(-c3ccccc3)nc(-c3ccc(-n4c5ccccc5c5cc6c(cc54)-c4ccccc4-n4c5ccccc5c5cccc-6c54)c4ccccc34)n2)cc1 ; c1ccc2c(c1)-c1cc3c(cc1-c1cccc4c5ccccc5n-2c14)c1ccccc1n3-c1cccc2c1oc1ccccc12 ; c1ccc2c(c1)-c1cc3c(cc1-c1cccc4c5ccccc5n-2c14)c1ccccc1n3-c1cccc2c1sc1ccccc12 ; c1ccc(-c2nc3ccccc3nc2-c2ccc(-n3c4ccccc4c4cc5c(cc43)-c3ccccc3-n3c4ccccc4c4cccc-5c43)cc2)cc1]

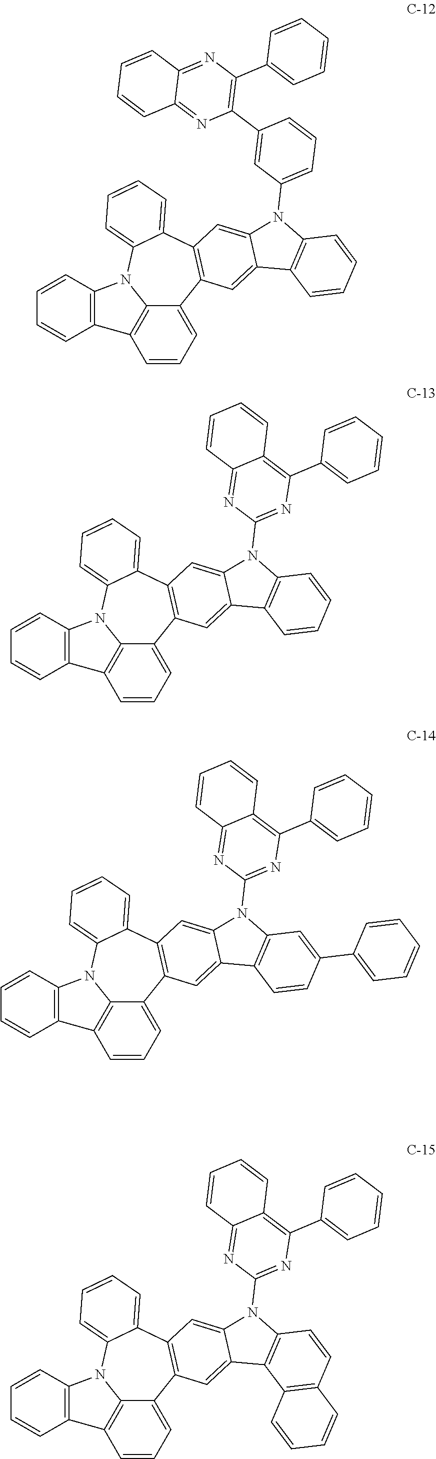 [SMILES: c1ccc(-c2nc3ccccc3nc2-c2cccc(-n3c4ccccc4c4cc5c(cc43)-c3ccccc3-n3c4ccccc4c4cccc-5c43)c2)cc1 ; c1ccc(-c2nc(-n3c4ccccc4c4cc5c(cc43)-c3ccccc3-n3c4ccccc4c4cccc-5c43)nc3ccccc23)cc1 ; c1ccc(-c2ccc3c4cc5c(cc4n(-c4nc(-c6ccccc6)c6ccccc6n4)c3c2)-c2ccccc2-n2c3ccccc3c3cccc-5c32)cc1 ; c1ccc(-c2nc(-n3c4cc5c(cc4c4c6ccccc6ccc43)-c3cccc4c6ccccc6n(c34)-c3ccccc3-5)nc3ccccc23)cc1]

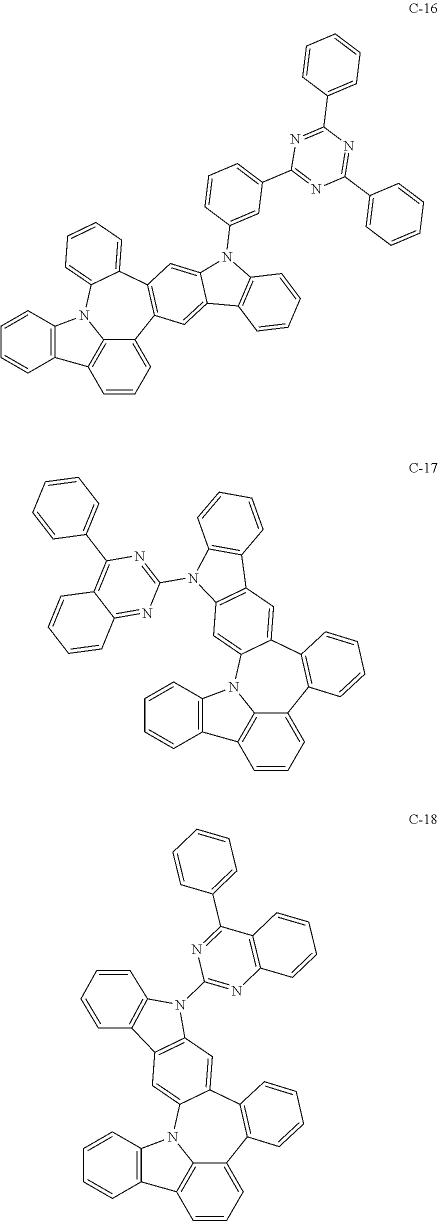 [SMILES: c1ccc(-c2nc(-c3ccccc3)nc(-c3cccc(-n4c5ccccc5c5cc6c(cc54)-c4ccccc4-n4c5ccccc5c5cccc-6c54)c3)n2)cc1 ; c1ccc(-c2nc(-n3c4ccccc4c4cc5c(cc43)-n3c4ccccc4c4cccc(c43)-c3ccccc3-5)nc3ccccc23)cc1 ; c1ccc(-c2nc(-n3c4ccccc4c4cc5c(cc43)-c3ccccc3-c3cccc4c6ccccc6n-5c34)nc3ccccc23)cc1]

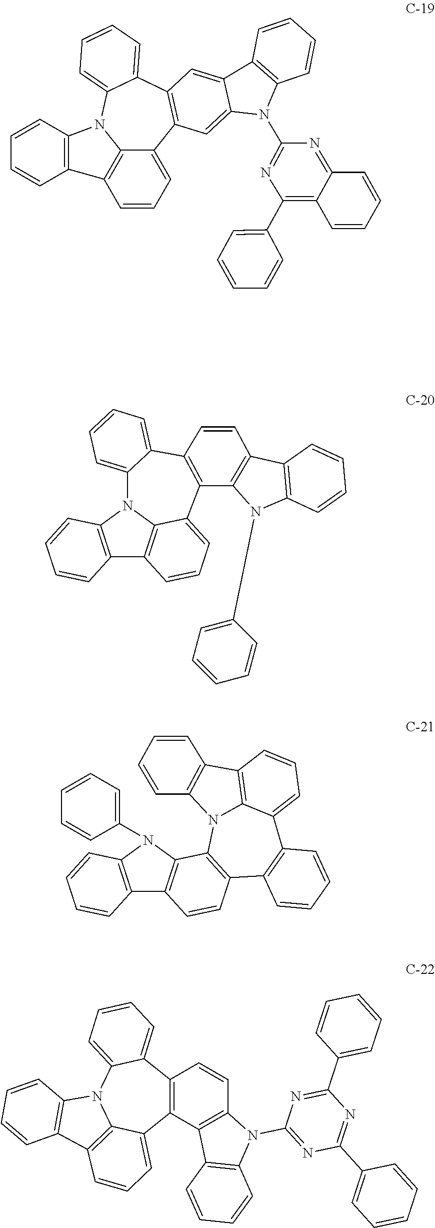 [SMILES: c1ccc(-c2nc(-n3c4ccccc4c4cc5c(cc43)-c3cccc4c6ccccc6n(c34)-c3ccccc3-5)nc3ccccc23)cc1 ; c1ccc(-n2c3ccccc3c3ccc4c(c32)-c2cccc3c5ccccc5n(c23)-c2ccccc2-4)cc1 ; c1ccc(-n2c3ccccc3c3ccc4c(c32)-n2c3ccccc3c3cccc(c32)-c2ccccc2-4)cc1 ; c1ccc(-c2nc(-c3ccccc3)nc(-n3c4ccccc4c4c5c(ccc43)-c3ccccc3-n3c4ccccc4c4cccc-5c43)n2)cc1]

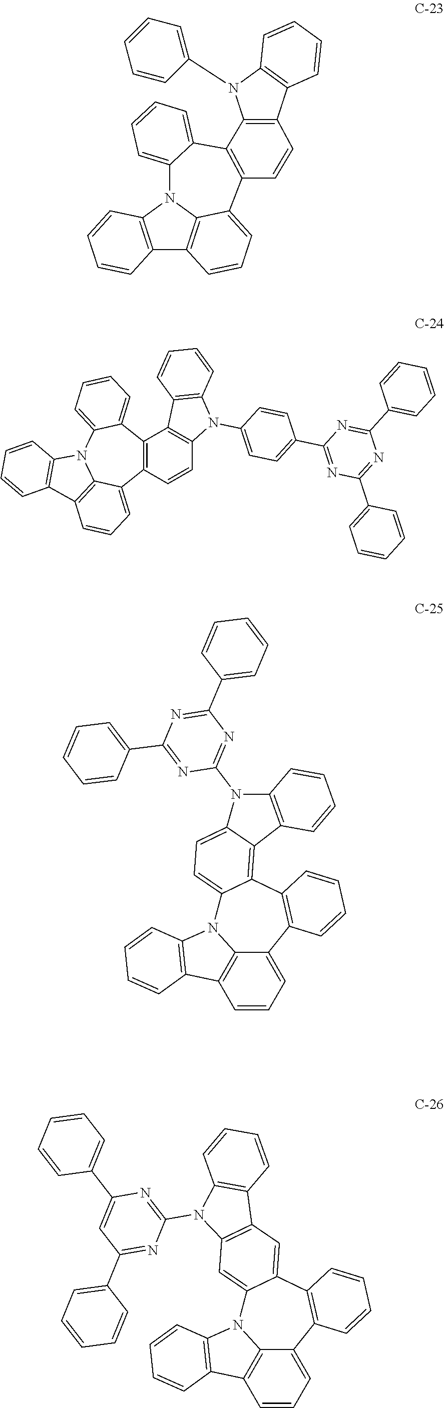 [SMILES: c1ccc(-n2c3ccccc3c3ccc4c(c32)-c2ccccc2-n2c3ccccc3c3cccc-4c32)cc1 ; c1ccc(-c2nc(-c3ccccc3)nc(-c3ccc(-n4c5ccccc5c5c6c(ccc54)-c4cccc5c7ccccc7n(c45)-c4ccccc4-6)cc3)n2)cc1 ; c1ccc(-c2nc(-c3ccccc3)nc(-n3c4ccccc4c4c5c(ccc43)-n3c4ccccc4c4cccc(c43)-c3ccccc3-5)n2)cc1 ; c1ccc(-c2cc(-c3ccccc3)nc(-n3c4ccccc4c4cc5c(cc43)-n3c4ccccc4c4cccc(c43)-c3ccccc3-5)n2)cc1]

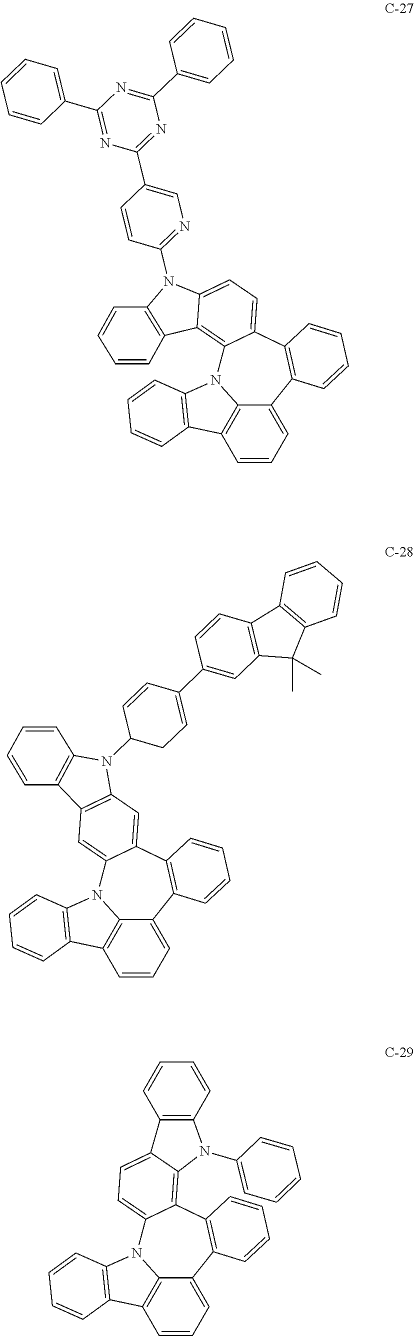 [SMILES: c1ccc(-c2nc(-c3ccccc3)nc(-c3ccc(-n4c5ccccc5c5c6c(ccc54)-c4ccccc4-c4cccc5c7ccccc7n-6c45)nc3)n2)cc1 ; CC1(C)c2ccccc2-c2ccc(C3=CCC(n4c5ccccc5c5cc6c(cc54)-c4ccccc4-c4cccc5c7ccccc7n-6c45)C=C3)cc21 ; c1ccc(-n2c3ccccc3c3ccc4c(c32)-c2ccccc2-c2cccc3c5ccccc5n-4c23)cc1]

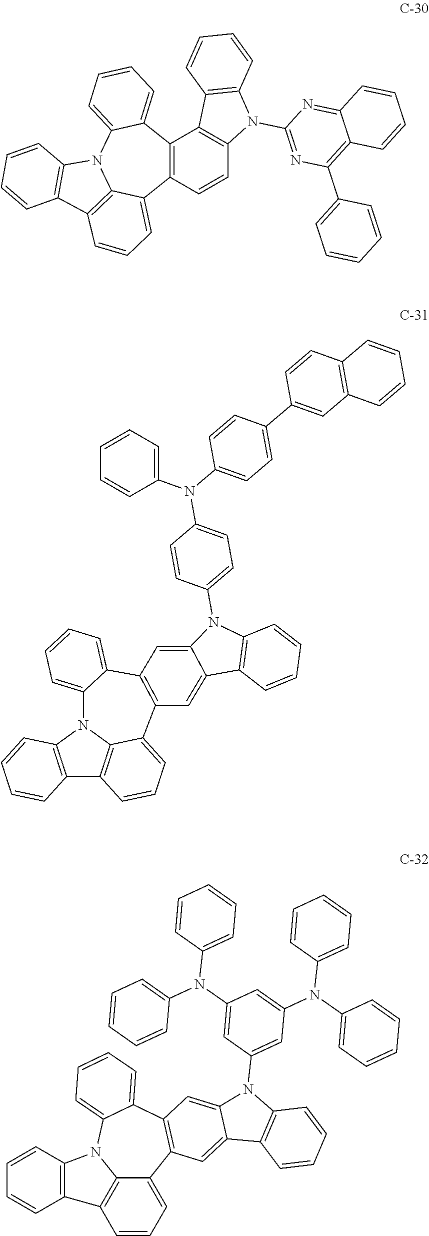 [SMILES: c1ccc(-c2nc(-n3c4ccccc4c4c5c(ccc43)-c3cccc4c6ccccc6n(c34)-c3ccccc3-5)nc3ccccc23)cc1 ; c1ccc(N(c2ccc(-c3ccc4ccccc4c3)cc2)c2ccc(-n3c4ccccc4c4cc5c(cc43)-c3ccccc3-n3c4ccccc4c4cccc-5c43)cc2)cc1 ; c1ccc(N(c2ccccc2)c2cc(N(c3ccccc3)c3ccccc3)cc(-n3c4ccccc4c4cc5c(cc43)-c3ccccc3-n3c4ccccc4c4cccc-5c43)c2)cc1]

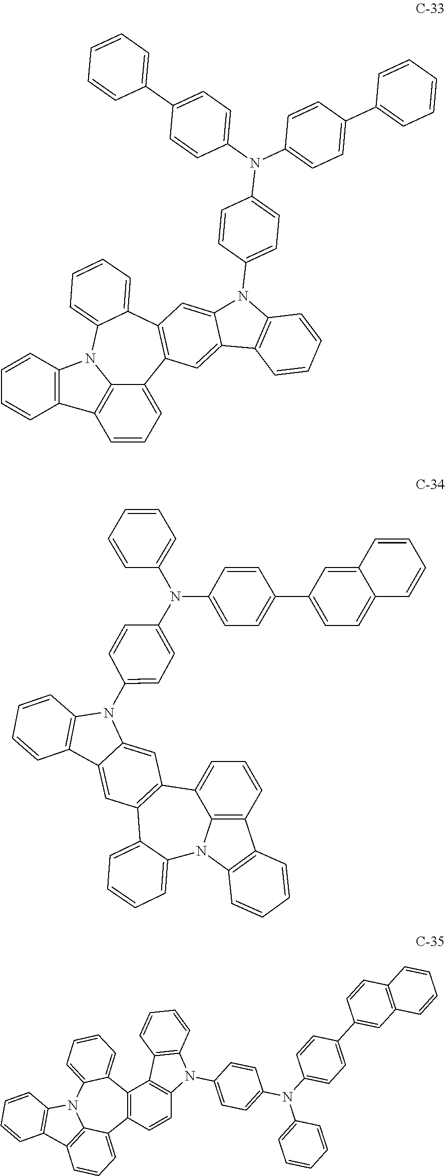 [SMILES: c1ccc(-c2ccc(N(c3ccc(-c4ccccc4)cc3)c3ccc(-n4c5ccccc5c5cc6c(cc54)-c4ccccc4-n4c5ccccc5c5cccc-6c54)cc3)cc2)cc1 ; c1ccc(N(c2ccc(-c3ccc4ccccc4c3)cc2)c2ccc(-n3c4ccccc4c4cc5c(cc43)-c3cccc4c6ccccc6n(c34)-c3ccccc3-5)cc2)cc1 ; c1ccc(N(c2ccc(-c3ccc4ccccc4c3)cc2)c2ccc(-n3c4ccccc4c4c5c(ccc43)-c3cccc4c6ccccc6n(c34)-c3ccccc3-5)cc2)cc1]

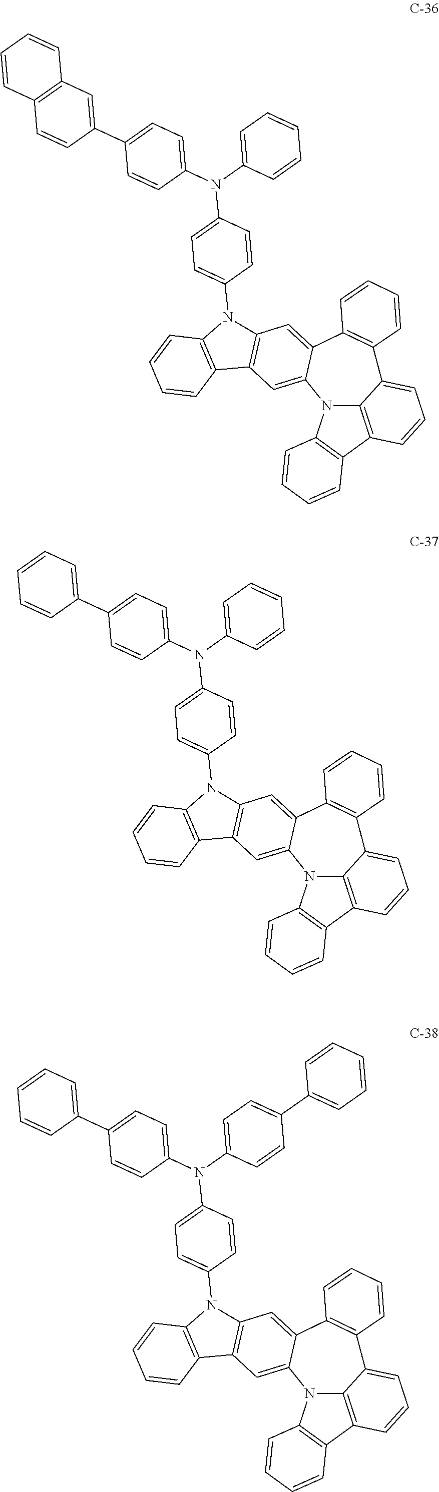 [SMILES: c1ccc(N(c2ccc(-c3ccc4ccccc4c3)cc2)c2ccc(-n3c4ccccc4c4cc5c(cc43)-c3ccccc3-c3cccc4c6ccccc6n-5c34)cc2)cc1 ; c1ccc(-c2ccc(N(c3ccccc3)c3ccc(-n4c5ccccc5c5cc6c(cc54)-c4ccccc4-c4cccc5c7ccccc7n-6c45)cc3)cc2)cc1 ; c1ccc(-c2ccc(N(c3ccc(-c4ccccc4)cc3)c3ccc(-n4c5ccccc5c5cc6c(cc54)-c4ccccc4-c4cccc5c7ccccc7n-6c45)cc3)cc2)cc1]

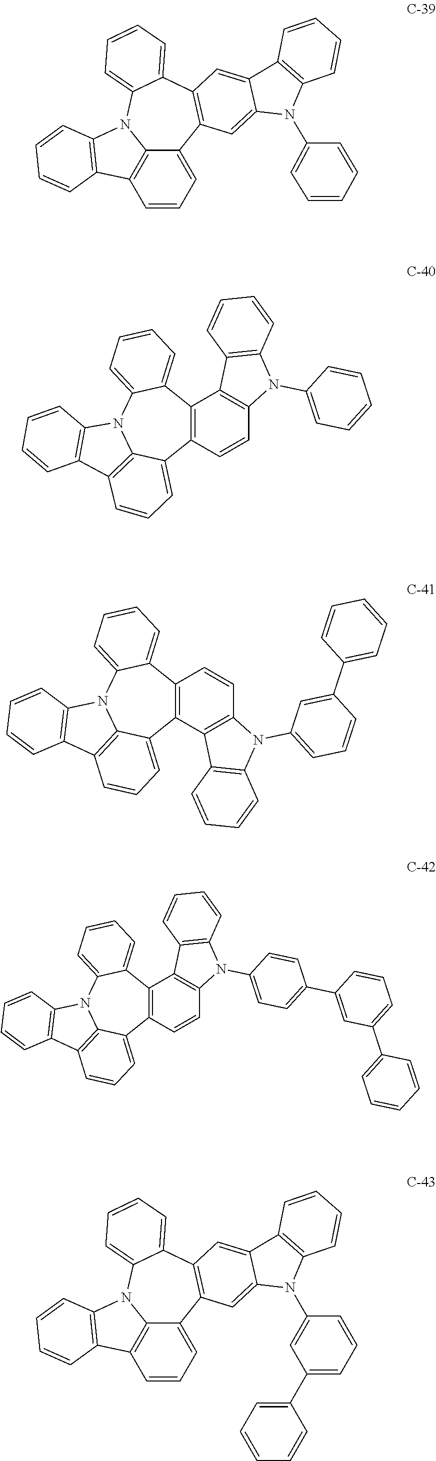 [SMILES: c1ccc(-n2c3ccccc3c3cc4c(cc32)-c2cccc3c5ccccc5n(c23)-c2ccccc2-4)cc1 ; c1ccc(-n2c3ccccc3c3c4c(ccc32)-c2cccc3c5ccccc5n(c23)-c2ccccc2-4)cc1 ; c1ccc(-c2cccc(-n3c4ccccc4c4c5c(ccc43)-c3ccccc3-n3c4ccccc4c4cccc-5c43)c2)cc1 ; c1ccc(-c2cccc(-c3ccc(-n4c5ccccc5c5c6c(ccc54)-c4cccc5c7ccccc7n(c45)-c4ccccc4-6)cc3)c2)cc1 ; c1ccc(-c2cccc(-n3c4ccccc4c4cc5c(cc43)-c3cccc4c6ccccc6n(c34)-c3ccccc3-5)c2)cc1]

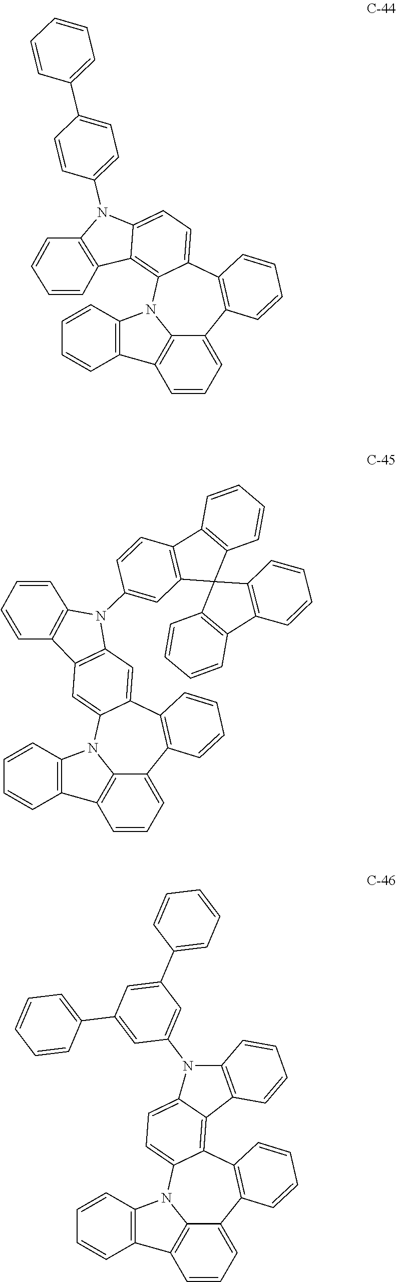 [SMILES: c1ccc(-c2ccc(-n3c4ccccc4c4c5c(ccc43)-c3ccccc3-c3cccc4c6ccccc6n-5c34)cc2)cc1 ; c1ccc2c(c1)-c1cc3c(cc1-n1c4ccccc4c4cccc-2c41)c1ccccc1n3-c1ccc2c(c1)C1(c3ccccc3-c3ccccc31)c1ccccc1-2 ; c1ccc(-c2cc(-c3ccccc3)cc(-n3c4ccccc4c4c5c(ccc43)-n3c4ccccc4c4cccc(c43)-c3ccccc3-5)c2)cc1]

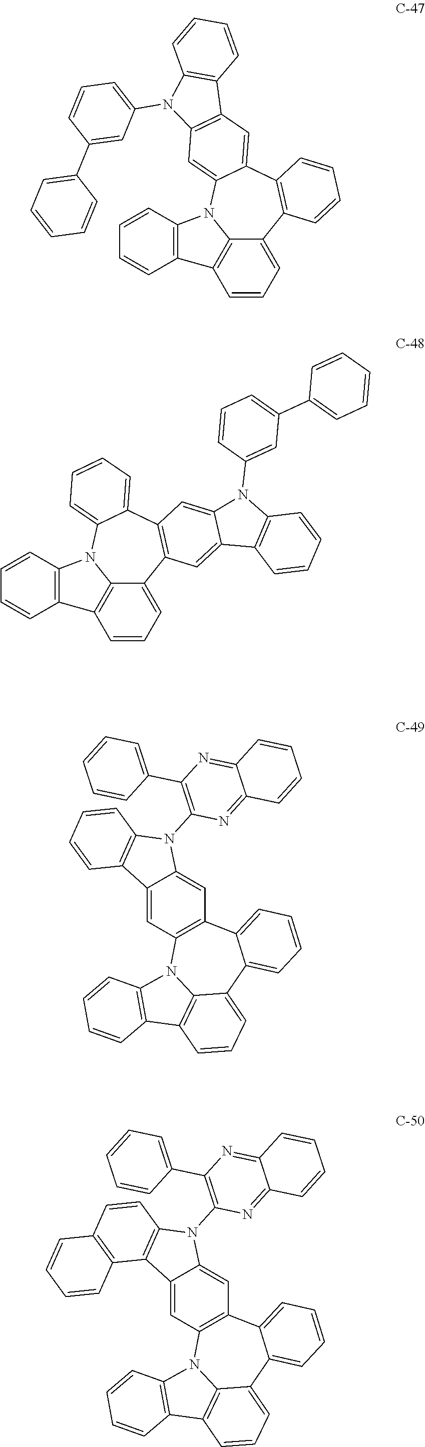 [SMILES: c1ccc(-c2cccc(-n3c4ccccc4c4cc5c(cc43)-n3c4ccccc4c4cccc(c43)-c3ccccc3-5)c2)cc1 ; c1ccc(-c2cccc(-n3c4ccccc4c4cc5c(cc43)-c3ccccc3-n3c4ccccc4c4cccc-5c43)c2)cc1 ; c1ccc(-c2nc3ccccc3nc2-n2c3ccccc3c3cc4c(cc32)-c2ccccc2-c2cccc3c5ccccc5n-4c23)cc1 ; c1ccc(-c2nc3ccccc3nc2-n2c3cc4c(cc3c3c5ccccc5ccc32)-n2c3ccccc3c3cccc(c32)-c2ccccc2-4)cc1]

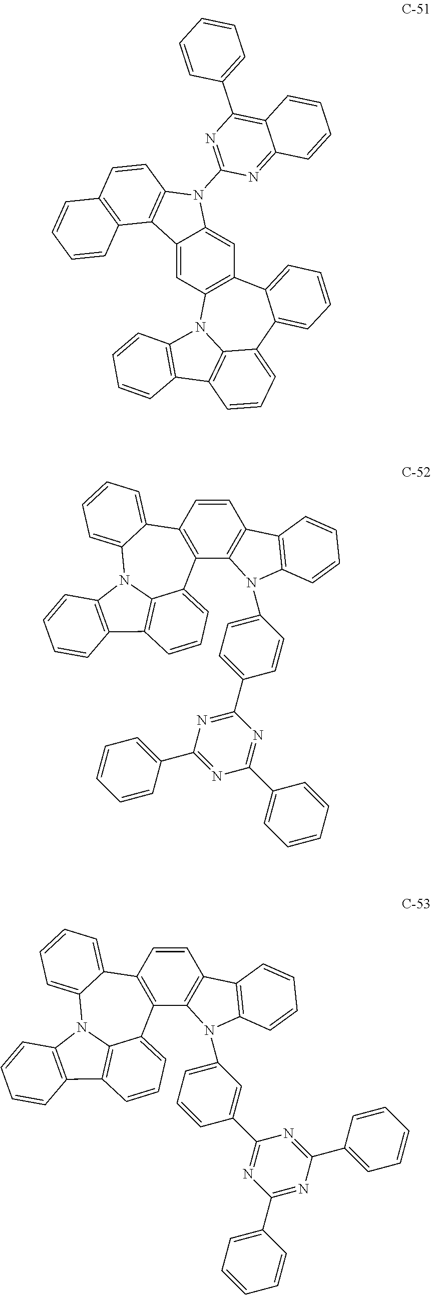 [SMILES: c1ccc(-c2nc(-n3c4cc5c(cc4c4c6ccccc6ccc43)-n3c4ccccc4c4cccc(c43)-c3ccccc3-5)nc3ccccc23)cc1 ; c1ccc(-c2nc(-c3ccccc3)nc(-c3ccc(-n4c5ccccc5c5ccc6c(c54)-c4cccc5c7ccccc7n(c45)-c4ccccc4-6)cc3)n2)cc1 ; c1ccc(-c2nc(-c3ccccc3)nc(-c3cccc(-n4c5ccccc5c5ccc6c(c54)-c4cccc5c7ccccc7n(c45)-c4ccccc4-6)c3)n2)cc1]

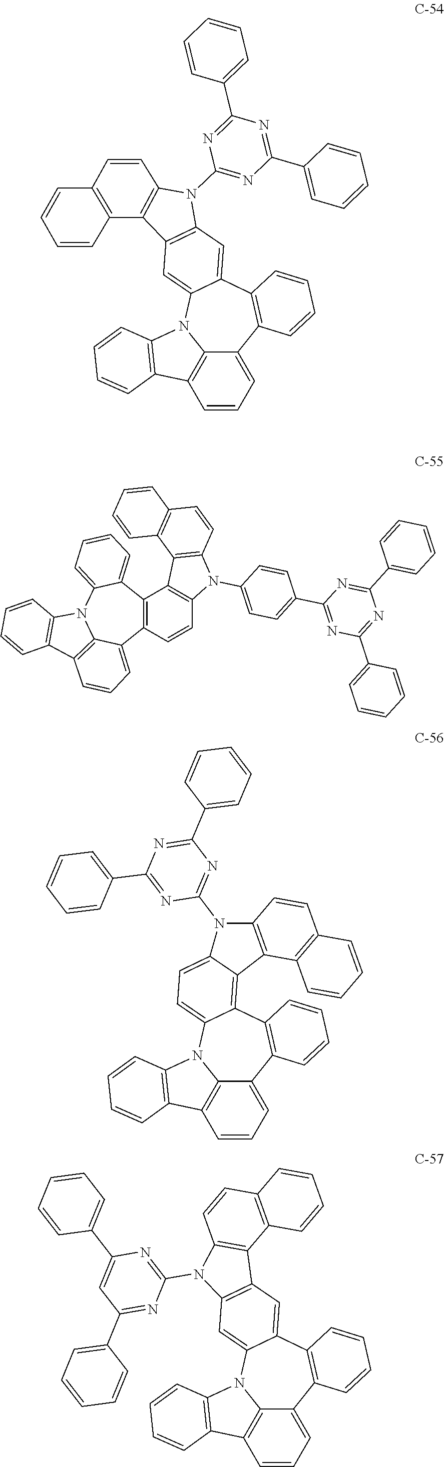

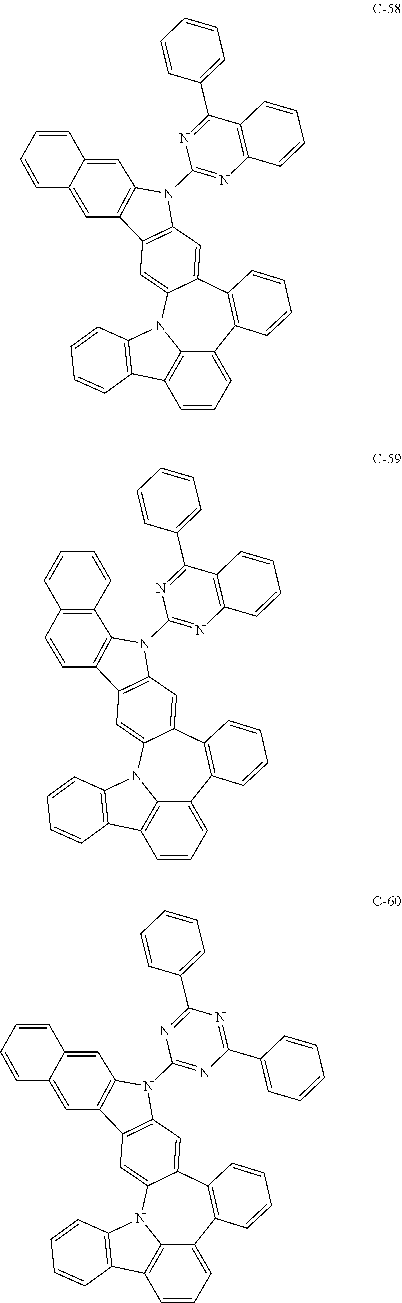 [SMILES: c1ccc(-c2nc(-n3c4cc5c(cc4c4cc6ccccc6cc43)-n3c4ccccc4c4cccc(c43)-c3ccccc3-5)nc3ccccc23)cc1 ; c1ccc(-c2nc(-n3c4cc5c(cc4c4ccc6ccccc6c43)-n3c4ccccc4c4cccc(c43)-c3ccccc3-5)nc3ccccc23)cc1 ; c1ccc(-c2nc(-c3ccccc3)nc(-n3c4cc5c(cc4c4cc6ccccc6cc43)-n3c4ccccc4c4cccc(c43)-c3ccccc3-5)n2)cc1]

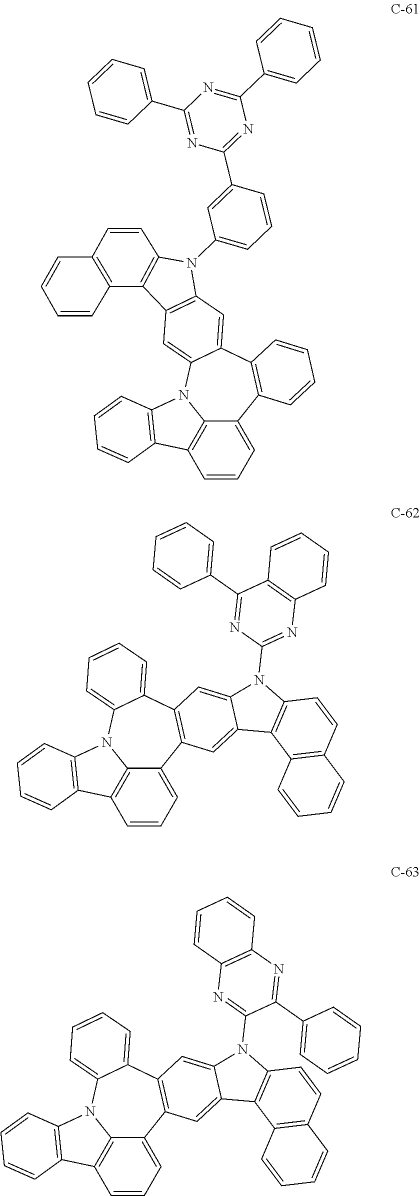 [SMILES: c1ccc(-c2nc(-c3ccccc3)nc(-c3cccc(-n4c5cc6c(cc5c5c7ccccc7ccc54)-n4c5ccccc5c5cccc(c54)-c4ccccc4-6)c3)n2)cc1 ; c1ccc(-c2nc(-n3c4cc5c(cc4c4c6ccccc6ccc43)-c3cccc4c6ccccc6n(c34)-c3ccccc3-5)nc3ccccc23)cc1 ; c1ccc(-c2nc3ccccc3nc2-n2c3cc4c(cc3c3c5ccccc5ccc32)-c2cccc3c5ccccc5n(c23)-c2ccccc2-4)cc1]

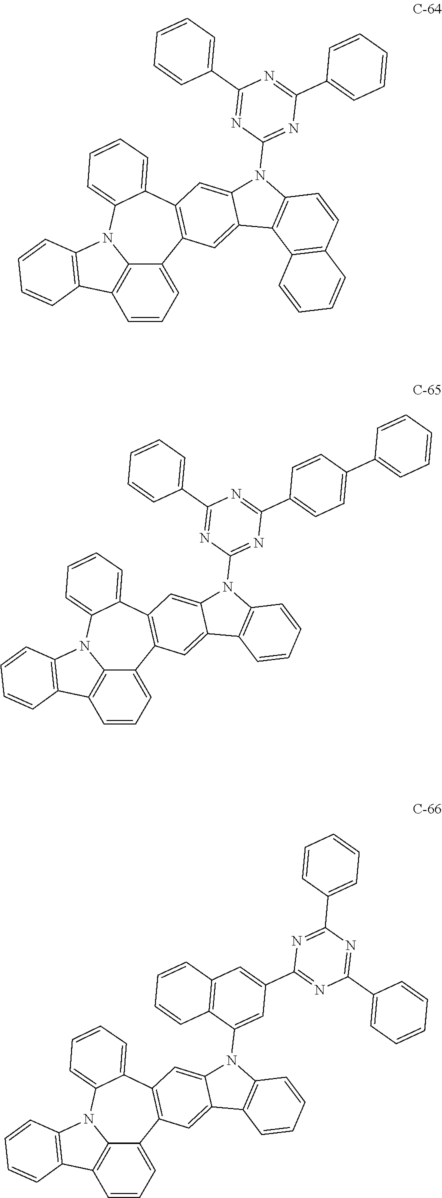 [SMILES: c1ccc(-c2nc(-c3ccccc3)nc(-n3c4cc5c(cc4c4c6ccccc6ccc43)-c3cccc4c6ccccc6n(c34)-c3ccccc3-5)n2)cc1 ; c1ccc(-c2ccc(-c3nc(-c4ccccc4)nc(-n4c5ccccc5c5cc6c(cc54)-c4ccccc4-n4c5ccccc5c5cccc-6c54)n3)cc2)cc1 ; c1ccc(-c2nc(-c3ccccc3)nc(-c3cc(-n4c5ccccc5c5cc6c(cc54)-c4ccccc4-n4c5ccccc5c5cccc-6c54)c4ccccc4c3)n2)cc1]

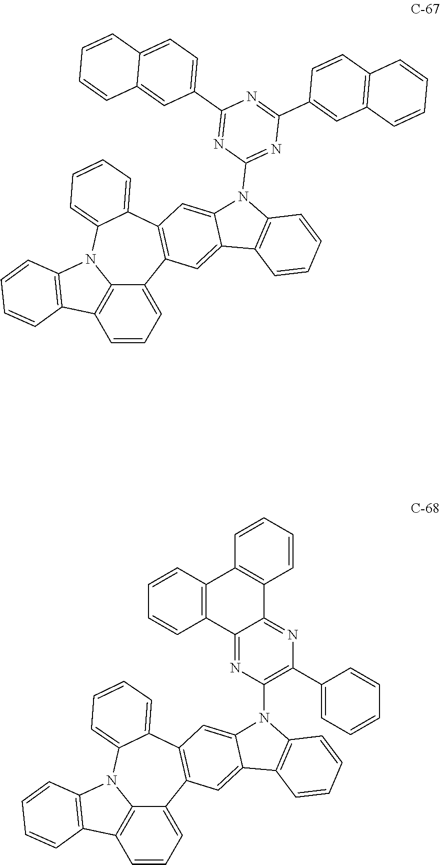 [SMILES: c1ccc2c(c1)-c1cc3c(cc1-c1cccc4c5ccccc5n-2c14)c1ccccc1n3-c1nc(-c2ccc3ccccc3c2)nc(-c2ccc3ccccc3c2)n1 ; c1ccc(-c2nc3c4ccccc4c4ccccc4c3nc2-n2c3ccccc3c3cc4c(cc32)-c2ccccc2-n2c3ccccc3c3cccc-4c32)cc1]

Furthermore, the present disclosure provides an organic electroluminescent material comprising the organic electroluminescent compound of formula 1, and an organic electroluminescent device comprising the material.

The material may consist of the organic electroluminescent compound alone of the present disclosure. Otherwise, the material may further comprise a conventional compound(s) which has been comprised in an organic electroluminescent material, in addition to the compound of the present disclosure.

The organic electroluminescent device of the present disclosure may comprise a first electrode, a second electrode, and at least one organic layer disposed between the first and second electrodes. The organic layer may comprise at least one organic electroluminescent compound of formula 1.

One of the first and second electrodes may be an anode, and the other may be a cathode. The organic layer may comprise a light-emitting layer, and may further comprise at least one layer selected from a hole injection layer, a hole transport layer, a hole auxiliary layer, an auxiliary light-emitting layer, an electron transport layer, an electron buffering layer, an electron injection layer, an interlayer, a hole blocking layer, and an electron blocking layer, wherein the hole auxiliary layer or the auxiliary light-emitting layer is interposed between the hole transport layer and the light-emitting layer, and modulates hole mobility. The hole auxiliary layer or the auxiliary light-emitting layer has the effects to provide improved efficiency and lifespan of the organic electroluminescent device.

The organic electroluminescent compound of formula 1 of the present disclosure may be comprised in the light-emitting layer as a host material. Preferably, the light-emitting layer may further comprise at least one dopant, and if needed, a compound other than the organic electroluminescent compound of formula 1 of the present disclosure may be comprised additionally as a second host material.

According to another aspect of the present disclosure, a material for preparing an organic electroluminescent device is provided. The material may comprise a first host material and a second host material, wherein the first host material comprises the organic electroluminescent compound of the present disclosure. The weight ratio between the first host material and the second host material is in the range of 1:99 to 99:1.

The second host material may be from any of the known phosphorescent host materials. Preferably, the second host material may be selected from the group consisting of the phosphorescent hosts of formulae 7 to 11 below.

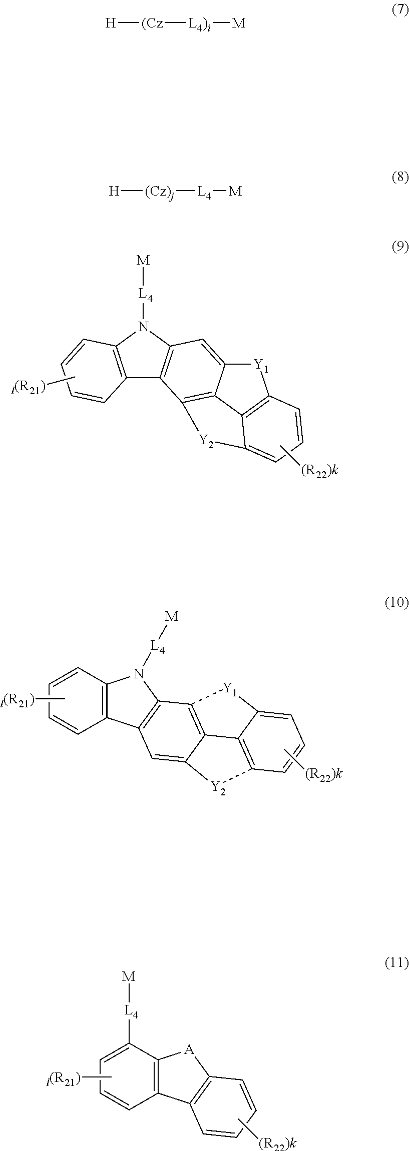

Wherein

Cz has the following structure:

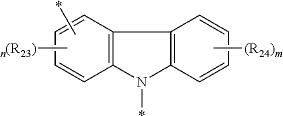

A represents —O— or —S—;

R₂₁ to R₂₄ each independently, represent hydrogen, deuterium, a halogen, a substituted or unsubstituted (C1-C30)alkyl, a substituted or unsubstituted (C6-C30)aryl, a substituted or unsubstituted (5 to 30-membered)heteroaryl or —SiR₂₅R₂₆R₂₇; R₂₅ to R₂₇, each independently, represent a substituted or unsubstituted (C1-C30)alkyl, or a substituted or unsubstituted (C6-C30)aryl; La represents a single bond, a substituted or unsubstituted (C6-C30)arylene, or a substituted or unsubstituted (5 to 30-membered)heteroarylene; M represents a substituted or unsubstituted (C6-C30)aryl, or a substituted or unsubstituted (5 to 30-membered)heteroaryl; Y₁ and Y₂ each independently, represent —O—, —S—, —N(R₄₁)— or —C(R₄₂)(R₄₃)—, and Y₁ and Y₂ do not occur concurrently; R₄₁ to R₄₃, each independently, represent a substituted or unsubstituted (C1-C30)alky, a substituted or unsubstituted (C6-C30)aryl, or a substituted or unsubstituted (5 to 30-membered)heteroaryl, R₄₂ and R₄₃ may be the same or different; i and j, each independently, represent an integer of 1 to 3; k, l, m and n, each independently, represent an integer of 0 to 4; when i, j, k, l, m or n is an integer of 2 or more, each of (Cz-L₄), each of (Cz), each of R₂₁, each of R₂₂, each of R₂₃ or each of R₂₄ may be the same or different.

Specifically, the second host material preferably includes the following:

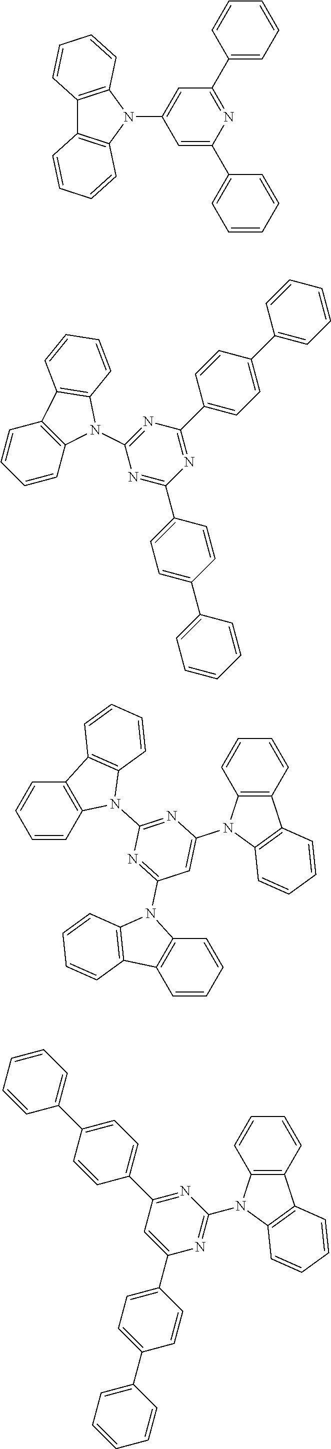 [SMILES: c1ccc(-c2cc(-n3c4ccccc4c4ccccc43)cc(-c3ccccc3)n2)cc1 ; c1ccc(-c2ccc(-c3nc(-c4ccc(-c5ccccc5)cc4)nc(-n4c5ccccc5c5ccccc54)n3)cc2)cc1 ; c1ccc2c(c1)c1ccccc1n2-c1cc(-n2c3ccccc3c3ccccc32)nc(-n2c3ccccc3c3ccccc32)n1 ; c1ccc(-c2ccc(-c3cc(-c4ccc(-c5ccccc5)cc4)nc(-n4c5ccccc5c5ccccc54)n3)cc2)cc1]

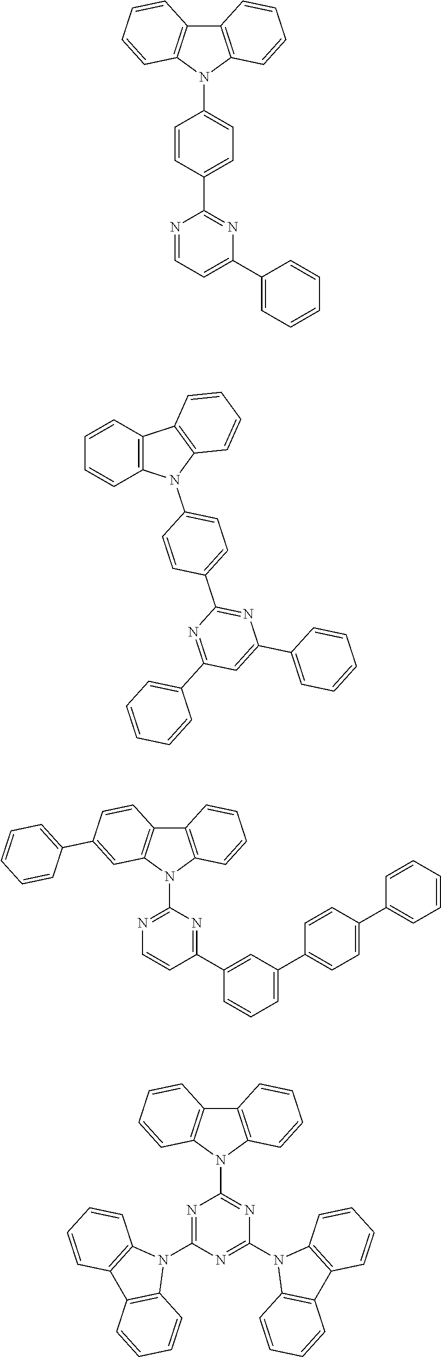 [SMILES: c1ccc(-c2ccnc(-c3ccc(-n4c5ccccc5c5ccccc54)cc3)n2)cc1 ; c1ccc(-c2cc(-c3ccccc3)nc(-c3ccc(-n4c5ccccc5c5ccccc54)cc3)n2)cc1 ; c1ccc(-c2ccc(-c3cccc(-c4ccnc(-n5c6ccccc6c6ccc(-c7ccccc7)cc65)n4)c3)cc2)cc1 ; c1ccc2c(c1)c1ccccc1n2-c1nc(-n2c3ccccc3c3ccccc32)nc(-n2c3ccccc3c3ccccc32)n1]

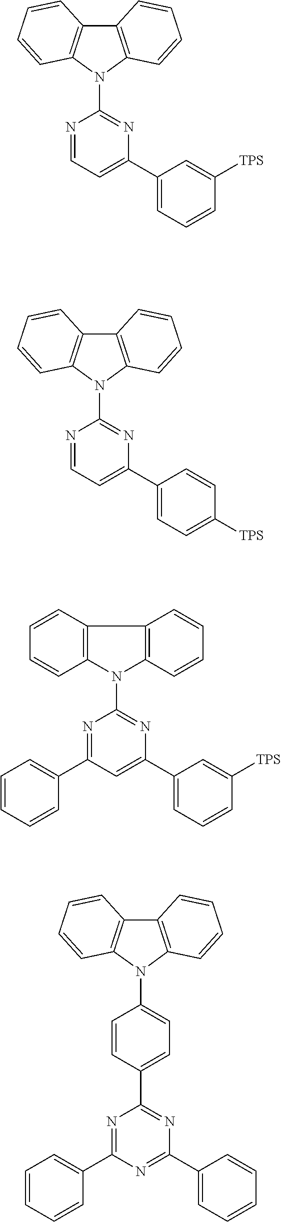

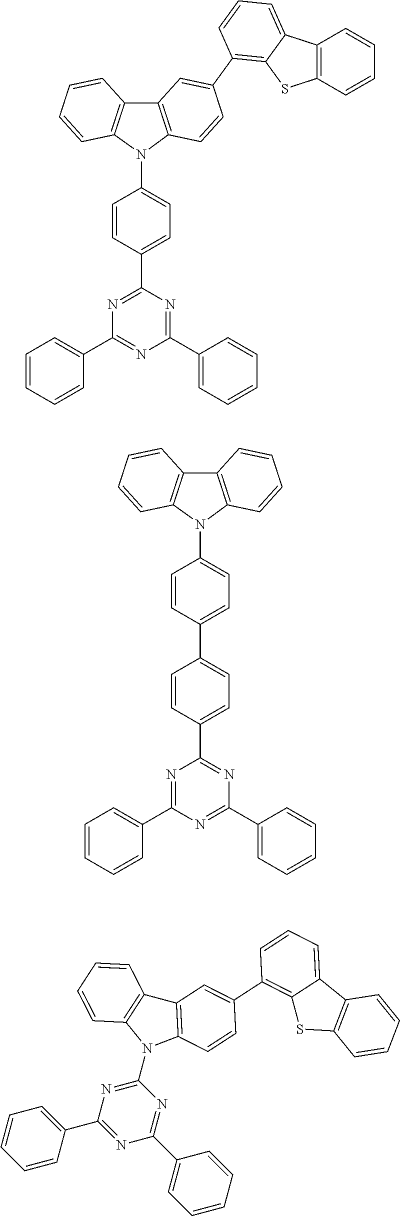

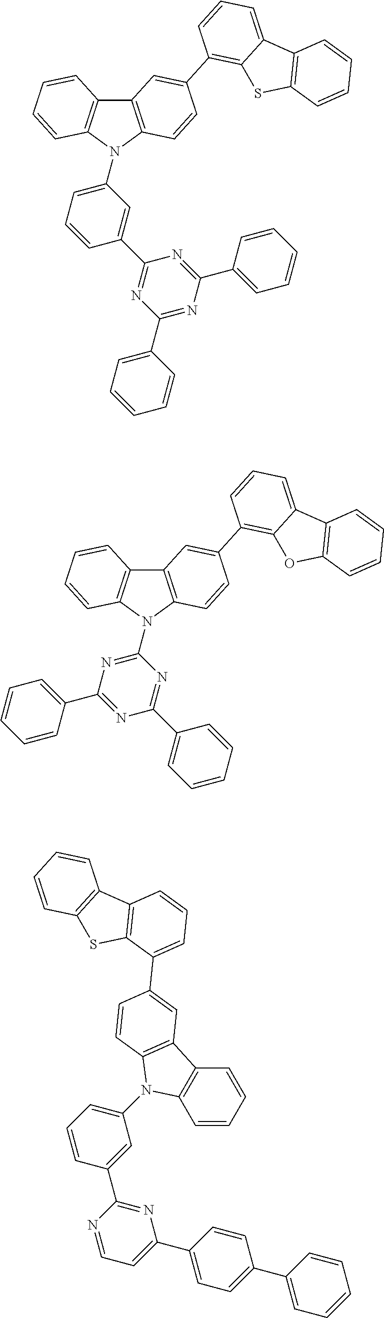 [SMILES: c1ccc(-c2nc(-c3ccccc3)nc(-c3cccc(-n4c5ccccc5c5cc(-c6cccc7c6sc6ccccc67)ccc54)c3)n2)cc1 ; c1ccc(-c2nc(-c3ccccc3)nc(-n3c4ccccc4c4cc(-c5cccc6c5oc5ccccc56)ccc43)n2)cc1 ; c1ccc(-c2ccc(-c3ccnc(-c4cccc(-n5c6ccccc6c6cc(-c7cccc8c7sc7ccccc78)ccc65)c4)n3)cc2)cc1]

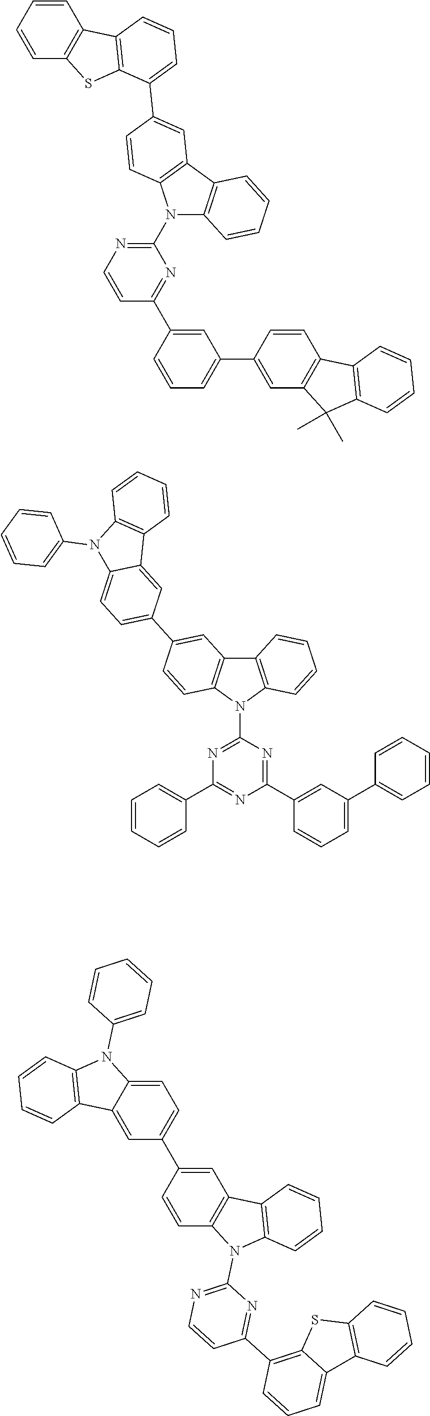 [SMILES: CC1(C)c2ccccc2-c2ccc(-c3cccc(-c4ccnc(-n5c6ccccc6c6cc(-c7cccc8c7sc7ccccc78)ccc65)n4)c3)cc21 ; c1ccc(-c2cccc(-c3nc(-c4ccccc4)nc(-n4c5ccccc5c5cc(-c6ccc7c(c6)c6ccccc6n7-c6ccccc6)ccc54)n3)c2)cc1 ; c1ccc(-n2c3ccccc3c3cc(-c4ccc5c(c4)c4ccccc4n5-c4nccc(-c5cccc6c5sc5ccccc56)n4)ccc32)cc1]

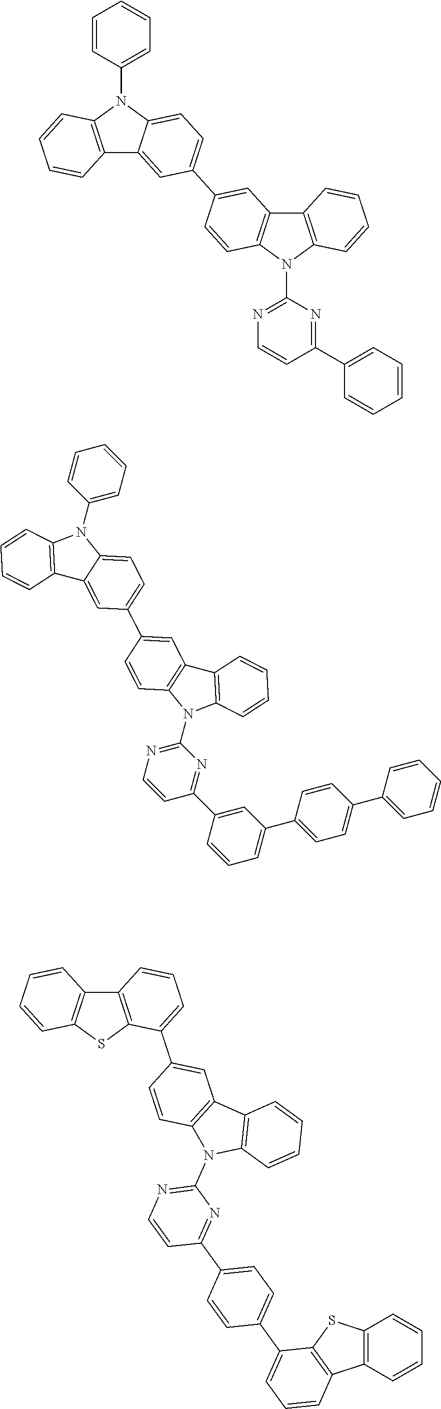 [SMILES: c1ccc(-c2ccnc(-n3c4ccccc4c4cc(-c5ccc6c(c5)c5ccccc5n6-c5ccccc5)ccc43)n2)cc1 ; c1ccc(-c2ccc(-c3cccc(-c4ccnc(-n5c6ccccc6c6cc(-c7ccc8c(c7)c7ccccc7n8-c7ccccc7)ccc65)n4)c3)cc2)cc1 ; c1ccc2c(c1)sc1c(-c3ccc(-c4ccnc(-n5c6ccccc6c6cc(-c7cccc8c7sc7ccccc78)ccc65)n4)cc3)cccc12]

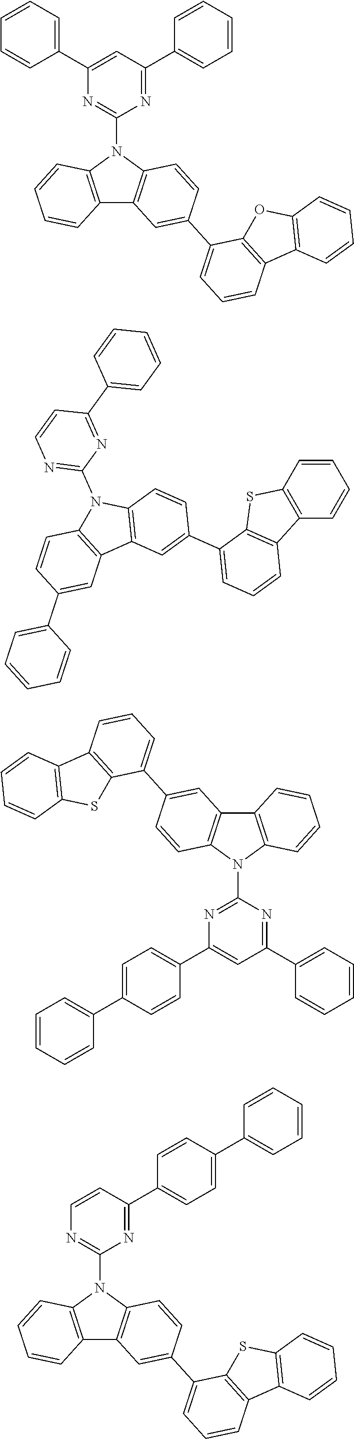 [SMILES: c1ccc(-c2cc(-c3ccccc3)nc(-n3c4ccccc4c4cc(-c5cccc6c5oc5ccccc56)ccc43)n2)cc1 ; c1ccc(-c2ccc3c(c2)c2cc(-c4cccc5c4sc4ccccc45)ccc2n3-c2nccc(-c3ccccc3)n2)cc1 ; c1ccc(-c2ccc(-c3cc(-c4ccccc4)nc(-n4c5ccccc5c5cc(-c6cccc7c6sc6ccccc67)ccc54)n3)cc2)cc1 ; c1ccc(-c2ccc(-c3ccnc(-n4c5ccccc5c5cc(-c6cccc7c6sc6ccccc67)ccc54)n3)cc2)cc1]

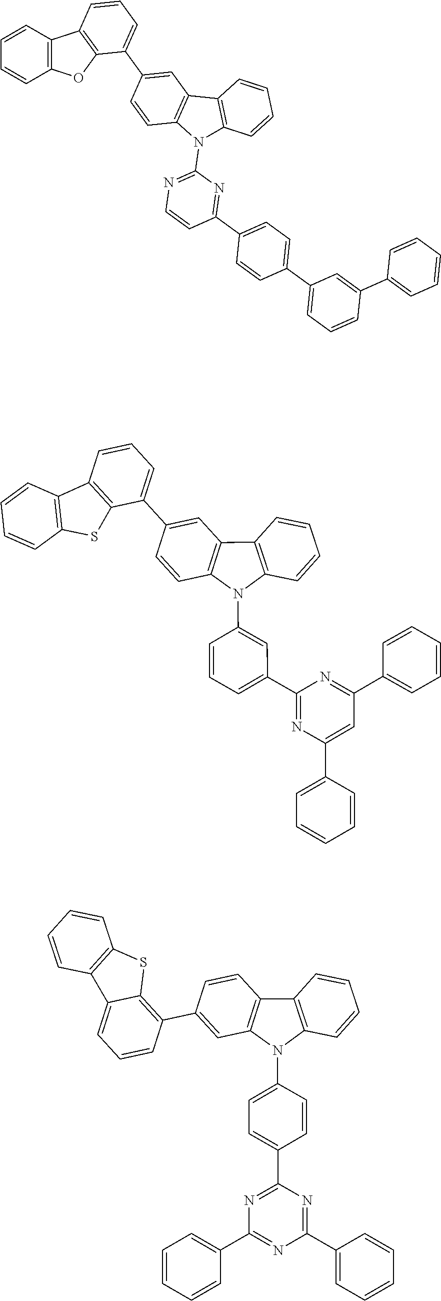 [SMILES: c1ccc(-c2cccc(-c3ccc(-c4ccnc(-n5c6ccccc6c6cc(-c7cccc8c7oc7ccccc78)ccc65)n4)cc3)c2)cc1 ; c1ccc(-c2cc(-c3ccccc3)nc(-c3cccc(-n4c5ccccc5c5cc(-c6cccc7c6sc6ccccc67)ccc54)c3)n2)cc1 ; c1ccc(-c2nc(-c3ccccc3)nc(-c3ccc(-n4c5ccccc5c5ccc(-c6cccc7c6sc6ccccc67)cc54)cc3)n2)cc1]

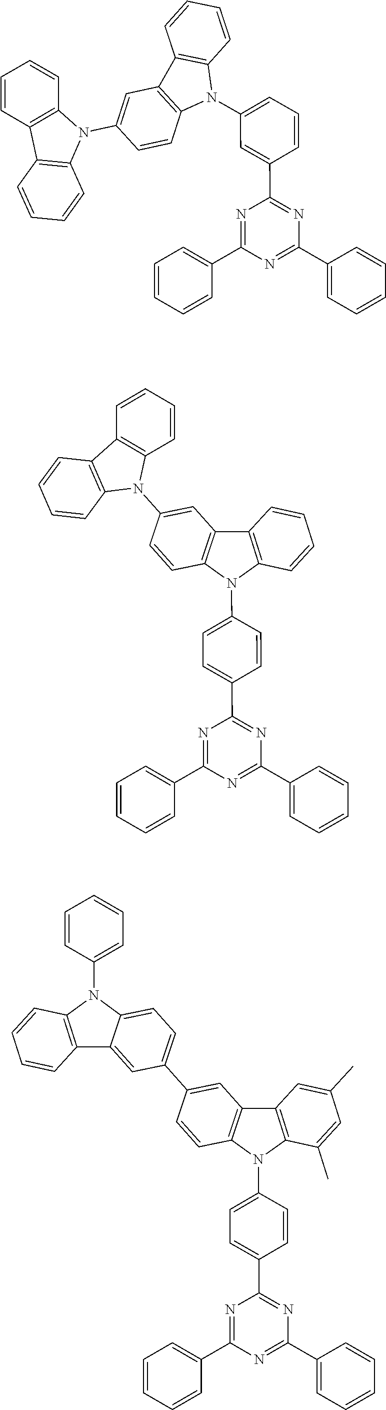 [SMILES: c1ccc(-c2nc(-c3ccccc3)nc(-c3cccc(-n4c5ccccc5c5cc(-n6c7ccccc7c7ccccc76)ccc54)c3)n2)cc1 ; c1ccc(-c2nc(-c3ccccc3)nc(-c3ccc(-n4c5ccccc5c5cc(-n6c7ccccc7c7ccccc76)ccc54)cc3)n2)cc1 ; Cc1cc(C)c2c(c1)c1cc(-c3ccc4c(c3)c3ccccc3n4-c3ccccc3)ccc1n2-c1ccc(-c2nc(-c3ccccc3)nc(-c3ccccc3)n2)cc1]

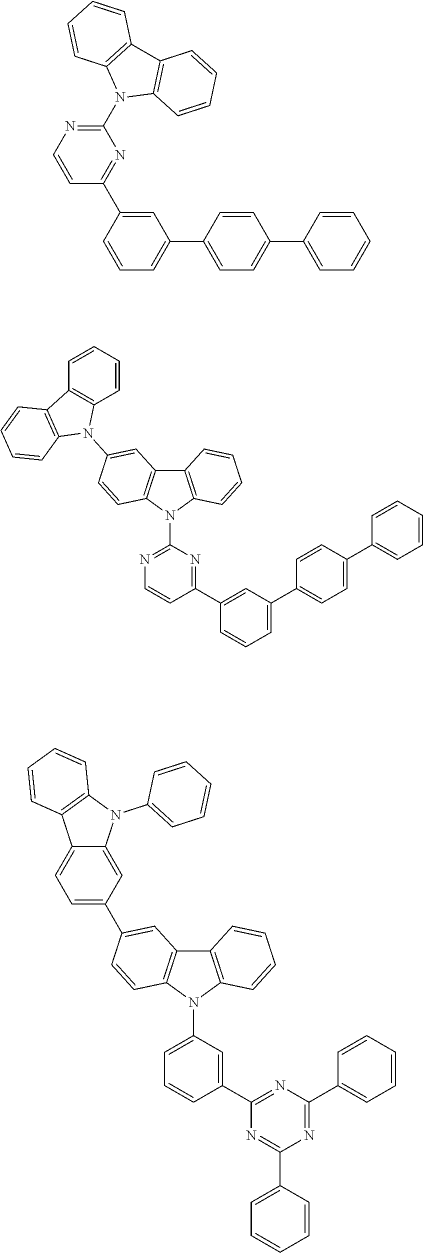 [SMILES: c1ccc(-c2ccc(-c3cccc(-c4ccnc(-n5c6ccccc6c6ccccc65)n4)c3)cc2)cc1 ; c1ccc(-c2ccc(-c3cccc(-c4ccnc(-n5c6ccccc6c6cc(-n7c8ccccc8c8ccccc87)ccc65)n4)c3)cc2)cc1 ; c1ccc(-c2nc(-c3ccccc3)nc(-c3cccc(-n4c5ccccc5c5cc(-c6ccc7c8ccccc8n(-c8ccccc8)c7c6)ccc54)c3)n2)cc1]

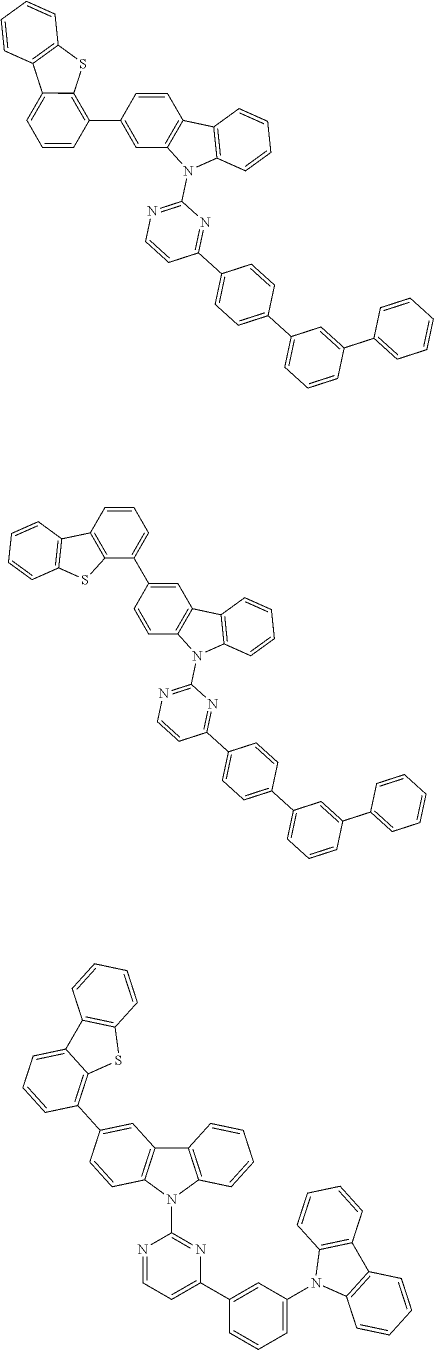 [SMILES: c1ccc(-c2cccc(-c3ccc(-c4ccnc(-n5c6ccccc6c6ccc(-c7cccc8c7sc7ccccc78)cc65)n4)cc3)c2)cc1 ; c1ccc(-c2cccc(-c3ccc(-c4ccnc(-n5c6ccccc6c6cc(-c7cccc8c7sc7ccccc78)ccc65)n4)cc3)c2)cc1 ; c1cc(-c2ccnc(-n3c4ccccc4c4cc(-c5cccc6c5sc5ccccc56)ccc43)n2)cc(-n2c3ccccc3c3ccccc32)c1]

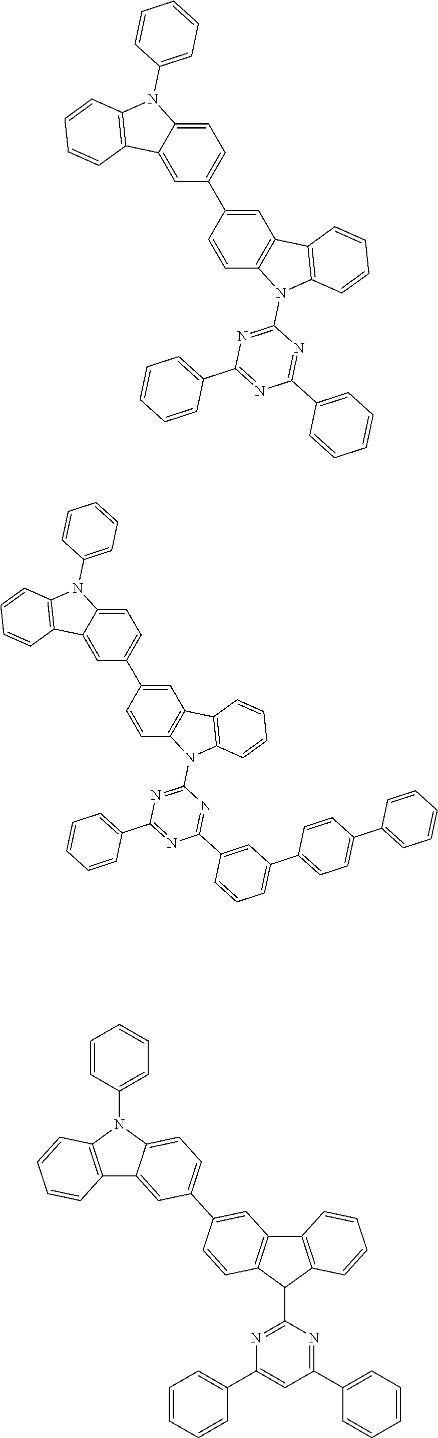 [SMILES: c1ccc(-c2nc(-c3ccccc3)nc(-n3c4ccccc4c4cc(-c5ccc6c(c5)c5ccccc5n6-c5ccccc5)ccc43)n2)cc1 ; c1ccc(-c2ccc(-c3cccc(-c4nc(-c5ccccc5)nc(-n5c6ccccc6c6cc(-c7ccc8c(c7)c7ccccc7n8-c7ccccc7)ccc65)n4)c3)cc2)cc1 ; c1ccc(-c2cc(-c3ccccc3)nc(C3c4ccccc4-c4cc(-c5ccc6c(c5)c5ccccc5n6-c5ccccc5)ccc43)n2)cc1]

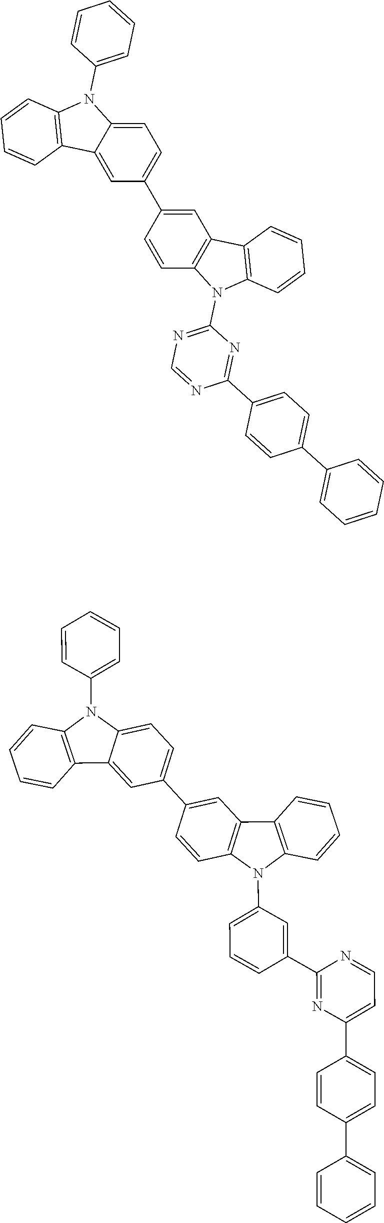 [SMILES: c1ccc(-c2ccc(-c3ncnc(-n4c5ccccc5c5cc(-c6ccc7c(c6)c6ccccc6n7-c6ccccc6)ccc54)n3)cc2)cc1 ; c1ccc(-c2ccc(-c3ccnc(-c4cccc(-n5c6ccccc6c6cc(-c7ccc8c(c7)c7ccccc7n8-c7ccccc7)ccc65)c4)n3)cc2)cc1]

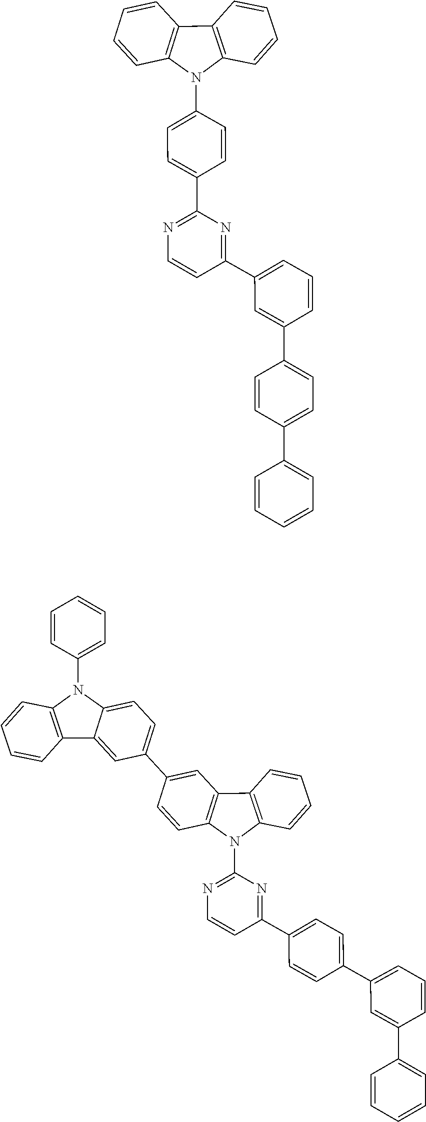 [SMILES: c1ccc(-c2ccc(-c3cccc(-c4ccnc(-c5ccc(-n6c7ccccc7c7ccccc76)cc5)n4)c3)cc2)cc1 ; c1ccc(-c2cccc(-c3ccc(-c4ccnc(-n5c6ccccc6c6cc(-c7ccc8c(c7)c7ccccc7n8-c7ccccc7)ccc65)n4)cc3)c2)cc1]

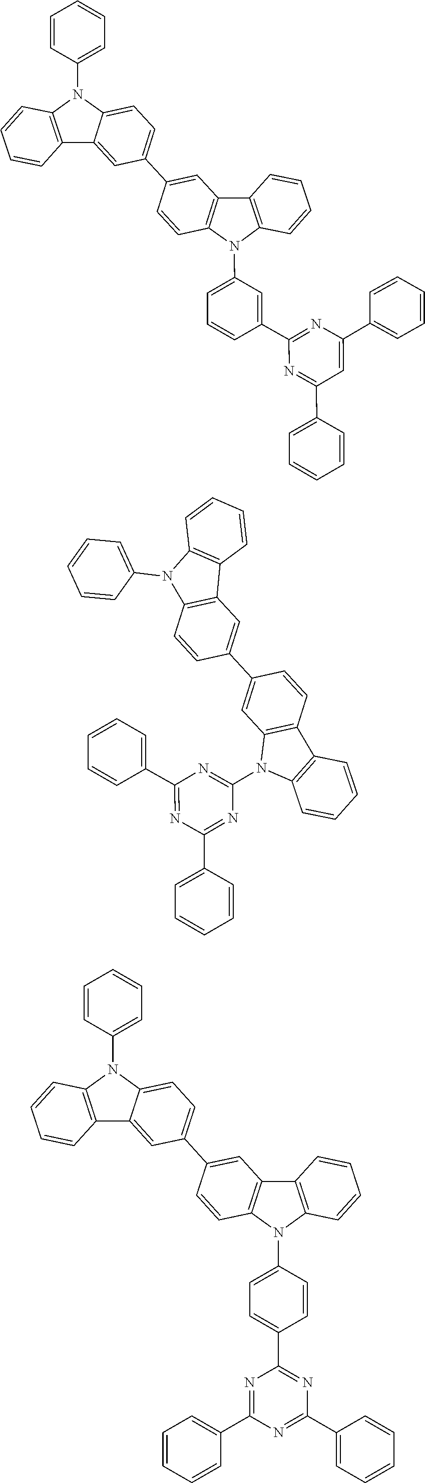 [SMILES: c1ccc(-c2cc(-c3ccccc3)nc(-c3cccc(-n4c5ccccc5c5cc(-c6ccc7c(c6)c6ccccc6n7-c6ccccc6)ccc54)c3)n2)cc1 ; c1ccc(-c2nc(-c3ccccc3)nc(-n3c4ccccc4c4ccc(-c5ccc6c(c5)c5ccccc5n6-c5ccccc5)cc43)n2)cc1 ; c1ccc(-c2nc(-c3ccccc3)nc(-c3ccc(-n4c5ccccc5c5cc(-c6ccc7c(c6)c6ccccc6n7-c6ccccc6)ccc54)cc3)n2)cc1]

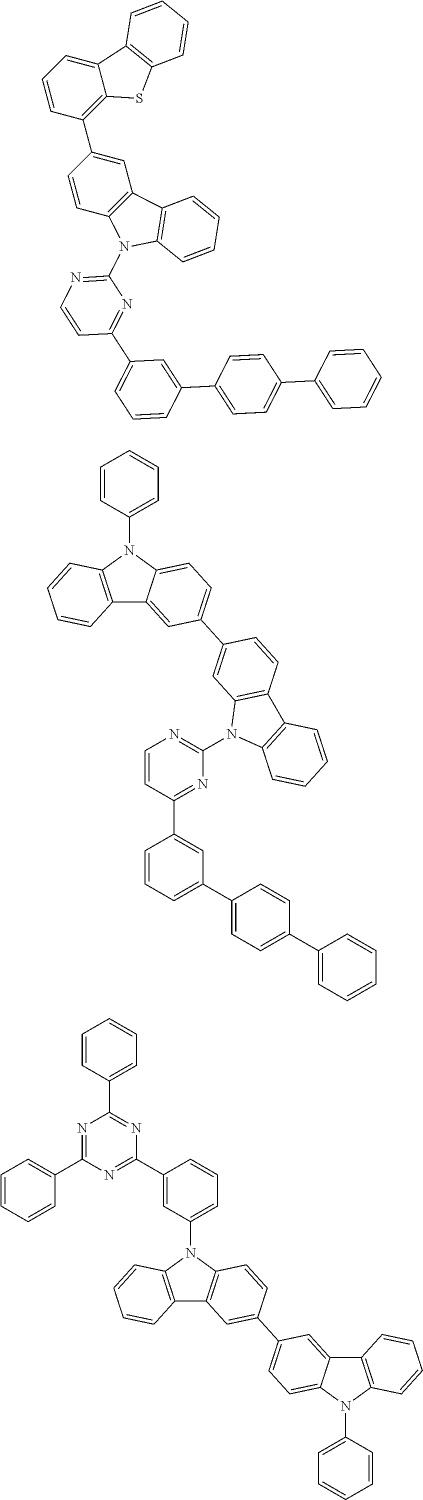

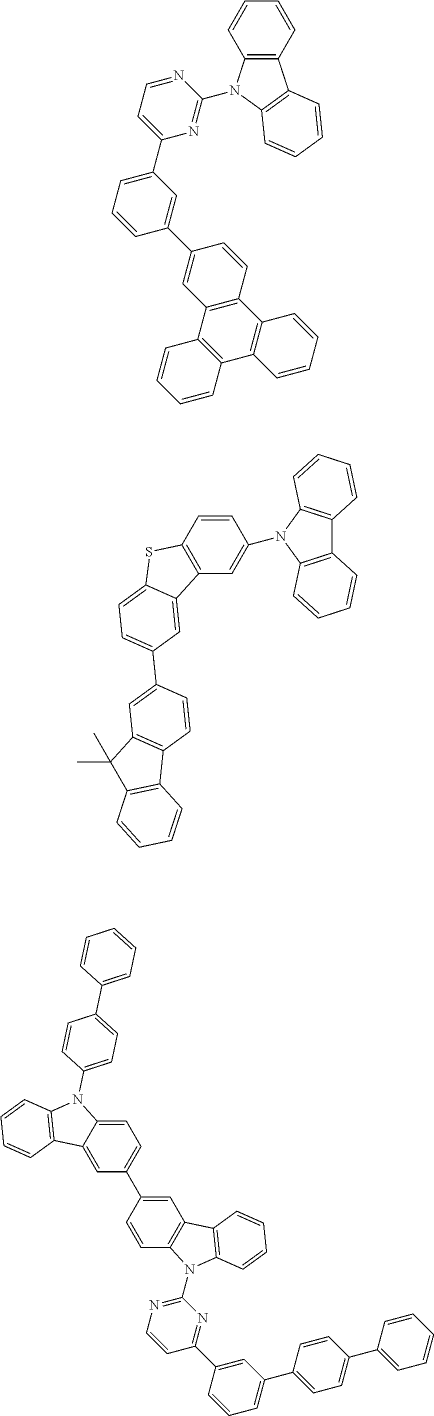 [SMILES: c1cc(-c2ccc3c4ccccc4c4ccccc4c3c2)cc(-c2ccnc(-n3c4ccccc4c4ccccc43)n2)c1 ; CC1(C)c2ccccc2-c2ccc(-c3ccc4sc5ccc(-n6c7ccccc7c7ccccc76)cc5c4c3)cc21 ; c1ccc(-c2ccc(-c3cccc(-c4ccnc(-n5c6ccccc6c6cc(-c7ccc8c(c7)c7ccccc7n8-c7ccc(-c8ccccc8)cc7)ccc65)n4)c3)cc2)cc1]

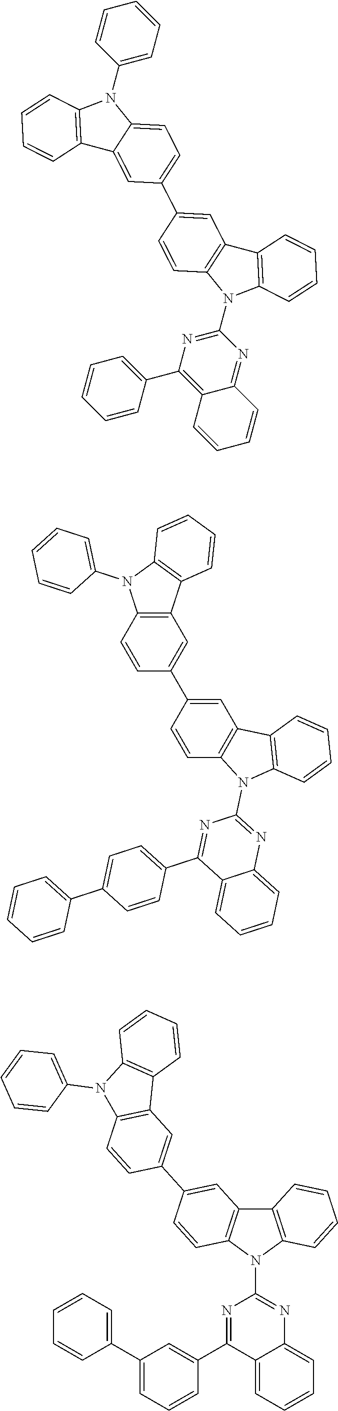 [SMILES: c1ccc(-c2nc(-n3c4ccccc4c4cc(-c5ccc6c(c5)c5ccccc5n6-c5ccccc5)ccc43)nc3ccccc23)cc1 ; c1ccc(-c2ccc(-c3nc(-n4c5ccccc5c5cc(-c6ccc7c(c6)c6ccccc6n7-c6ccccc6)ccc54)nc4ccccc34)cc2)cc1 ; c1ccc(-c2cccc(-c3nc(-n4c5ccccc5c5cc(-c6ccc7c(c6)c6ccccc6n7-c6ccccc6)ccc54)nc4ccccc34)c2)cc1]

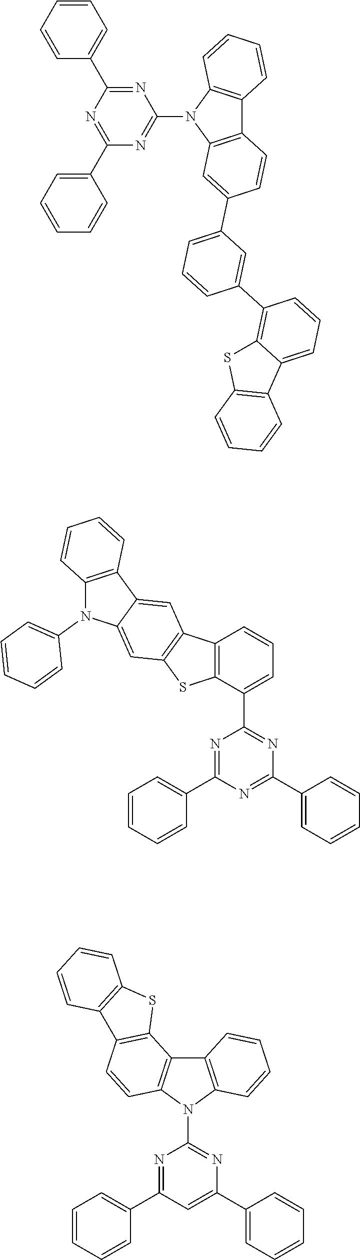 [SMILES: c1ccc(-c2nc(-c3ccccc3)nc(-n3c4ccccc4c4ccc(-c5cccc(-c6cccc7c6sc6ccccc67)c5)cc43)n2)cc1 ; c1ccc(-c2nc(-c3ccccc3)nc(-c3cccc4c3sc3cc5c(cc34)c3ccccc3n5-c3ccccc3)n2)cc1 ; c1ccc(-c2cc(-c3ccccc3)nc(-n3c4ccccc4c4c5sc6ccccc6c5ccc43)n2)cc1]

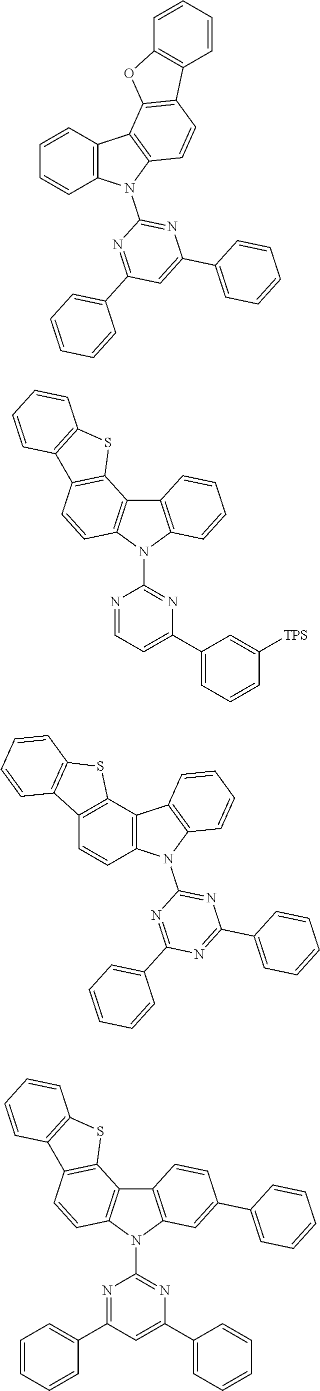

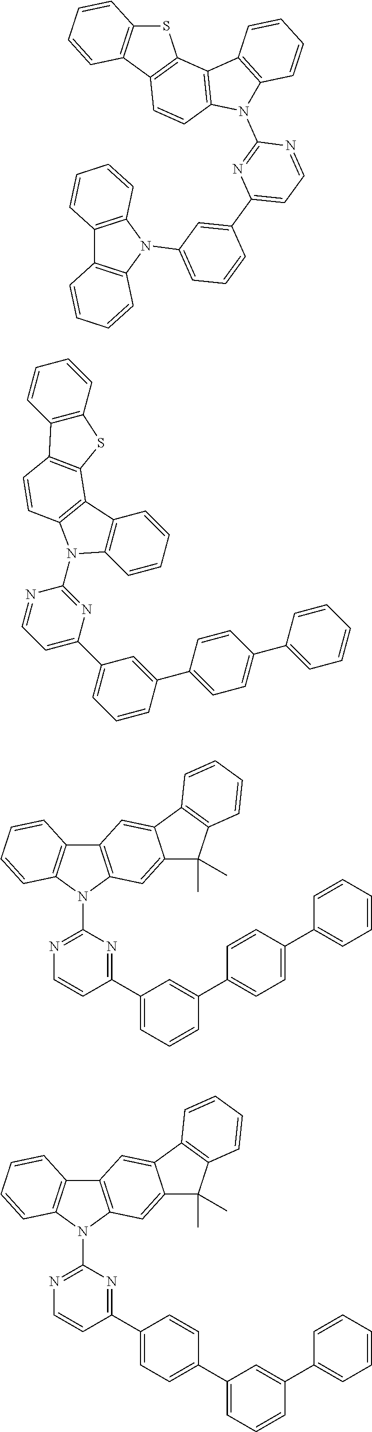

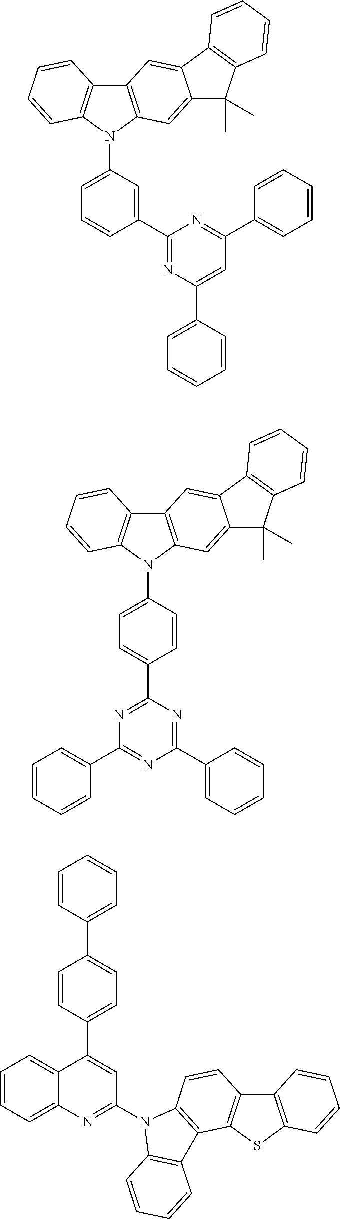 [SMILES: CC1(C)c2ccccc2-c2cc3c4ccccc4n(-c4cccc(-c5nc(-c6ccccc6)cc(-c6ccccc6)n5)c4)c3cc21 ; CC1(C)c2ccccc2-c2cc3c4ccccc4n(-c4ccc(-c5nc(-c6ccccc6)nc(-c6ccccc6)n5)cc4)c3cc21 ; c1ccc(-c2ccc(-c3cc(-n4c5ccccc5c5c6sc7ccccc7c6ccc54)nc4ccccc34)cc2)cc1]

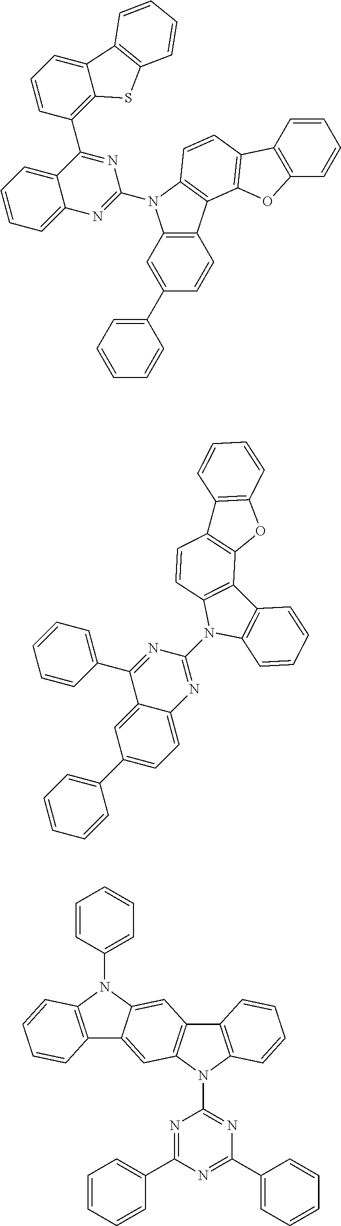 [SMILES: c1ccc(-c2ccc3c4c5oc6ccccc6c5ccc4n(-c4nc(-c5cccc6c5sc5ccccc56)c5ccccc5n4)c3c2)cc1 ; c1ccc(-c2ccc3nc(-n4c5ccccc5c5c6oc7ccccc7c6ccc54)nc(-c4ccccc4)c3c2)cc1 ; c1ccc(-c2nc(-c3ccccc3)nc(-n3c4ccccc4c4cc5c(cc43)c3ccccc3n5-c3ccccc3)n2)cc1]

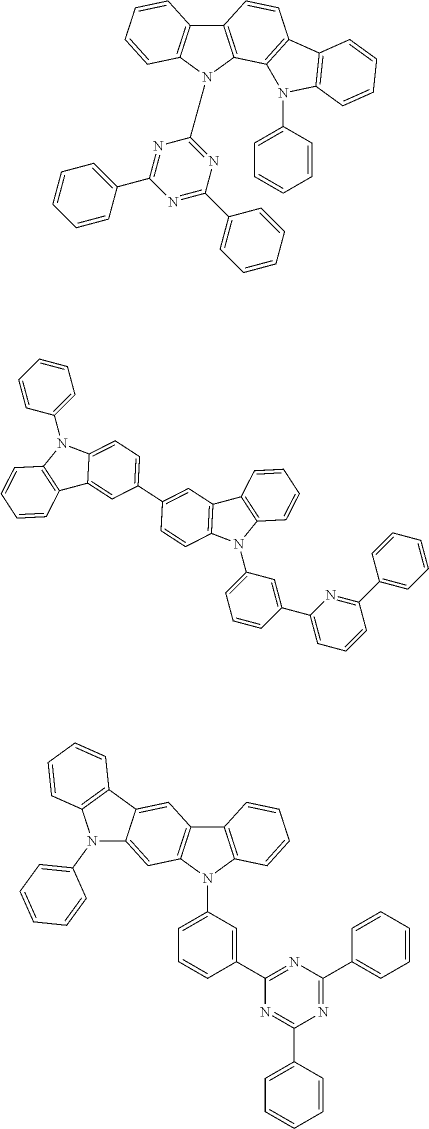 [SMILES: c1ccc(-c2nc(-c3ccccc3)nc(-n3c4ccccc4c4ccc5c6ccccc6n(-c6ccccc6)c5c43)n2)cc1 ; c1ccc(-c2cccc(-c3cccc(-n4c5ccccc5c5cc(-c6ccc7c(c6)c6ccccc6n7-c6ccccc6)ccc54)c3)n2)cc1 ; c1ccc(-c2nc(-c3ccccc3)nc(-c3cccc(-n4c5ccccc5c5cc6c7ccccc7n(-c7ccccc7)c6cc54)c3)n2)cc1]

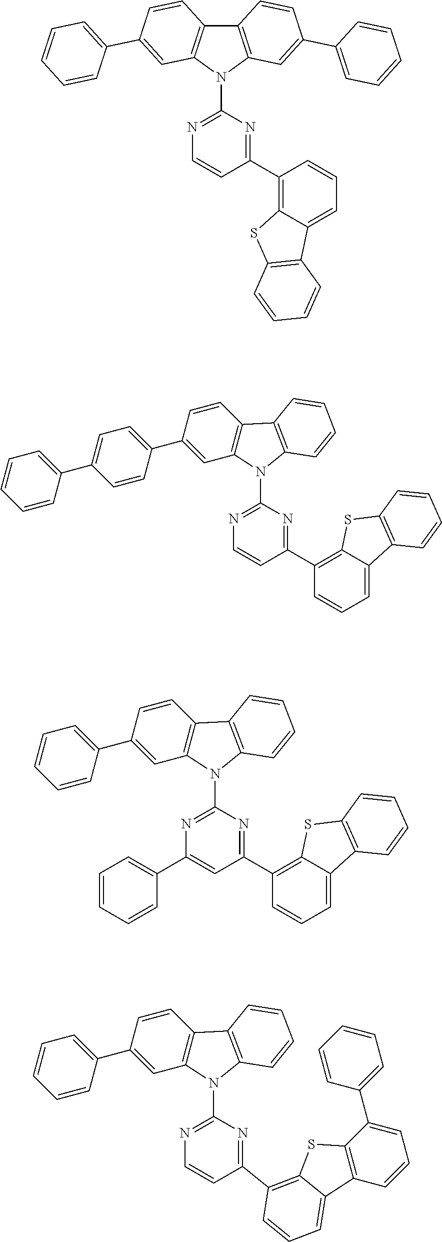 [SMILES: c1ccc(-c2ccc3c4ccc(-c5ccccc5)cc4n(-c4nccc(-c5cccc6c5sc5ccccc56)n4)c3c2)cc1 ; c1ccc(-c2ccc(-c3ccc4c5ccccc5n(-c5nccc(-c6cccc7c6sc6ccccc67)n5)c4c3)cc2)cc1 ; c1ccc(-c2ccc3c4ccccc4n(-c4nc(-c5ccccc5)cc(-c5cccc6c5sc5ccccc56)n4)c3c2)cc1 ; c1ccc(-c2ccc3c4ccccc4n(-c4nccc(-c5cccc6c5sc5c(-c7ccccc7)cccc56)n4)c3c2)cc1]

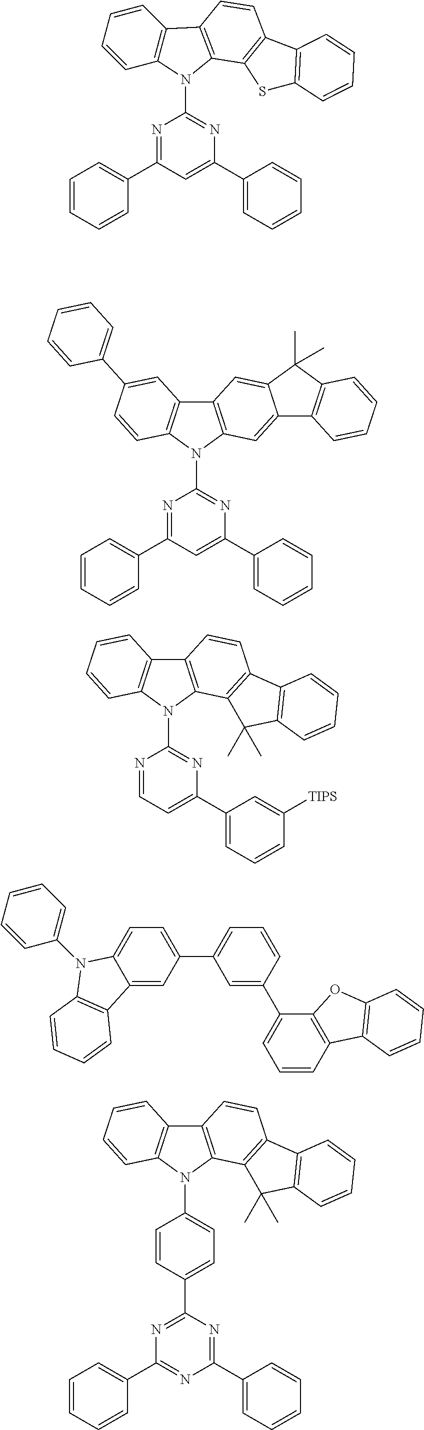

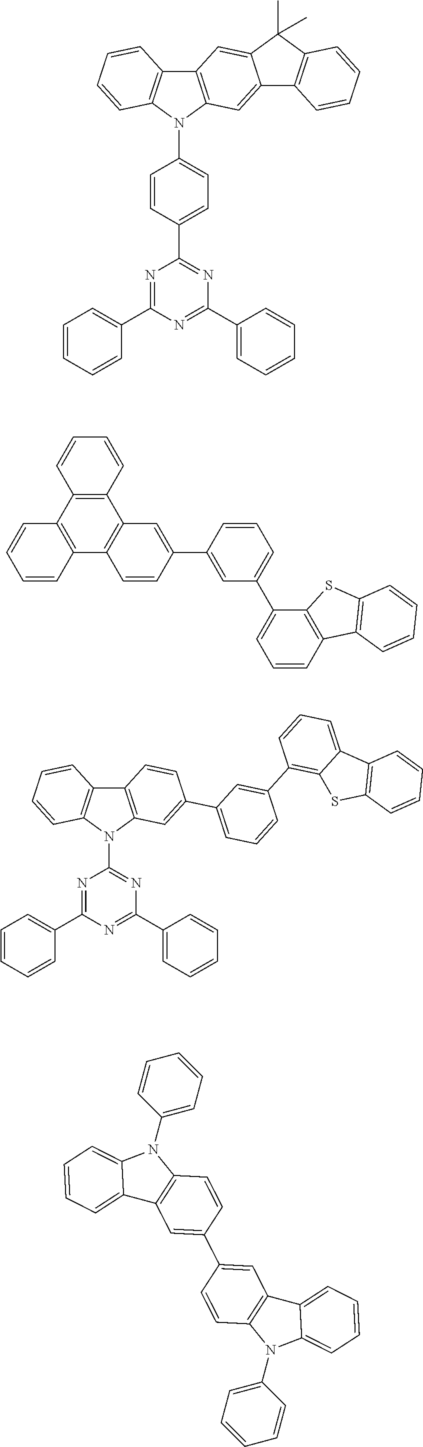 [SMILES: CC1(C)c2ccccc2-c2cc3c(cc21)c1ccccc1n3-c1ccc(-c2nc(-c3ccccc3)nc(-c3ccccc3)n2)cc1 ; c1cc(-c2ccc3c4ccccc4c4ccccc4c3c2)cc(-c2cccc3c2sc2ccccc23)c1 ; c1ccc(-c2nc(-c3ccccc3)nc(-n3c4ccccc4c4ccc(-c5cccc(-c6cccc7c6sc6ccccc67)c5)cc43)n2)cc1 ; c1ccc(-n2c3ccccc3c3cc(-c4ccc5c(c4)c4ccccc4n5-c4ccccc4)ccc32)cc1]

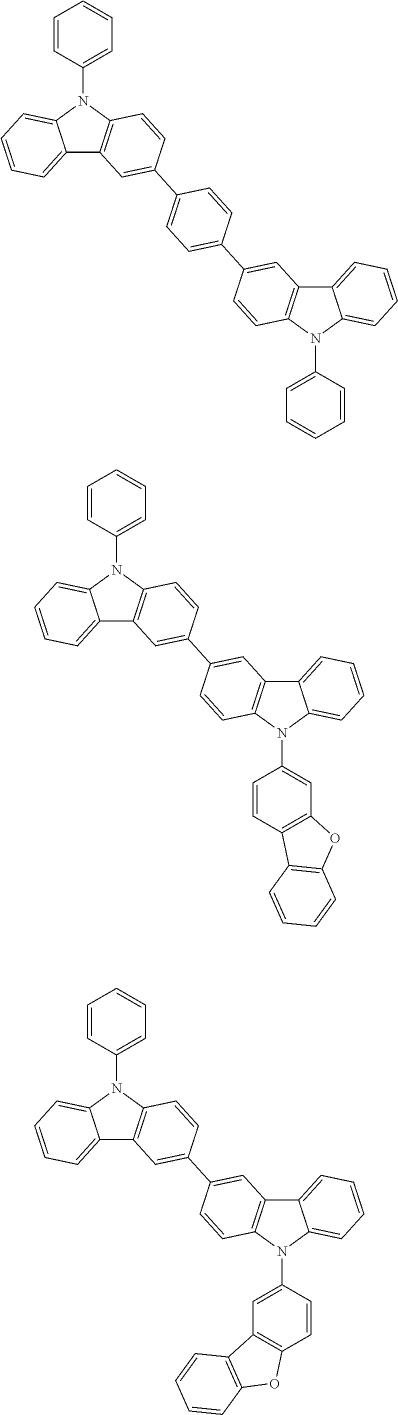 [SMILES: c1ccc(-n2c3ccccc3c3cc(-c4ccc(-c5ccc6c(c5)c5ccccc5n6-c5ccccc5)cc4)ccc32)cc1 ; c1ccc(-n2c3ccccc3c3cc(-c4ccc5c(c4)c4ccccc4n5-c4ccc5c(c4)oc4ccccc45)ccc32)cc1 ; c1ccc(-n2c3ccccc3c3cc(-c4ccc5c(c4)c4ccccc4n5-c4ccc5oc6ccccc6c5c4)ccc32)cc1]

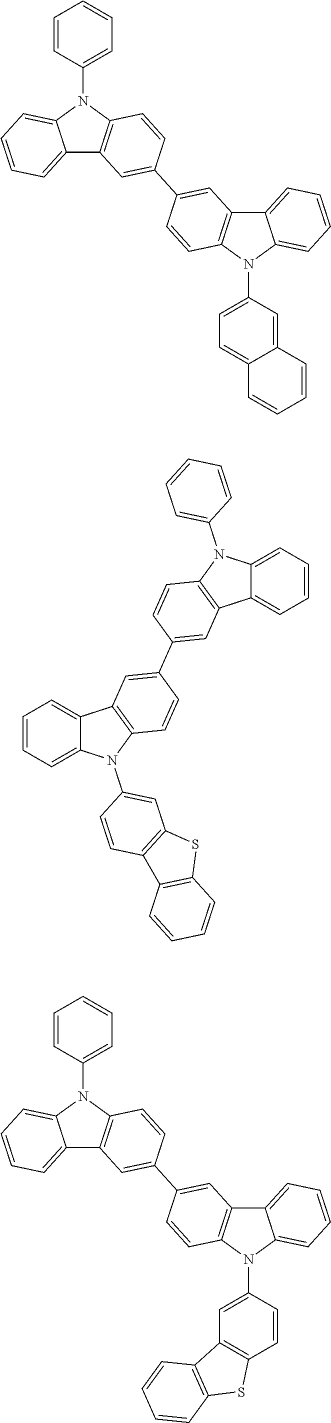 [SMILES: c1ccc(-n2c3ccccc3c3cc(-c4ccc5c(c4)c4ccccc4n5-c4ccc5ccccc5c4)ccc32)cc1 ; c1ccc(-n2c3ccccc3c3cc(-c4ccc5c(c4)c4ccccc4n5-c4ccc5c(c4)sc4ccccc45)ccc32)cc1 ; c1ccc(-n2c3ccccc3c3cc(-c4ccc5c(c4)c4ccccc4n5-c4ccc5sc6ccccc6c5c4)ccc32)cc1]

[wherein TPS represents triphenylsilyl.]

The dopant to be comprised in the organic electroluminescent device of the present disclosure is preferably at least one phosphorescent dopant. The phosphorescent dopant material for the organic electroluminescent device of the present disclosure is not limited, but may be preferably selected from metallated complex compounds of iridium (Ir), osmium (Os), copper (Cu) or platinum (Pt), more preferably selected from ortho-metallated complex compounds of iridium (Ir), osmium (Os), copper (Cu) or platinum (Pt), and even more preferably ortho-metallated iridium complex compounds.

The compounds represented by the following formulae 101 to 103 may be used as the dopant to be comprised in the organic electroluminescent device of the present disclosure.

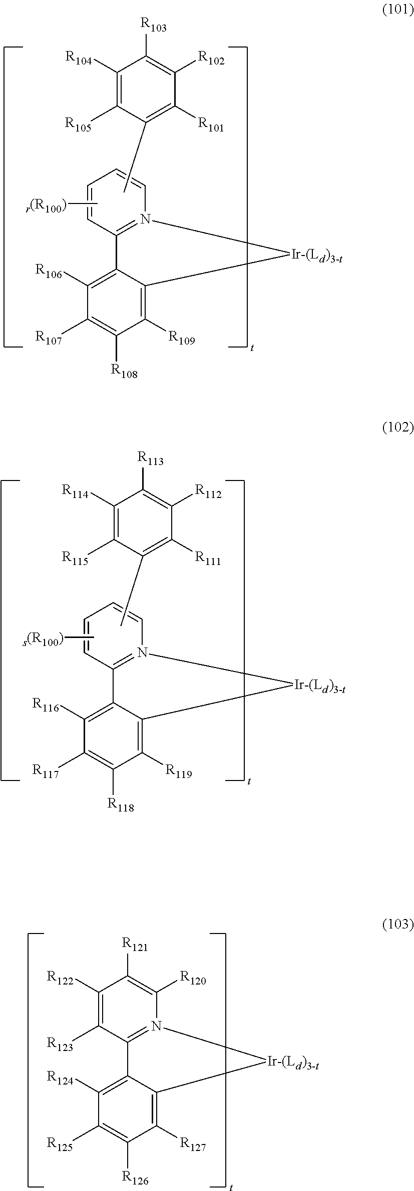

wherein L_{d} is selected from the following structures:

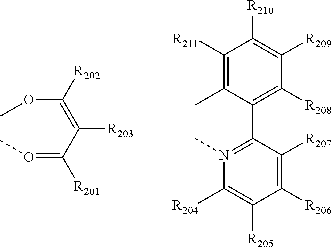

R₁₀₀ represents hydrogen, a substituted or unsubstituted (C1-C30)alkyl, or a substituted or unsubstituted (C3-C30)cycloalkyl;

R₁₀₁ to R₁₀₉ and R₁₁₁ to R₁₂₃, each independently, represent hydrogen, deuterium, a halogen, a (C1-C30)alky substituted or unsubstituted with a halogen, a cyano, a substituted or unsubstituted (C1-C30)alkoxy, a substituted or unsubstituted (C6-C30)aryl, or a substituted or unsubstituted (C3-C30)cycloalkyl; R₁₀₆ to R₁₀₉, each independently, may be linked to an adjacent substituent(s) to form a substituted or unsubstituted fused ring, for example, a fluorene substituted or unsubstituted with an alkyl, a dibenzothiophene substituted or unsubstituted with an alkyl, or a dibenzofuran substituted or unsubstituted with an alkyl; R₁₂₀ to R₁₂₃, each independently, may be linked to an adjacent substituent(s) to form a substituted or unsubstituted fused ring, for example, a quinoline substituted or unsubstituted with an alkyl or aryl;

R₁₂₄ to R₁₂₇, each independently, represent hydrogen, deuterium, a halogen, a substituted or unsubstituted (C1-C30)alkyl, or a substituted or unsubstituted (C6-C30)aryl; R₁₂₄ to R₁₂₇, each independently, may be linked to an adjacent substituent(s) to form a substituted or unsubstituted fused ring, for example, a fluorene substituted or unsubstituted with an alkyl, a dibenzothiophene substituted or unsubstituted with an alkyl, or a dibenzofuran substituted or unsubstituted with an alkyl;

R₂₀₁ to R₂₁₁, each independently, represent hydrogen, deuterium, a halogen, a (C1-C30)alkyl substituted or unsubstituted with a halogen, a substituted or unsubstituted (C3-C30)cycloalkyl, or a substituted or unsubstituted (C6-C30)aryl; R₂₀₁ to R₂₁₁, each independently, may be linked to an adjacent substituent(s) to form a substituted or unsubstituted fused ring, for example, a fluorene substituted or unsubstituted with an alkyl, a dibenzothiophene substituted or unsubstituted with an alkyl, or a dibenzofuran substituted or unsubstituted with an alkyl;

r and s, each independently, represent an integer of 1 to 3; when r or s is an integer of 2 or more, each of R₁₀₀ may be the same or different; and

t represents an integer of 1 to 3.

Specifically, the phosphorescent dopant includes the following:

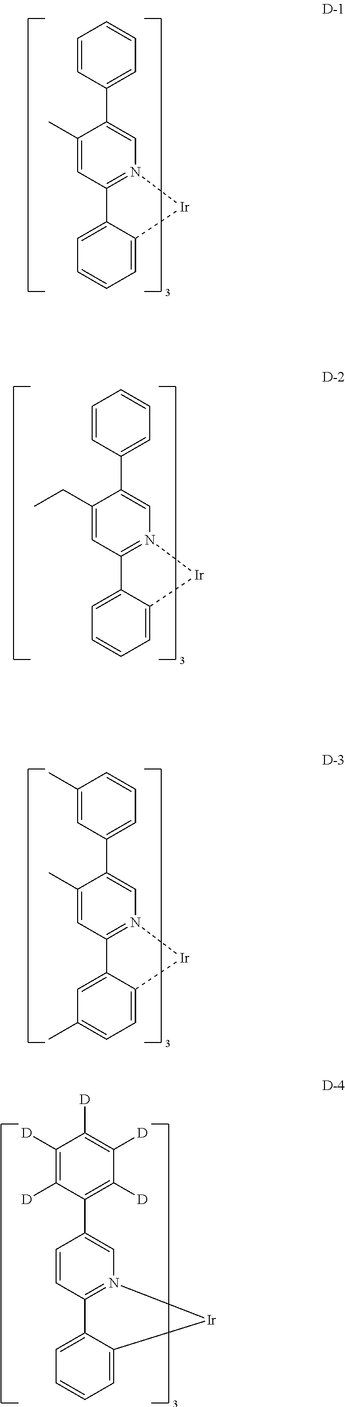

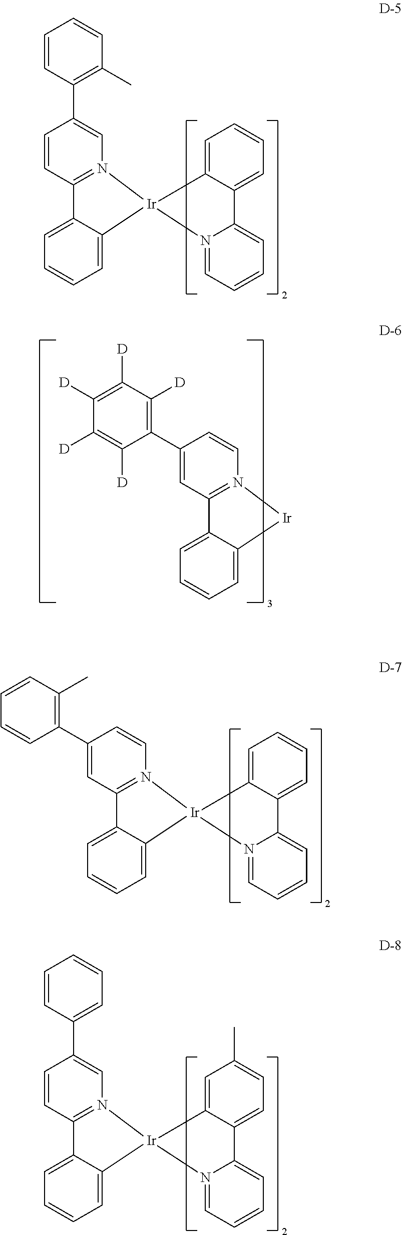

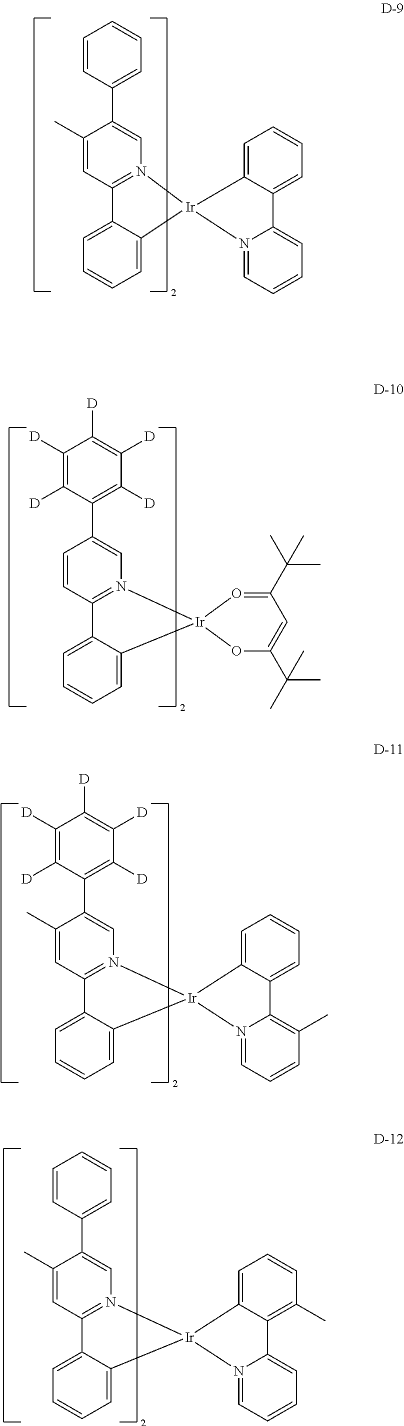

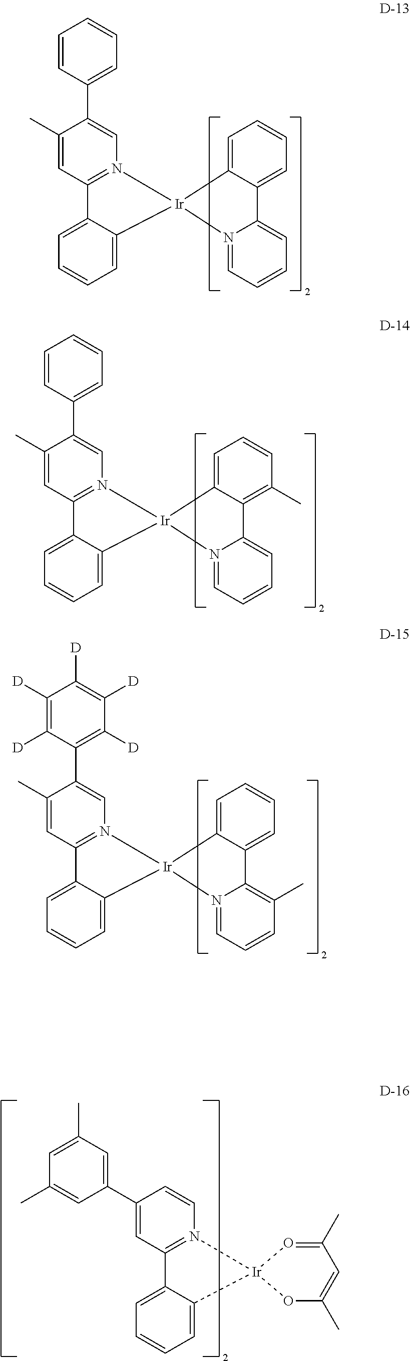

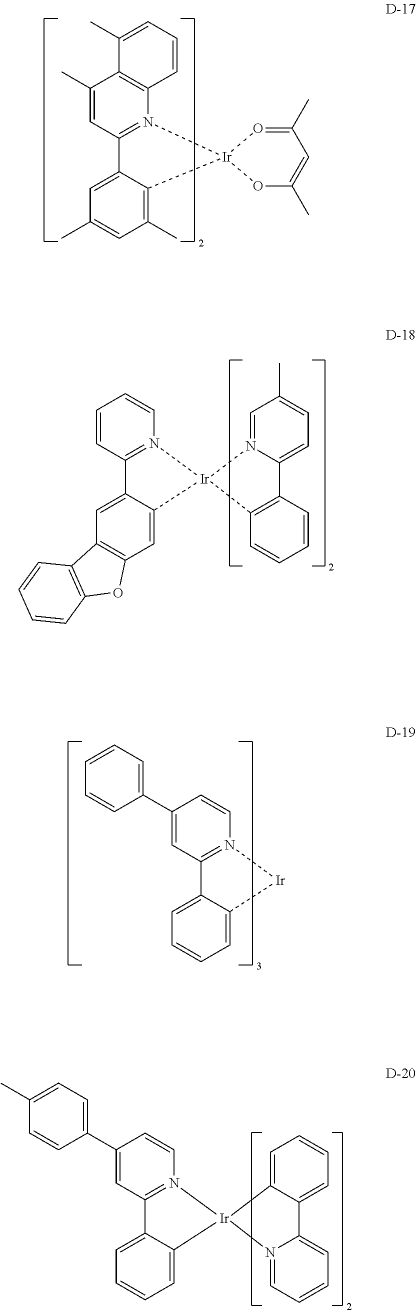

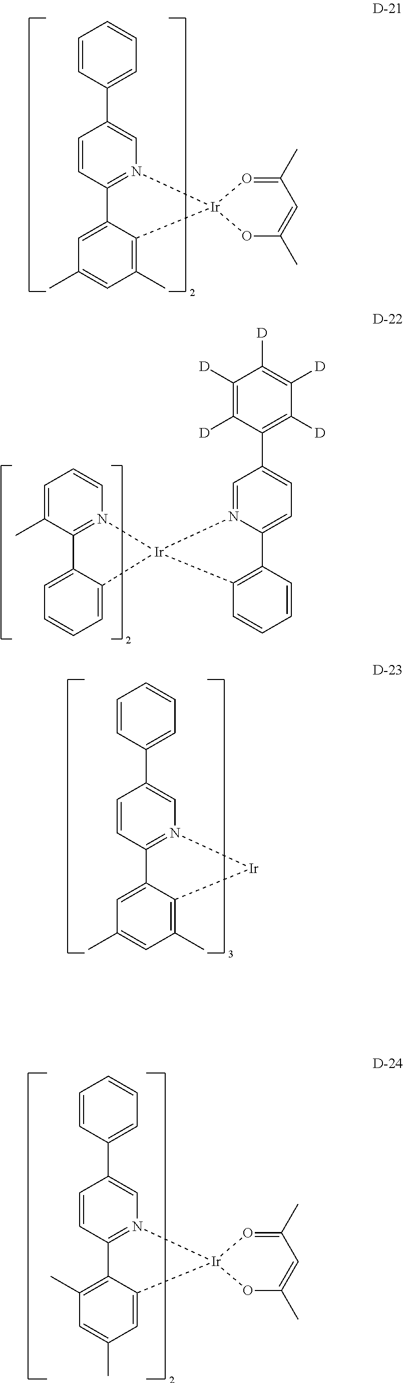

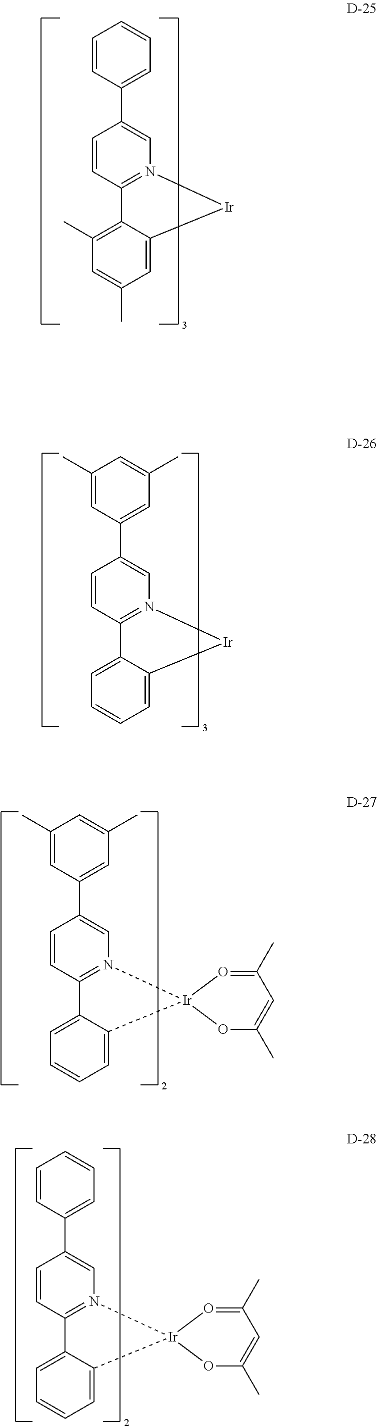

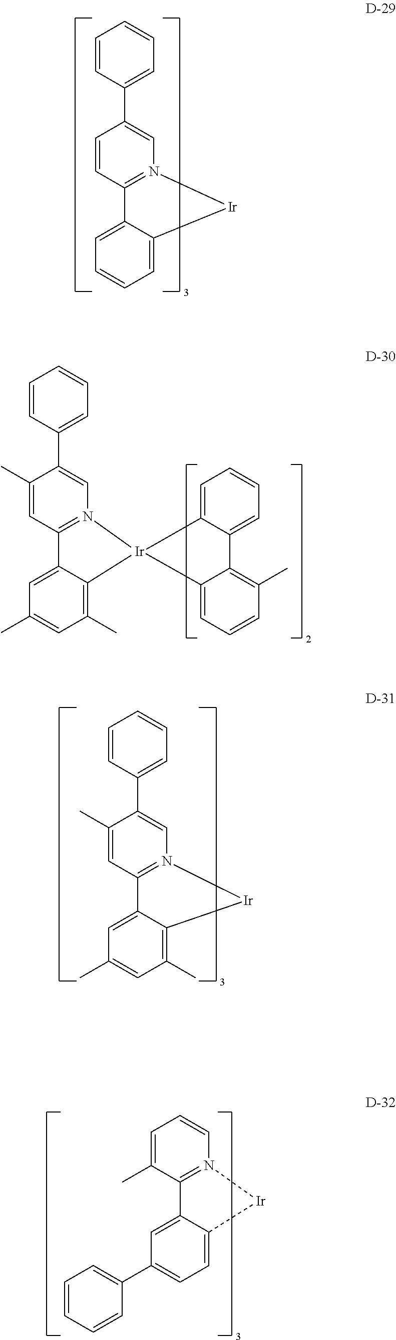

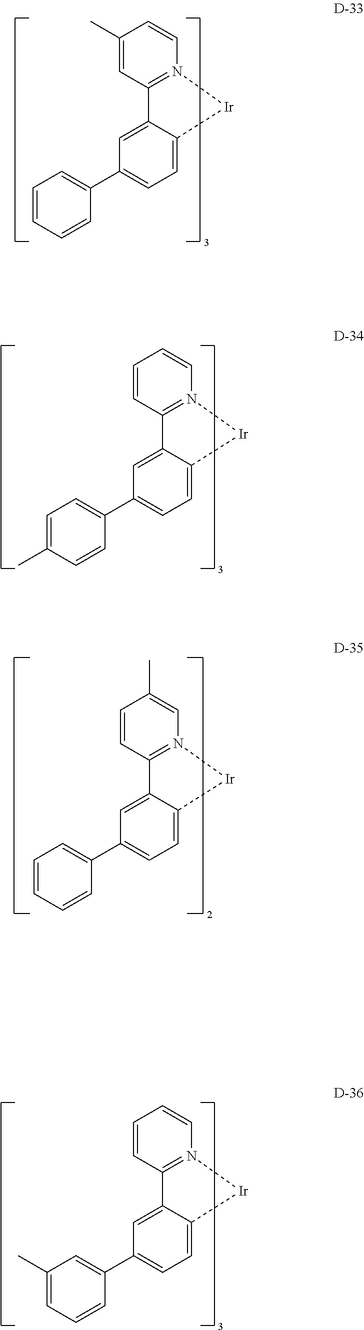

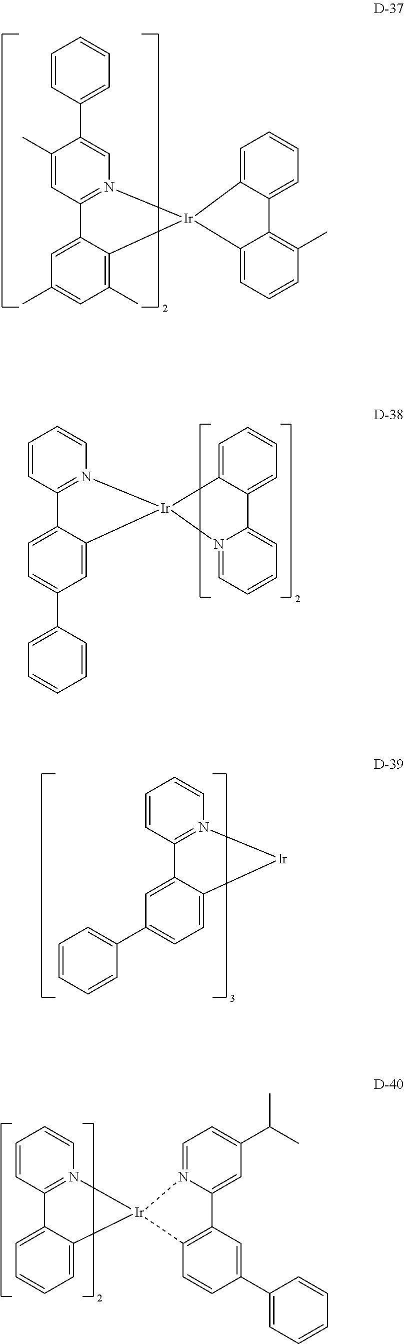

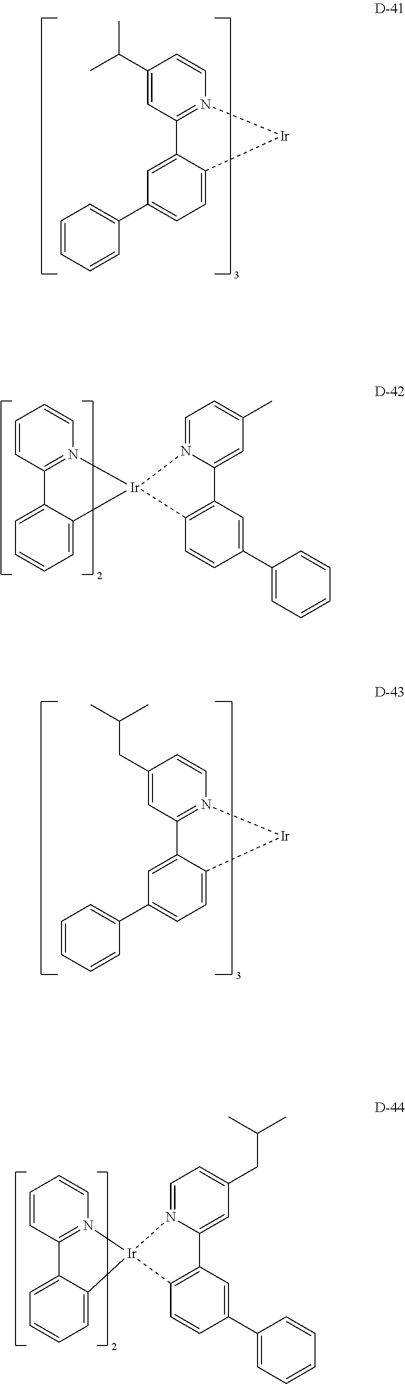

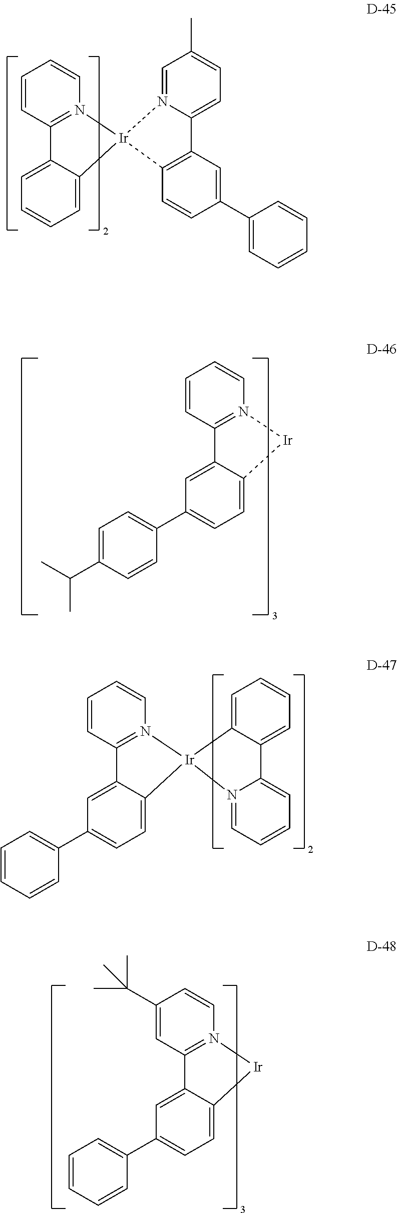

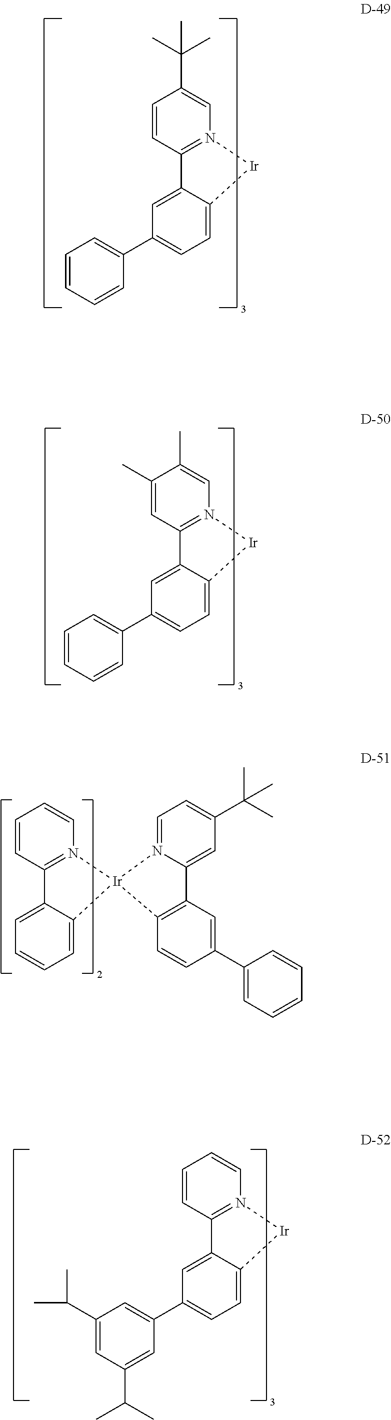

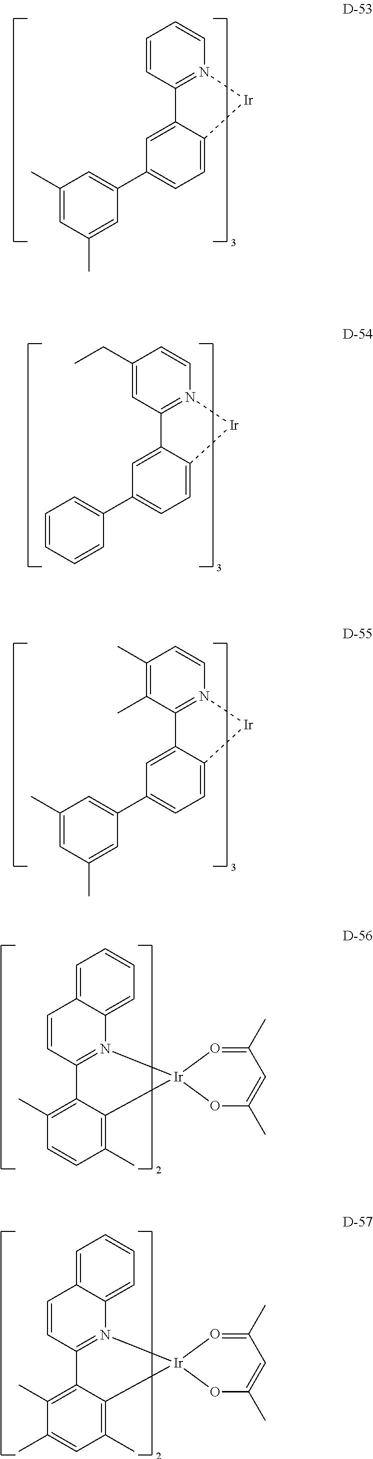

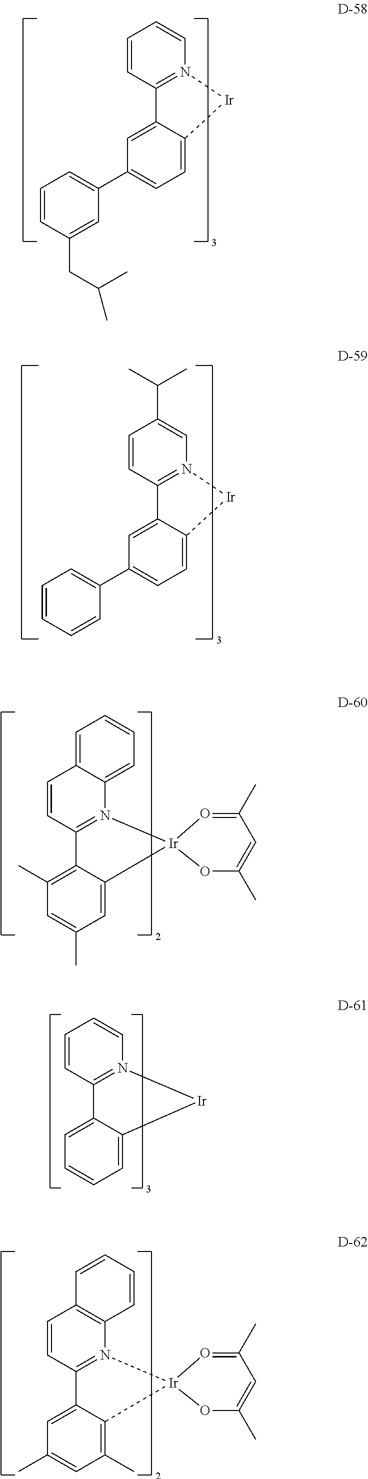

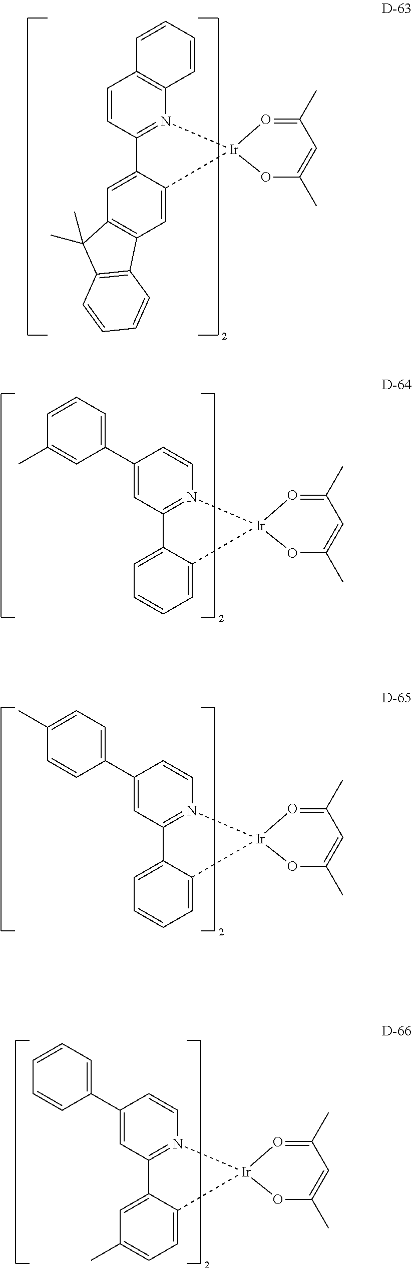

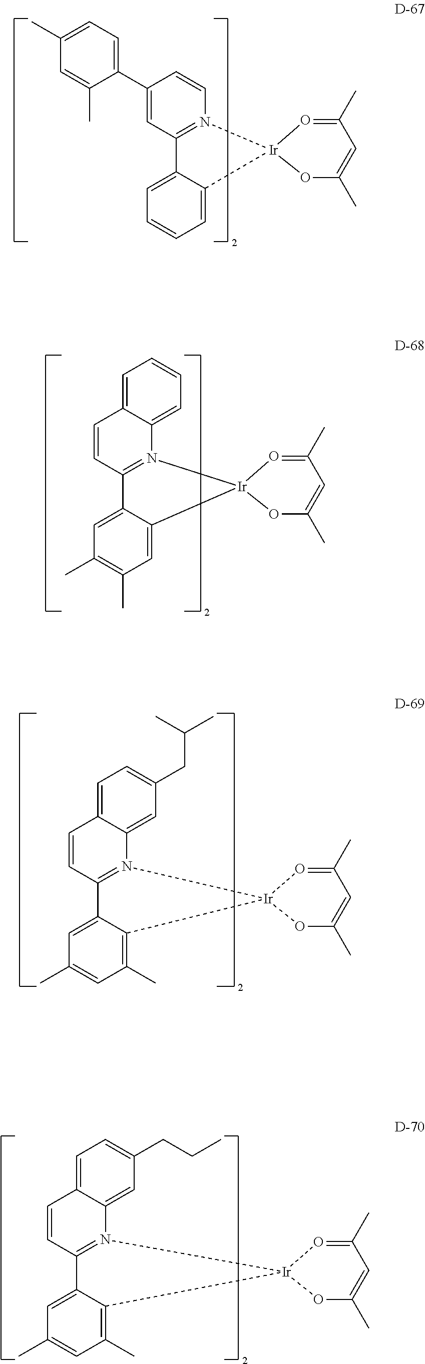

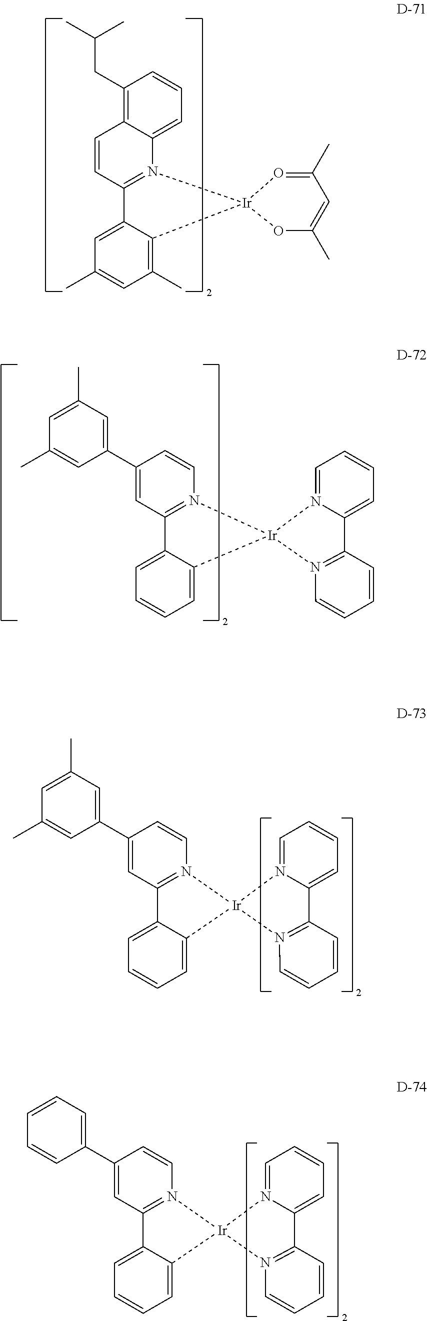

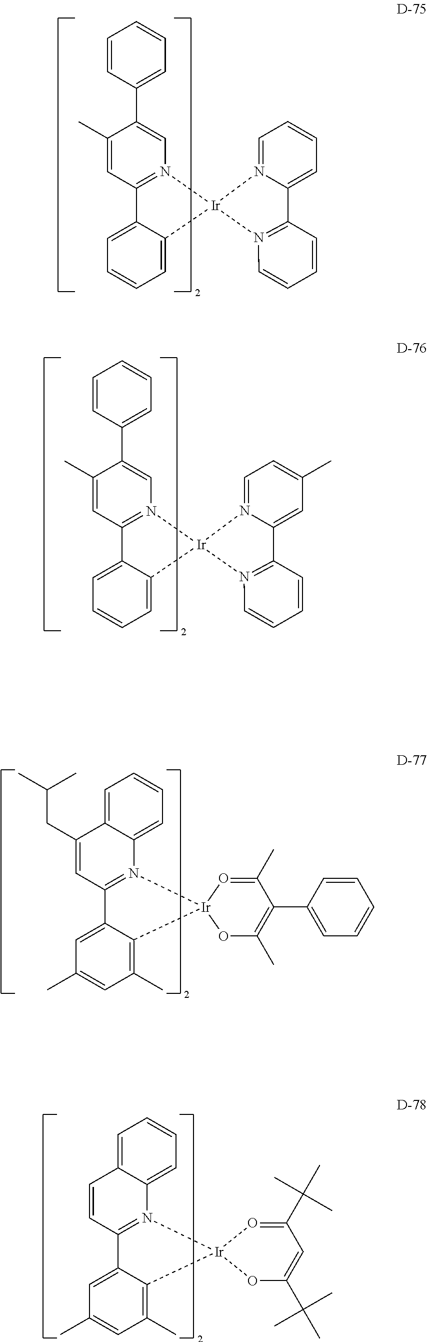

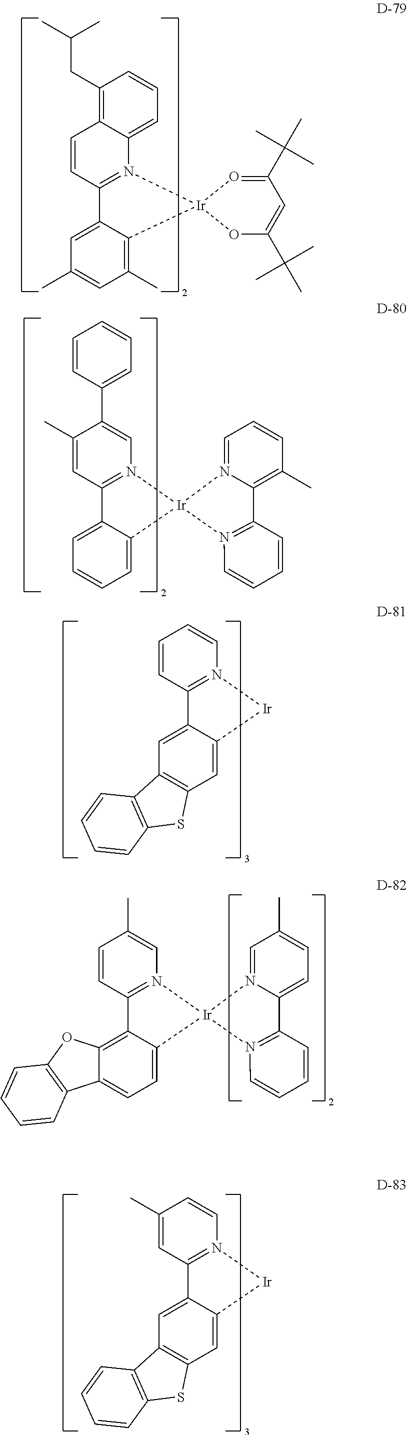

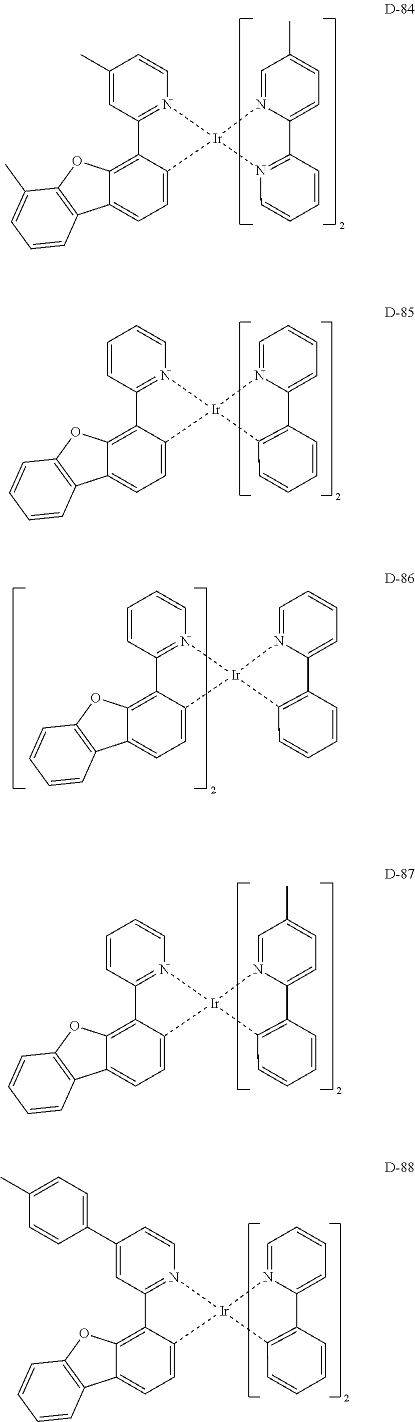

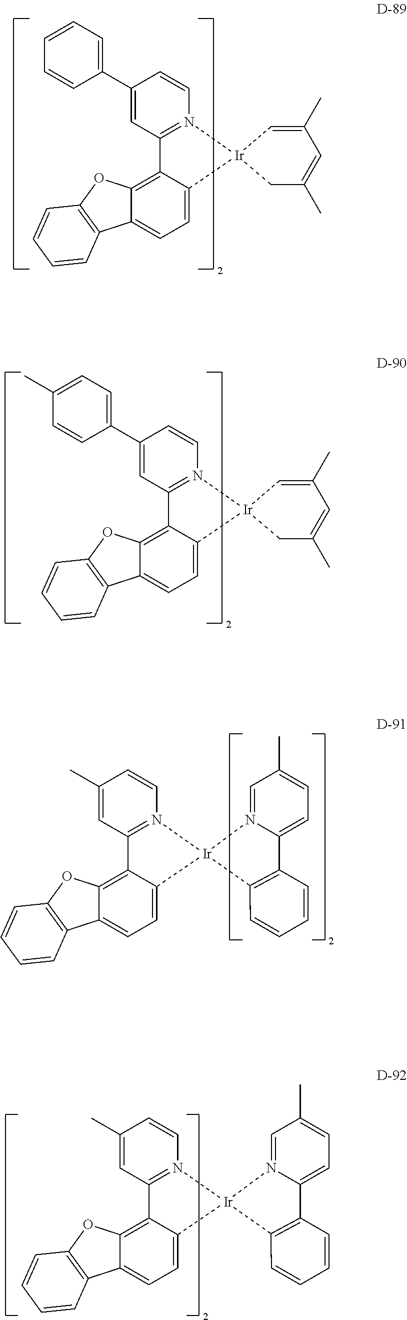

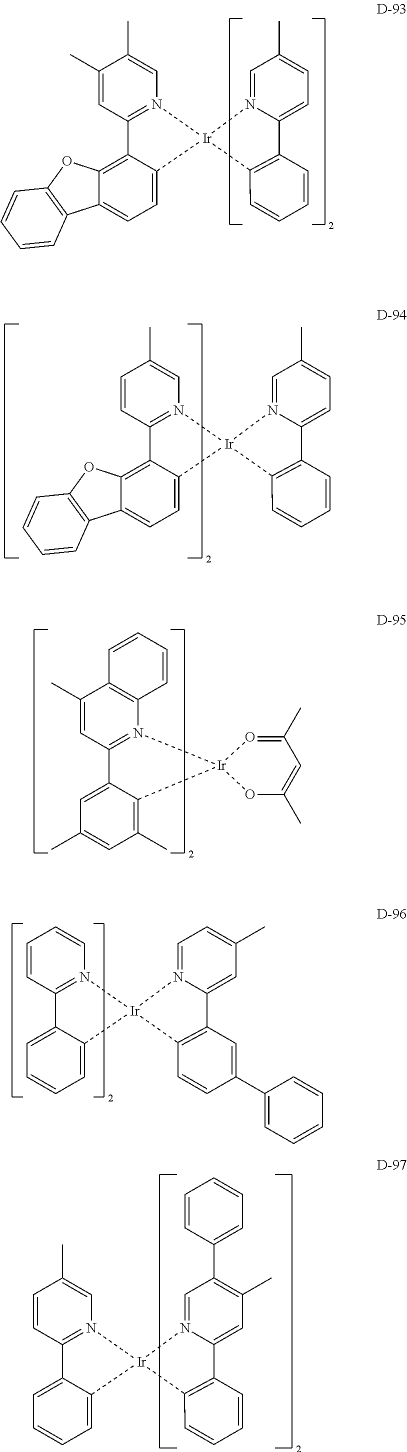

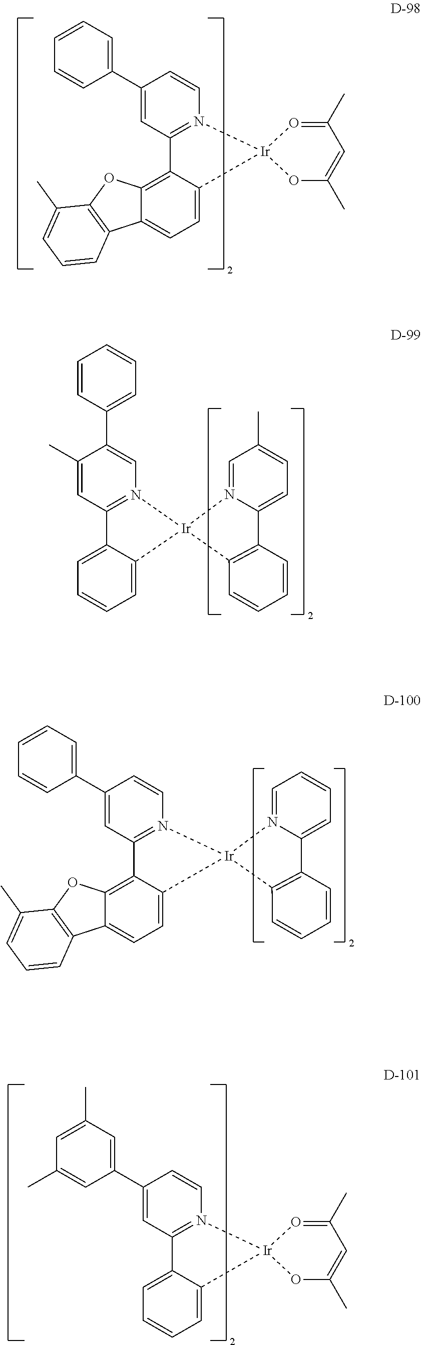

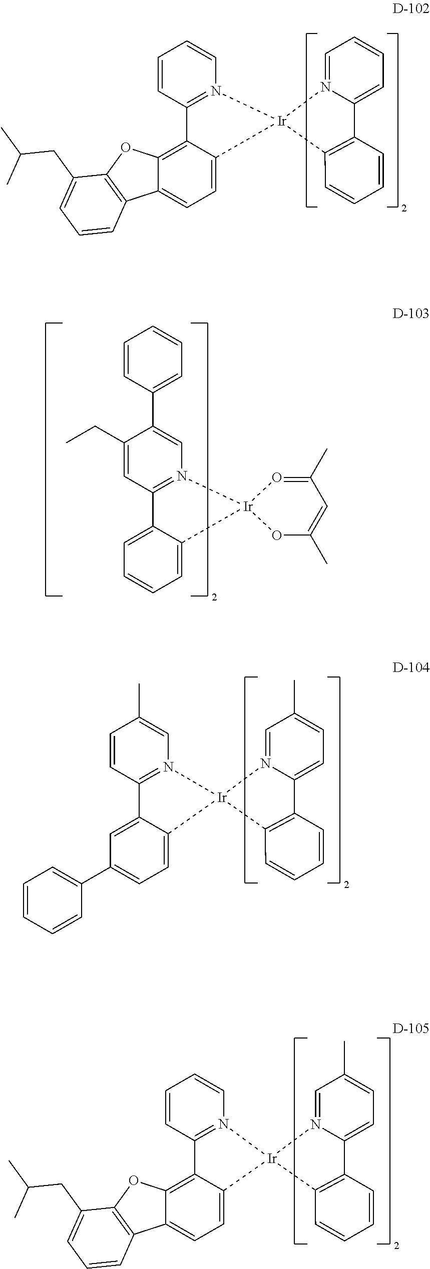

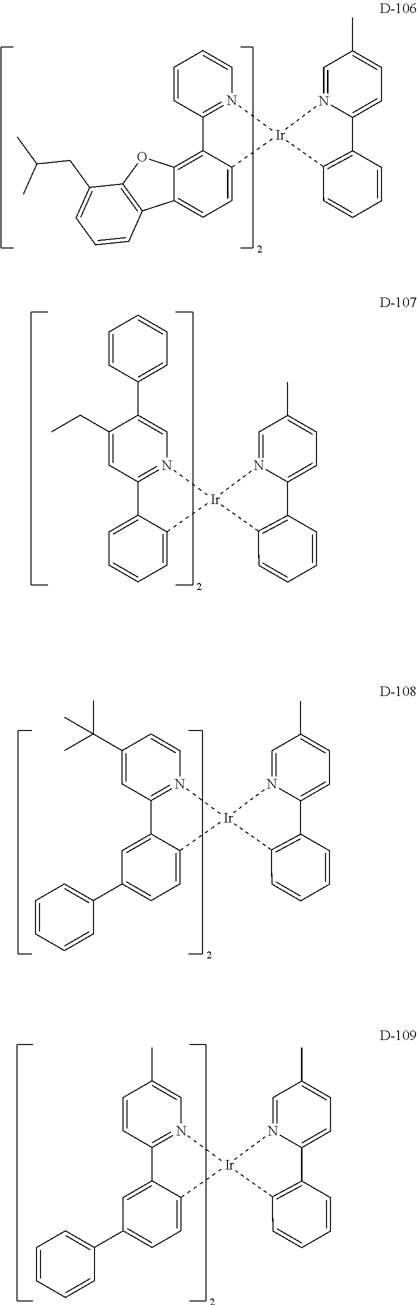

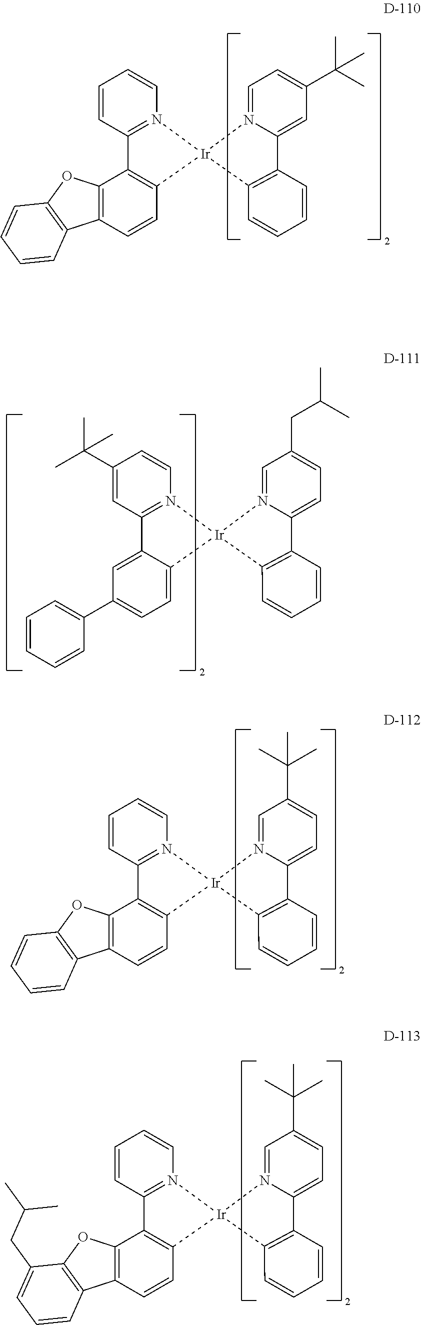

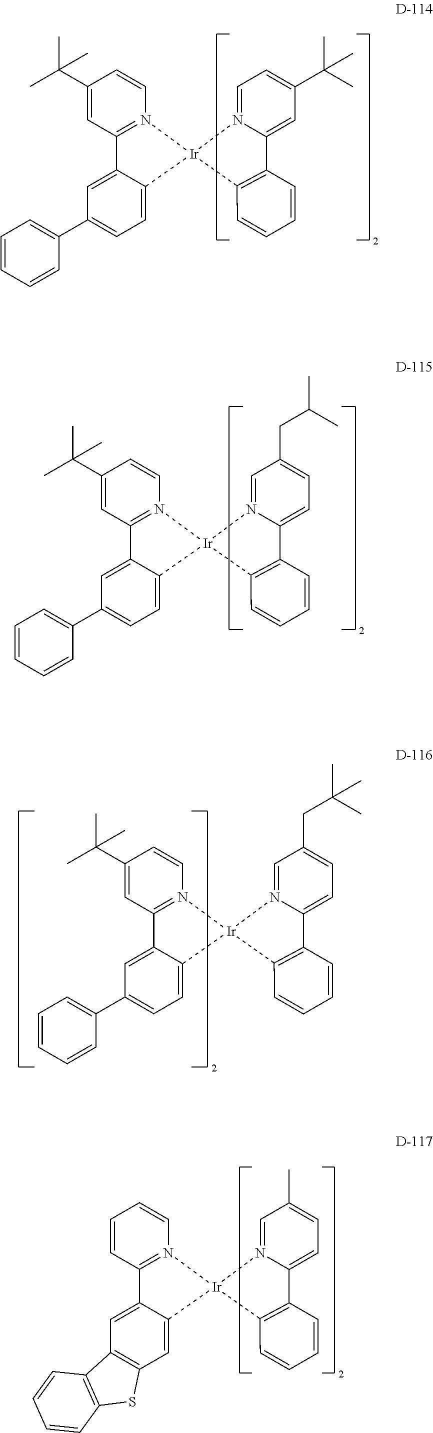

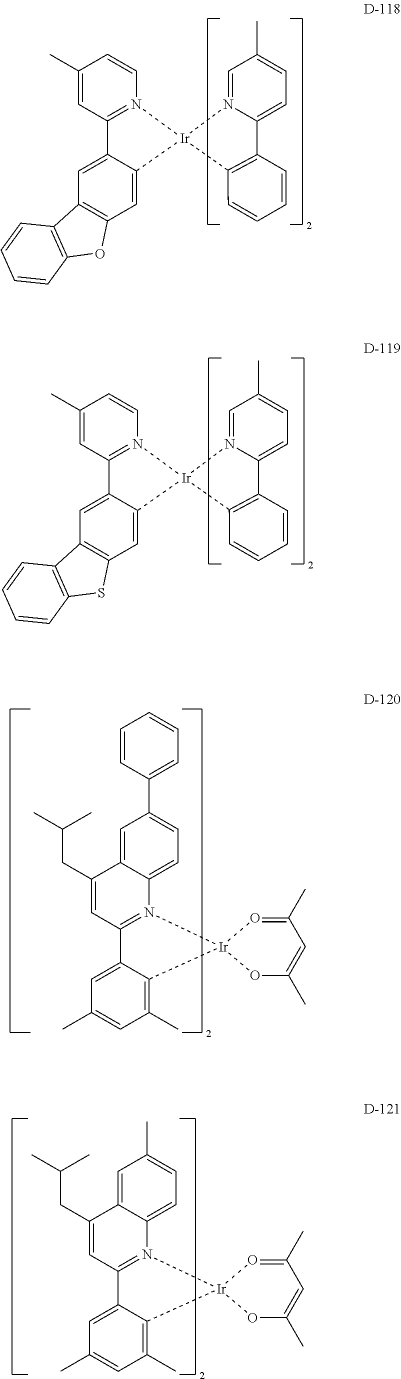

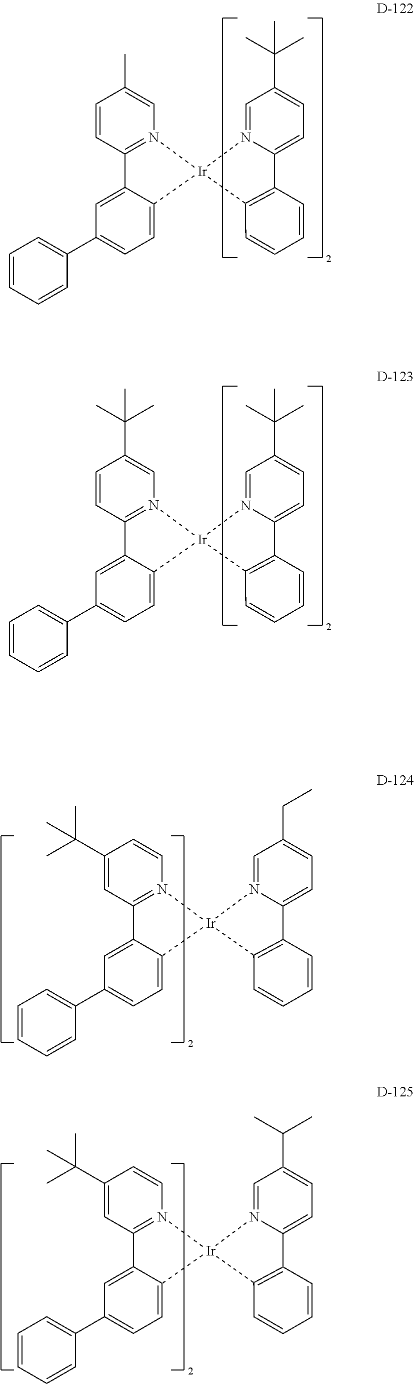

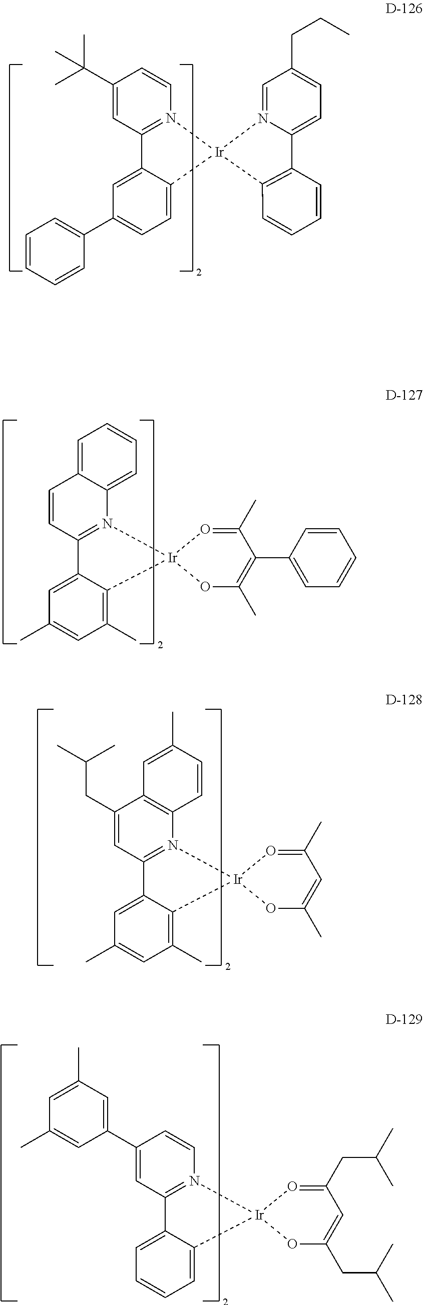

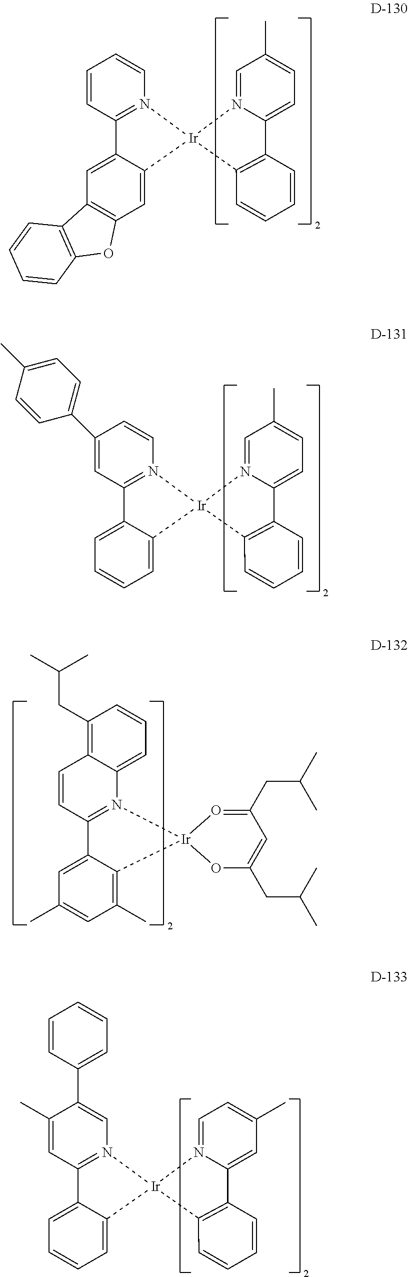

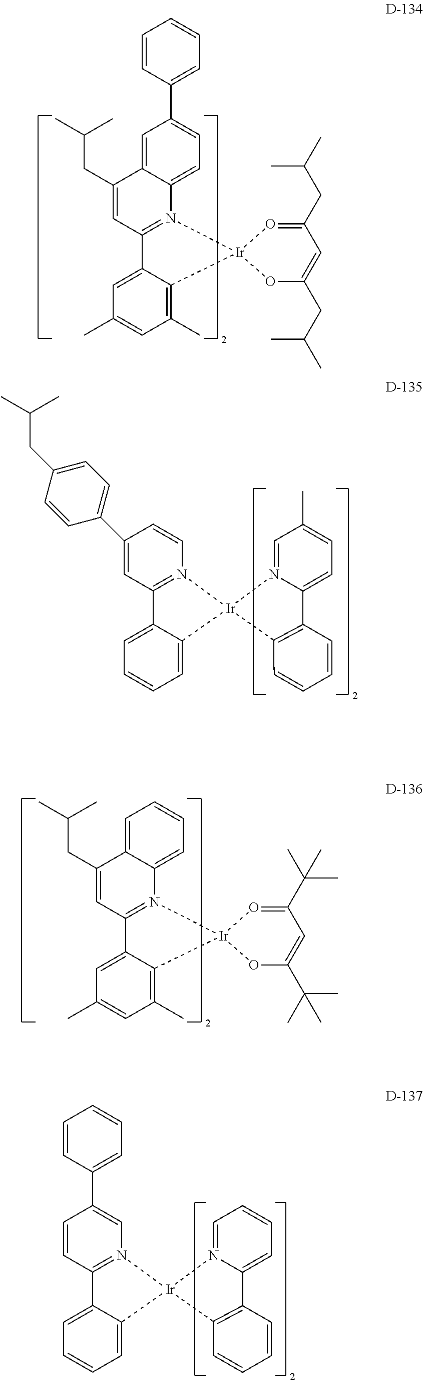

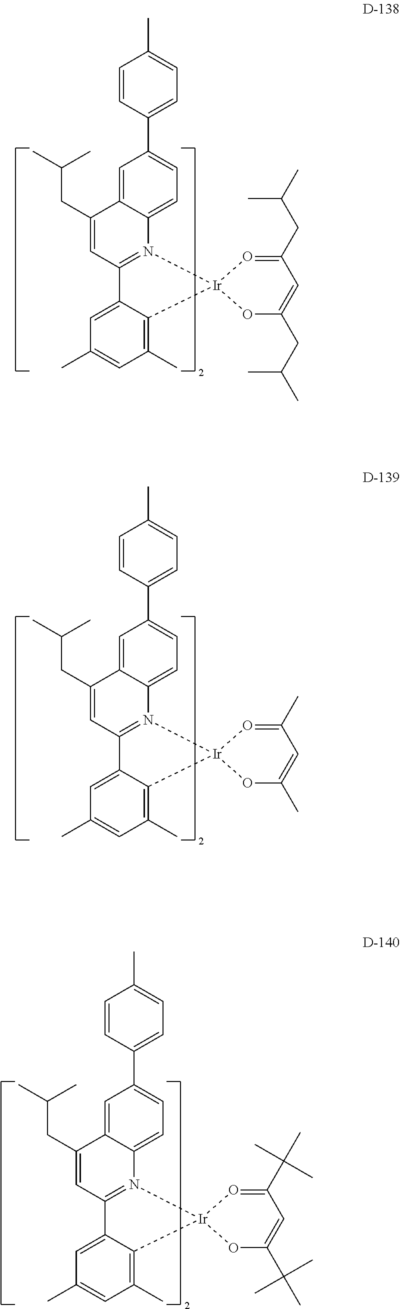

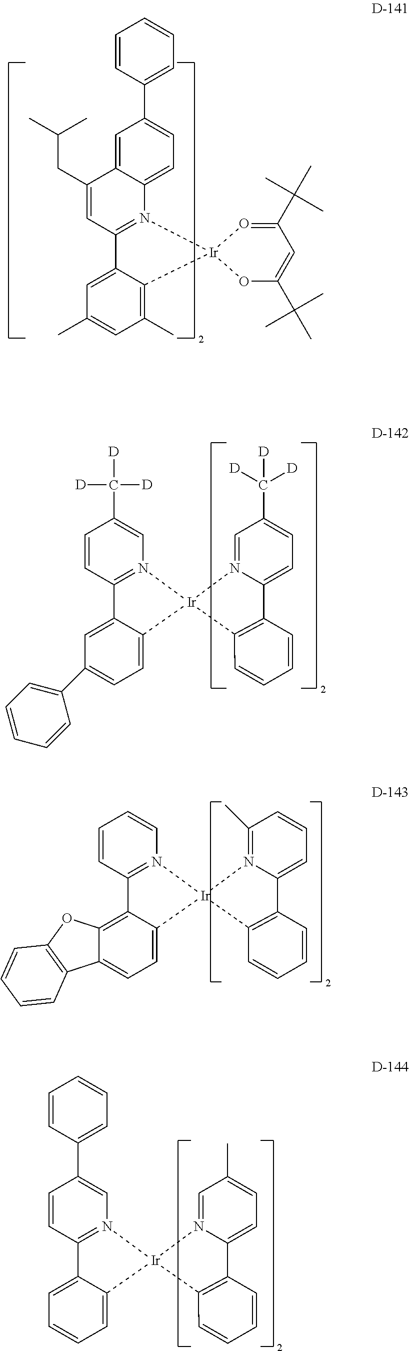

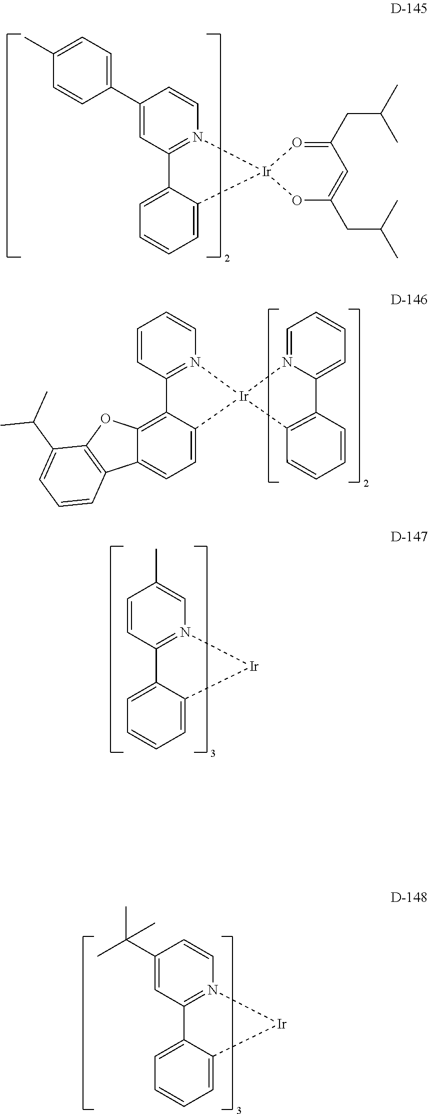

The organic electroluminescent device of the present disclosure comprises an organic electroluminescent compound of formula 1, and may further comprise at least one compound selected from the group consisting of arylamine-based compounds and styrylarylamine-based compounds.

In the organic electroluminescent device of the present disclosure, the organic layer may further comprise, in addition to the compound of formula 1, at least one metal selected from the group consisting of metals of Group 1, metals of Group 2, transition metals of the 4^{th} period, transition metals of the 5^{th} period, lanthanides and organic metals of the d-transition elements of the Periodic Table, or at least one complex compound comprising the metal. The organic layer may further comprise a light-emitting layer and a charge generating layer.

In addition, the organic electroluminescent device of the present disclosure may emit white light by further comprising at least one light-emitting layer, which comprises a blue electroluminescent compound, a red electroluminescent compound or a green electroluminescent compound known in the field, besides the compound of the present disclosure. If necessary, it may further comprise an orange light-emitting layer or a yellow light-emitting layer.

In the organic electroluminescent device of the present disclosure, preferably, at least one layer (hereinafter, “a surface layer”) may be placed on an inner surface(s) of one or both electrode(s), selected from a chalcogenide layer, a metal halide layer and a metal oxide layer. Specifically, a chalcogenide (includes oxides) layer of silicon or aluminum is preferably placed on an anode surface of an electroluminescent medium layer, and a metal halide layer or a metal oxide layer is preferably placed on a cathode surface of an electroluminescent medium layer. Such a surface layer provides operation stability for the organic electroluminescent device. Preferably, the chalcogenide includes SiOx (1≤X≤2), AlOx (1≤X≤1.5), SiON, SiAlON, etc.; the metal halide includes LiF, MgF₂, CaF₂, a rare earth metal fluoride, etc.; and the metal oxide includes Cs₂O, Li₂O, MgO, SrO, BaO, CaO, etc.

In the organic electroluminescent device of the present disclosure, a mixed region of an electron transport compound and a reductive dopant, or a mixed region of a hole transport compound and an oxidative dopant may be placed on at least one surface of a pair of electrodes. In this case, the electron transport compound is reduced to an anion, and thus it becomes easier to inject and transport electrons from the mixed region to an electroluminescent medium. Furthermore, the hole transport compound is oxidized to a cation, and thus it becomes easier to inject and transport holes from the mixed region to the electroluminescent medium. Preferably, the oxidative dopant includes various Lewis acids and acceptor compounds, and the reductive dopant includes alkali metals, alkali metal compounds, alkaline earth metals, rare-earth metals, and mixtures thereof. A reductive dopant layer may be employed as a charge generating layer to prepare an electroluminescent device having two or more light-emitting layers and emitting white light.

In order to form each layer of the organic electroluminescent device of the present disclosure, dry film-forming methods such as vacuum evaporation, sputtering, plasma and ion plating methods, or wet film-forming methods such as spin coating, dip coating, and flow coating methods can be used.

When using a wet film-forming method, a thin film can be formed by dissolving or diffusing materials forming each layer into any suitable solvent such as ethanol, chloroform, tetrahydrofuran, dioxane, etc. The solvent can be any solvent where the materials forming each layer can be dissolved or diffused, and where there are no problems in film-formation capability.

Hereinafter, the organic electroluminescent compound of the present disclosure, the preparation method of the compound, and the luminescent properties of the organic electroluminescent device comprising the compound will be explained in detail with reference to the following examples.

### EXAMPLE 1

### Preparation of Compound C-13

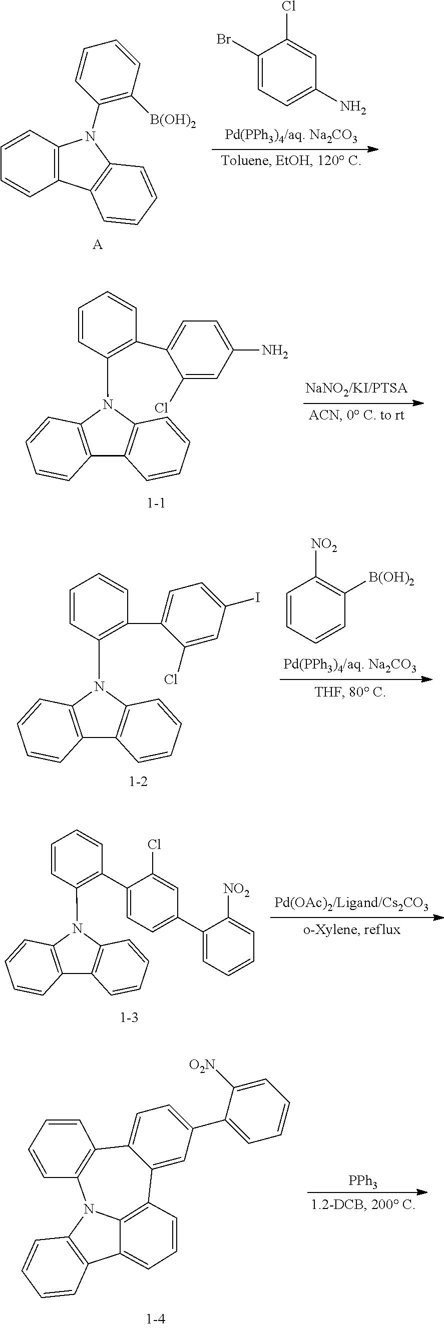

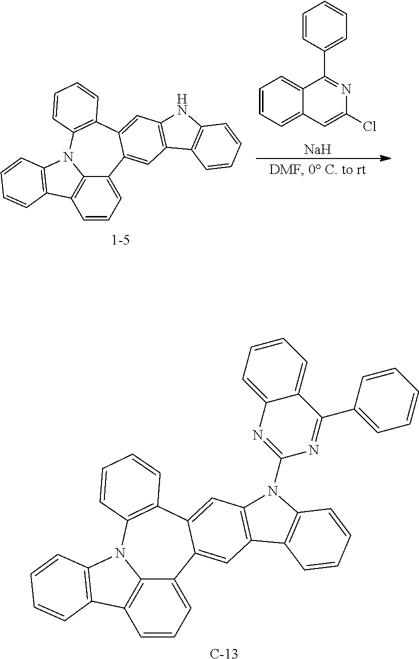

1) Preparation of Compound 1-1

After introducing compound A(22 g, 74.88 mmol), 4-bromo-3-chloroaniline(13 g, 62.40 mmol), tetrakis(triphenylphosphine)palladium(2.2 g, 1.87 mmol), sodium carbonate(17 g, 156.00 mmol), toluene(310 mL), EtOH(80 mL), and distilled water(80 mL) into a reaction vessel, the mixture was stirred at 120° C. for 6 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound 1-1 (14 g, yield: 61%).

2) Preparation of Compound 1-2

After introducing compound 1-1 (14 g, 37.95 mmol) to acetonitrile(380 mL) of a reaction vessel, para-toluenesulfonic acid monohydrate(22 g, 113.86 mmol) was added at 0° C. After 10 minutes, sodium nitrite(5 g, 75.90 mmol) and potassium iodide(16 g, 94.88 mmol) were dissolved in distilled water(280 mL), and this solution was then slowly added dropwise to the mixture. After completion of the dropwise addition, the mixture was warmed slowly to room temperature, and then additionally stirred for 4 hours. After completion of the reaction, sodium thiosulfate was added thereto to stop the reaction. The mixture was then extracted with ethyl acetate. The obtained organic layer was dried with magnesium sulfate, and the solvent was removed therefrom by a rotary evaporator. The products were purified by column chromatography to obtain compound 1-2 (9.6 g, yield: 53%).

3) Preparation of Compound 1-3

After introducing compound 1-2 (8.5 g, 17.72 mmol), 2-nitrophenyl boronic acid(4.4 g, 26.85 mmol), tetrakis(triphenylphosphine)palladium(0.6 g, 0.53 mmol), sodium carbonate(4.7 g, 44.30 mmol), tetrahydrofuran(90 mL) and distilled water(22 mL) into a reaction vessel, the mixture was stirred at 80° C. for 4 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound 1-3 (7.5 g, yield: 89%).

4) Preparation of Compound 1-4

After introducing compound 1-3 (7 g, 14.74 mmol), palladium(II) acetate(0.4 g, 1.47 mmol), tricyclohexylphosphonium tetrafluoroborate(1.1 g, 2.94 mmol), cesium carbonate(15 g, 44.22 mmol) and o-xylene(74 mL) into a reaction vessel, the mixture was stirred under reflux for 4 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound 1-4 (6.3 g, yield: 91%.

5) Preparation of Compound 1-5

After introducing compound 1-4 (6.3 g, 14.37 mmol), triphenylphosphine(11.3 g, 43.10 mmol) and 1,2-dichlorobenzene(72 mL) into a reaction vessel, the mixture was stirred at 200° C. for 8 hours. After completion of the reaction, the mixture was distilled under reduced pressure to remove the solvent. The mixture was then washed with distilled water and extracted with ethyl acetate. The obtained organic layer was dried with magnesium sulfate, and the solvent was removed therefrom by a rotary evaporator. The products were purified by column chromatography to obtain compound 1-5 (1.2 g, yield: 21%).

6) Preparation of Compound C-13

After dissolving compound 1-5 (1.2 g, 2.95 mmol) in dimethyl formaldehyde(15 mL) of a reaction vessel, sodium hydride (0.2 g, 4.43 mmol) was slowly added dropwise to the mixture at 0° C. After the mixture was stirred for 30 minutes, 2-chloro-4-phenylquinazoline(0.9 g, 3.54 mmol) was added dropwise thereto. After completion of the dropwise addition, the mixture was warmed to room temperature, and additionally stirred for 7 hours. After completion of the reaction, methanol was added thereto to stop the reaction. The mixture was then extracted with ethyl acetate. The obtained organic layer was dried with magnesium sulfate, and the solvent was removed therefrom by a rotary evaporator. The products were purified by column chromatography to obtain compound C-13 (0.8 g, yield: 44%).

| | MW | | | M.P |
|---|---|---|---|---|
| | (Molecular Weight) | UV | PL | (Melting Point) |
| C-13 | 610.70 | 404 nm | 507 nm | 260° C. |

### EXAMPLE 2

### Preparation of Compound C-6

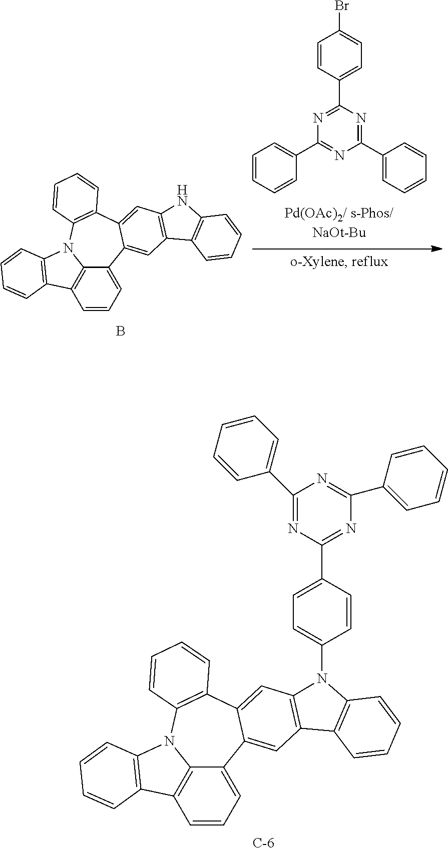

1) Preparation of Compound C-6

After introducing compound B (2.5 g, 6.15 mmol), 2-(4-bromophenyl)-4,6-diphenyl-1,3,5-triazine(2.9 g, 7.38 mmol), palladium(II) acetate (0.07 g, 0.31 mmol), 2-dicyclohexylphosphino-2′,6′-dimethoxybiphenyl(0.3 g, 0.62 mmol), sodium tert-butoxide(1.5 g, 15.38 mmol), and o-xylene(31 mL) into a reaction vessel, the mixture was stirred under reflux for 10 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound C-6 (0.8 g, yield: 18%).

| | MW | UV | PL | M.P |
|---|---|---|---|---|
| C-6 | 713.84 | 406 nm | 453 nm | 356° C. |

### EXAMPLE 3

### Preparation of Compound C-48

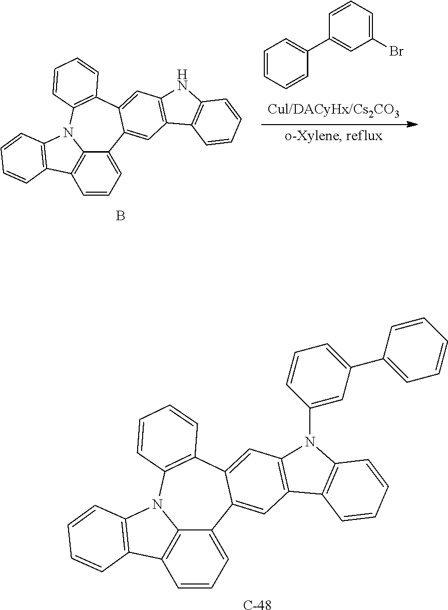

1) Preparation of Compound C-48

After introducing compound B (2 g, 4.90 mmol), 3-bromo-1-1′-biphenyl (1.7 g, 7.30 mmol), Cul (0.5 g, 15.04 mmol), diaminocyclohexane (1.2 mL, 9.80 mmol), cesium carbonate (3.2 g, 9.80 mmol) and o-xylene(25 mL) into a reaction vessel, the mixture was stirred under reflux for 7 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound C-48 (1.2 g, yield: 89%).

| | MW | UV | PL | M.P |
|---|---|---|---|---|
| C-48 | 558.67 | 386 nm | 457 nm | 221° C. |

### EXAMPLE 4

### Preparation of Compound C-49

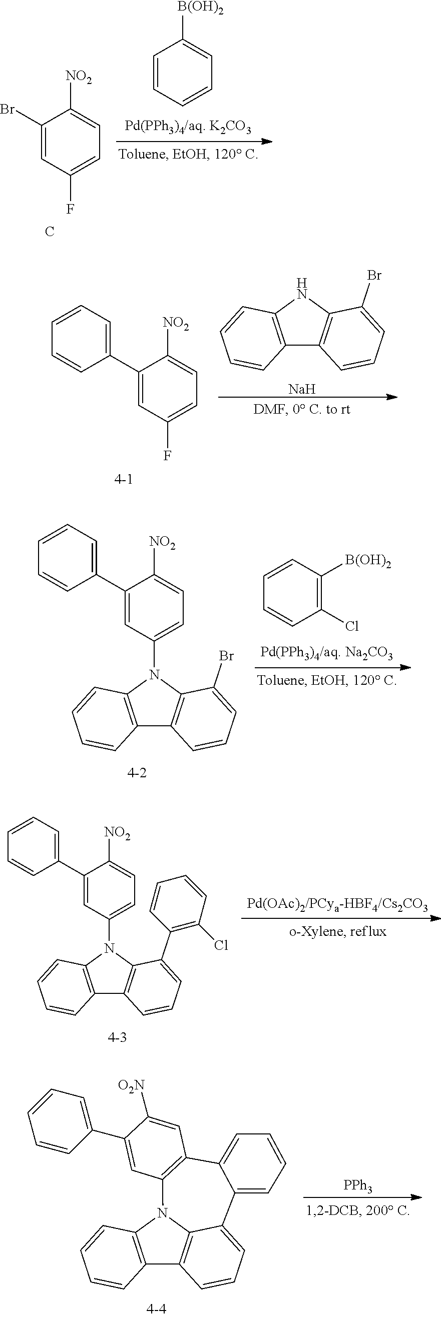

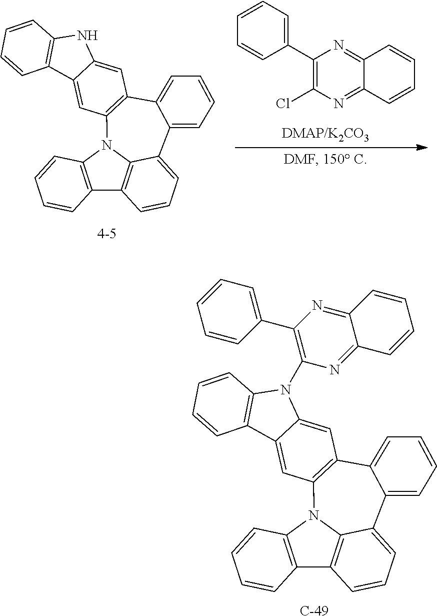

1) Preparation of Compound 4-1

After introducing compound C (30 g, 136.36 mmol), phenylboronic acid (20 g, 163.64 mmol), tetrakis(triphenylphosphine)palladium (4.7 g, 4.09 mmol), potassium carbonate (47.1 g, 340.90 mmol), toluene (680 mL), EtOH (170 mL) and distilled water (170 mL) into a reaction vessel, the mixture was stirred at 120° C. for 4 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound 4-1 (28 g, yield: 96%).

2) Preparation of Compound 4-2

After dissolving compound 4-1 (28 g, 128.91 mmol), 1-bromo-9H-carbazole (24 g, 97.52 mmol) in dimethyl formaldehyde (600 mL) of a reaction vessel, sodium hydride (6 g, 146.28 mmol, 60% in mineral oil) was added to the mixture at 0° C. The mixture was stirred at room temperature for 3 hours. After completion of the reaction, methanol and distilled water were added thereto. The obtained solid was filtered under reduced pressure, and subjected to column chromatography to obtain compound 4-2 (19 g, yield: 46%).

3) Preparation of Compound 4-3

After introducing compound 4-2 (19 g, 45.20 mmol), 2-chlorophenylboronic acid (8.5 g, 54.24 mmol), tetrakis(triphenylphosphine)palladium (1.6 g, 4.09 mmol), sodium carbonate (12 g, 113.00 mmol), toluene (230 mL), EtOH (56 mL), and distilled water (56 mL) into a reaction vessel, the mixture was stirred at 120° C. for 2 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound 4-3 (20 g, yield: 93%).

4) Preparation of Compound 4-4

After introducing compound 4-3 (20 g, 41.90 mmol), palladium(II) acetate (1 g, 4.19 mmol), tricyclohexylphosphonium tetrafluoroborate (3.1 g, 8.38 mmol), cesium carbonate (41 g, 125.70 mmol), and o-xylene (210 mL) into a reaction vessel, the mixture was stirred under reflux for 3 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound 4-4 (14 g, yield: 78%).

5) Preparation of Compound 4-5

After introducing compound 4-4 (14 g, 32.75 mol), triphenylphosphine (26 g, 98.25 mmol), and 1,2-dichlorobenzene (165 mL) into a reaction vessel, the mixture was stirred at 200° C. for 8 hours. After completion of the reaction, the mixture was distilled under reduced pressure to remove the solvent, and then the mixture was washed with distilled water and extracted with ethyl acetate. The obtained organic layer was dried with magnesium sulfate, and the solvent was removed therefrom by a rotary evaporator. The products were purified by column chromatography to obtain compound 4-5 (10 g, yield: 75%).

6) Preparation of Compound C-49

After introducing compound 4-5 (2 g, 4.90 mmol), 2-chloro-3-phenylquinoxaline (1.8 g, 7.30 mmol), 4-dimethylaminopyridine (0.3 g, 2.45 mmol), potassium carbonate (1.0 g, 7.30 mmol), and dimethylformamide (25 mL) into a reaction vessel, the mixture was stirred at 150° C. for 9 hours. After completion of the reaction, methanol was added thereto to stop the reaction. The mixture was then extracted with ethyl acetate. The obtained organic layer was dried with magnesium sulfate, and the solvent was removed therefrom by a rotary evaporator. The products were purified by column chromatography to obtain compound C-49 (0.9 g, yield: 30%).

| | MW | UV | PL | M.P |
|---|---|---|---|---|
| C-49 | 610.70 | 401 nm | 513 nm | 231° C. |

### EXAMPLE 5

### Preparation of Compound C-50

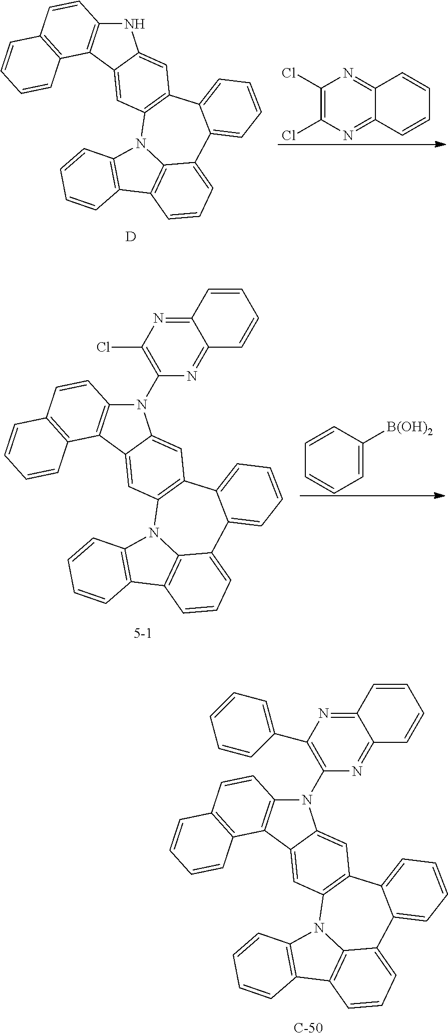

1) Preparation of Compound 5-1

After dissolving compound D (5.0 g, 10.95 mmol) in dimethyl formaldehyde (55 mL) of a reaction vessel, sodium hydride (0.7 g, 16.43 mmol) was slowly added dropwise to the mixture at 0° C. After the mixture was stirred for 30 minutes, 2,3-dichloroquinoxaline (3.3 g, 16.43 mmol) was added dropwise thereto. After completion of the dropwise addition, the mixture was warmed to room temperature, and additionally stirred for 4 hours. After completion of the reaction, methanol was added thereto to stop the reaction. The mixture was then extracted with ethyl acetate. The obtained organic layer was dried with magnesium sulfate, and the solvent was removed therefrom by a rotary evaporator. The products were purified by column chromatography to obtain compound 5-1 (5.1 g, yield: 75%).

2) Preparation of Compound C-50

After introducing compound 5-1 (5.1 g, 8.24 mmol), phenylboronic acid (1.2 g, 9.89 mmol), tetrakis(triphenylphosphine)palladium (0.3 g, 0.25 mmol), sodium carbonate (2.2 g, 20.60 mmol), toluene (42 mL), EtOH (10 mL), and distilled water (10 mL) into a reaction vessel, the mixture was stirred at 120° C. for 4 hours. After completion of the reaction, the mixture was washed with distilled water and extracted with ethyl acetate. The obtained organic layer was dried with magnesium sulfate, and the solvent was removed therefrom by a rotary evaporator. The products were purified by column chromatography to obtain compound C-50 (2.5 g, yield: 46%).

| | MW | UV | PL | M.P |
|---|---|---|---|---|
| C-50 | 660.78 | 406 nm | 519 nm | 280° C. |

### EXAMPLE 6

### Preparation of Compound C-51

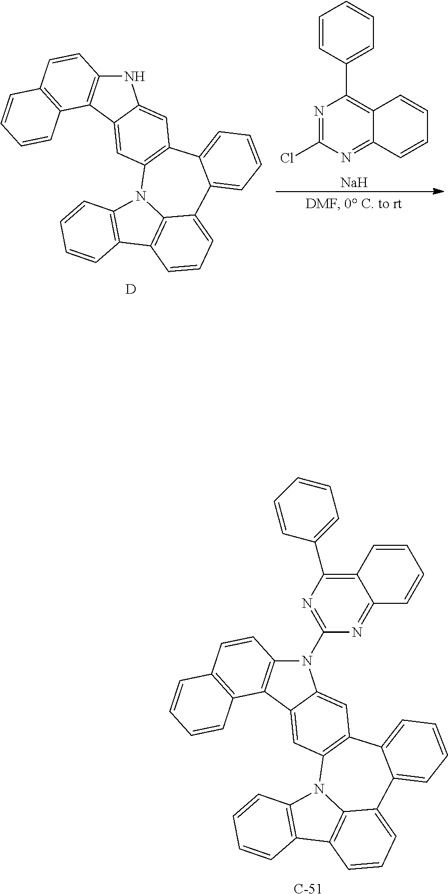

1) Preparation of Compound C-51

After dissolving compound D (3.0 g, 6.57 mmol) in dimethyl formaldehyde (33 mL) of a reaction vessel, sodium hydride (0.4 g, 9.86 mmol) was slowly added dropwise to the mixture at 0° C. After the mixture was stirred for 30 minutes, 2-chloro-4-phenylquinazoline (1.9 g, 7.89 mmol) was added dropwise thereto. After completion of the dropwise addition, the mixture was warmed to room temperature, and additionally stirred for 6 hours. After completion of the reaction, methanol was added thereto to stop the reaction. The mixture was then extracted with ethyl acetate. The obtained organic layer was dried with magnesium sulfate, and the solvent was removed therefrom by a rotary evaporator. The products were purified by column chromatography to obtain compound C-51 (1.4 g, yield: 33%).

| | MW | UV | PL | M.P |
|---|---|---|---|---|
| C-51 | 660.78 | 416 nm | 527 nm | 308° C. |

### DEVICE EXAMPLE 11

### OLED Produced by the Organic Electroluminescent Compound of the Present Disclosure

OLED was produced using the organic electroluminescent material of the present disclosure as follows. A transparent electrode indium tin oxide (ITO) thin film (10 Ω/sq) on a glass substrate for an organic electroluminescent device (OLED) (Geomatec) was subjected to an ultrasonic washing with acetone, ethanol, and distilled water sequentially, and was then stored in isopropanol. The ITO substrate was then mounted on a substrate holder of a vacuum vapor depositing apparatus. Compound HI-1 was introduced into a cell of the vacuum vapor depositing apparatus, and then the pressure in the chamber of the apparatus was controlled to 10⁻⁶ torr. Thereafter, an electric current was applied to the cell to evaporate compound HI-1, thereby forming a first hole injection layer having a thickness of 80 nm on the ITO substrate. Compound HI-2 was then introduced into another cell of the vacuum vapor depositing apparatus, and evaporated by applying electric current to the cell, thereby forming a second hole injection layer having a thickness of 5 nm on the first hole injection layer. Compound HT-1 was introduced into one cell of the vacuum vapor depositing apparatus, and evaporated by applying electric current to the cell, thereby forming a first hole transport layer having a thickness of 10 nm on the second hole injection layer. Compound HT-3 was then introduced into another cell of the vacuum vapor depositing apparatus, and evaporated by applying electric current to the cell, thereby forming a second hole transport layer having a thickness of 60 nm on the first hole transport layer. After forming the hole injection layer and the hole transport layer, a light-emitting layer was deposited thereon as follows. Compound C-13 was introduced, as a host material, into a cell of the vacuum vapor depositing apparatus, and compound D-71 was introduced into another cell. The two compounds were then evaporated at different rates, so that the dopant was deposited in a doping amount of 3 wt % based on the total amount of the host and dopant to form a light-emitting layer having a thickness of 40 nm on the hole transport layer. Compounds ET-1 and EI-1 were then introduced into another two cells of the vacuum vapor depositing apparatus, respectively, and evaporated at the same rate of 1:1, thereby forming an electron transport layer having a thickness of 30 nm on the light-emitting layer. After depositing compound EI-1 as an electron injection layer having a thickness of 2 nm on the electron transport layer, an AI cathode having a thickness of 80 nm was then deposited by another vacuum vapor deposition apparatus on the electron injection layer to produce OLED.

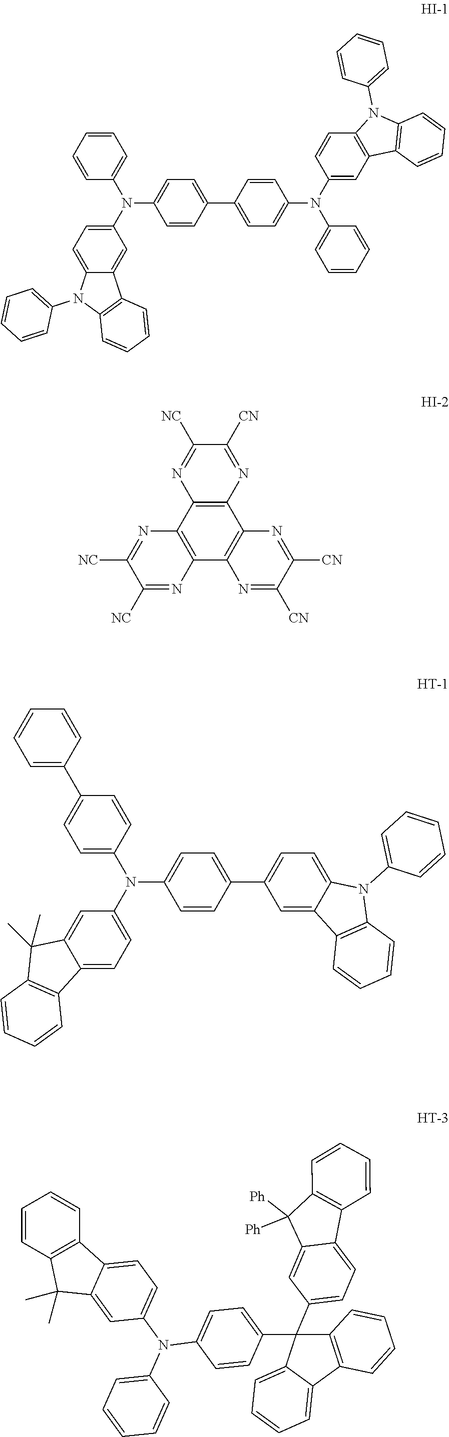 [SMILES: c1ccc(N(c2ccc(-c3ccc(N(c4ccccc4)c4ccc5c(c4)c4ccccc4n5-c4ccccc4)cc3)cc2)c2ccc3c(c2)c2ccccc2n3-c2ccccc2)cc1 ; N#Cc1nc2c3nc(C#N)c(C#N)nc3c3nc(C#N)c(C#N)nc3c2nc1C#N ; CC1(C)c2ccccc2-c2ccc(N(c3ccc(-c4ccccc4)cc3)c3ccc(-c4ccc5c(c4)c4ccccc4n5-c4ccccc4)cc3)cc21 ; CC1(C)c2ccccc2-c2ccc(N(c3ccccc3)c3ccc(C4(c5ccc6c(c5)C(c5ccccc5)(c5ccccc5)c5ccccc5-6)c5ccccc5-c5ccccc54)cc3)cc21]

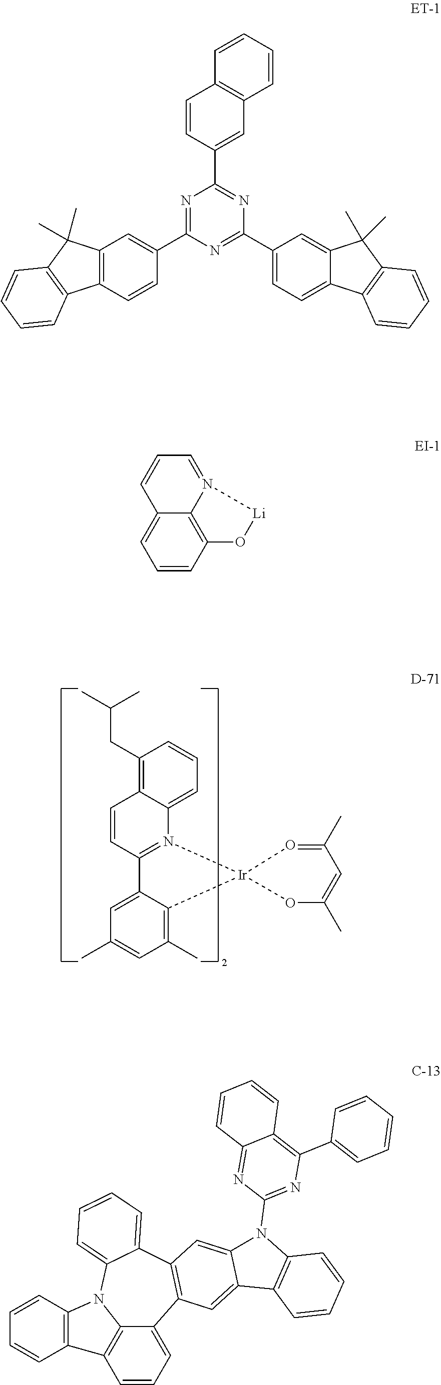

The produced OLED showed red emission having efficiency of 24.1 cd/A at 4.2V of voltage and a luminance of 1,000 cd/m².

### DEVICE EXAMPLES 2, 3, 4, 5

### OLED Produced by the Organic Electroluminescent Compound of the Present Disclosure

OLED was produced in the same manner as in Device Example 1, except that the compound shown in Table 1 below was used as a host for a light-emitting layer.

| Device Example | | Voltage | Efficiency |
|---|---|---|---|
| No. | Host | (V) | (cd/A) |
| 2 | C-6 | 3.3 | 27.6 |
| 3 | C-49 | 3.7 | 28.6 |
| 4 | C-50 | 4.1 | 28.1 |
| 5 | C-51 | 4.2 | 23.8 |

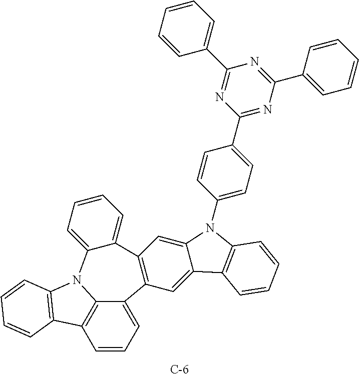

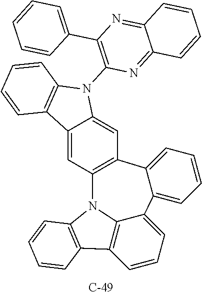

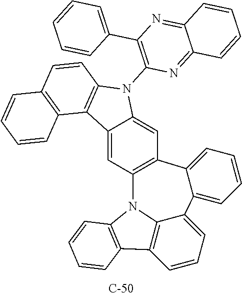

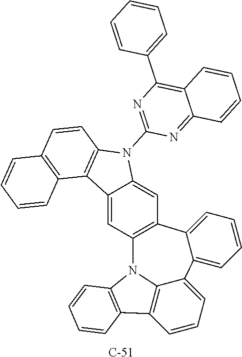

### COMPARATIVE DEVICE EXAMPLE

### OLED Produced by a Conventional Organic Electroluminescent Compound

OLED was produced in the same manner as in the Device Examples, except for using compound B as a host for a light-emitting layer.

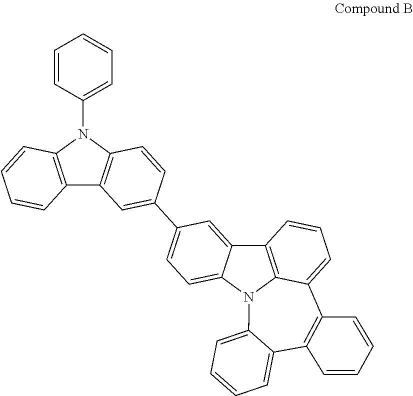 [SMILES: c1ccc(-n2c3ccccc3c3cc(-c4ccc5c(c4)c4cccc6c4n5-c4ccccc4-c4ccccc4-6)ccc32)cc1]

The produced OLED showed red emission having efficiency of 3.3 cd/A at 8.2V of voltage and a luminance of 1,000 cd/m².

As confirmed by the Device Examples and Comparative Device Example, the organic electroluminescent compound of the present disclosure has better luminous efficiency than conventional compounds and especially shows excellence in current and power efficiencies.

1. An organic electroluminescent compound represented by the following formula 1: 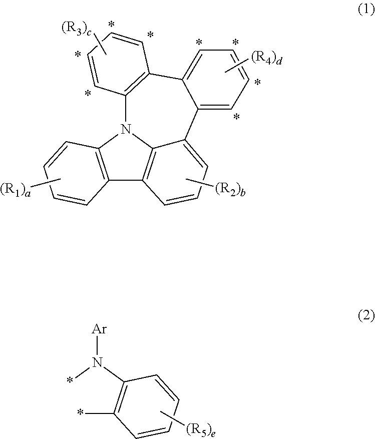
In formula 1,
each of two adjacent * of one phenyl ring of formula 1 is bonded to each of two * of formula 2, and
in formulae 1 and 2,
R₁ to R₅, each independently, represent hydrogen, deuterium, a halogen, a cyano, a carboxy, a nitro, a hydroxy, a substituted or unsubstituted (C1-C30)alkyl, a substituted or unsubstituted (C3-C30)cycloalkyl, a substituted or unsubstituted (C3-C30)cycloalkenyl, a substituted or unsubstituted (3 to 7-membered)heterocycloalkyl, a substituted or unsubstituted (C6-C30)aryl, a substituted or unsubstituted (3 to 30-membered)heteroaryl, —NR₆R₇ or —SiR₈R₉R₁₀, or may be linked to an adjacent substituent(s) to form a substituted or unsubstituted (C3-C30), mono- or polycyclic, alicyclic or aromatic ring, whose carbon atom(s) may be replaced with at least one hetero atom selected from nitrogen, oxygen, and sulfur; and
R₆ to R₁₀, each independently, represent hydrogen, deuterium, a halogen, a cyano, a carboxy, a nitro, a hydroxy, a substituted or unsubstituted (C1-C30)alkyl, a substituted or unsubstituted (C3-C30)cycloalkyl, a substituted or unsubstituted (C3-C30)cycloalkenyl, a substituted or unsubstituted (3 to 7-membered)heterocycloalkyl, a substituted or unsubstituted (C6-C30)aryl, or a substituted or unsubstituted (3 to 30-membered)heteroaryl;
Ar₁ represents a substituted or unsubstituted (C6-C30)aryl, or a substituted or unsubstituted (3 to 30-membered)heteroaryl;
a, c, d and e, each independently, represent an integer of 1 to 4; b represents an integer of 1 to 3; and
the heteroaryl contains at least one hetero atom selected from B, N, O, S, Si and P.

2. The organic electroluminescent compound according to claim 1, wherein the organic electroluminescent compound is represented by any of the following formulae 3 to 6: 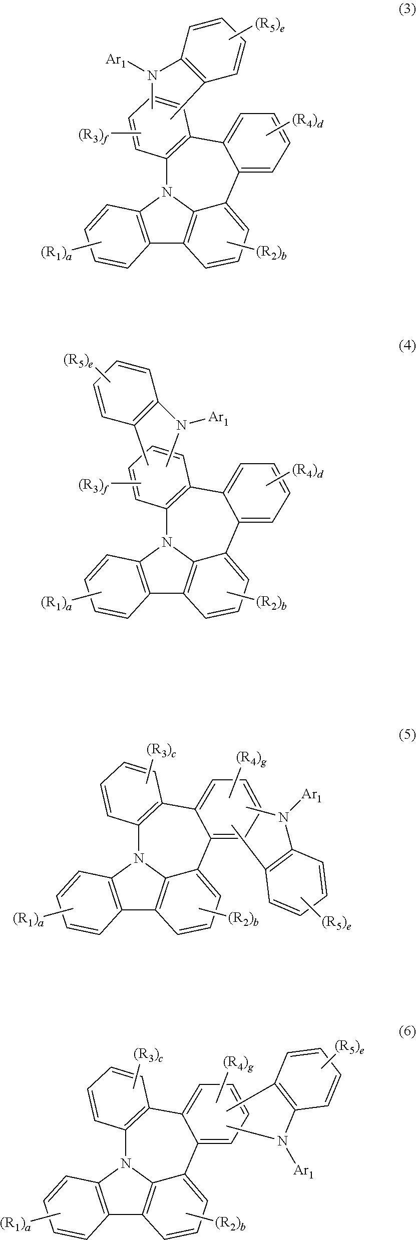
In formulae 3 to 6,
f and g, each independently, represent an integer of 1 or 2, and
R₁ to R₅, Ar₁, a, b, c, d and e are as defined in claim 1.

3. The organic electroluminescent compound according to claim 1, wherein in R₁ to R₁₀ and Ar₁, the substituent of the substituted (C1-C30)alkyl, the substituted (C3-C30)cycloalkyl, the substituted (C3-C30)cycloalkenyl, the substituted (3 to 7-membered)heterocycloalkyl, the substituted (C6-C30)aryl, the substituted (3 to 30-membered)heteroaryl, and the substituted (C3-C30) mono- or polycyclic alicyclic or aromatic ring, each independently, is selected from the group consisting of deuterium, a halogen, a cyano, a carboxy, a nitro, a hydroxy, a (C1-C30)alkyl, a halo(C1-C30)alkyl, a (C2-C30)alkenyl, a (C2-C30) alkynyl, a (C1-C30)alkoxy, a (C1-C30)alkylthio, a (C3-C30)cycloalkyl, a (C3-C30)cycloalkenyl, a (3 to 7-membered)heterocycloalkyl, a (C6-C30)aryloxy, a (C6-C30)arylthio, a (5 to 30-membered)heteroaryl substituted or unsubstituted with a (C6-C30)aryl, a (C6-C30)aryl substituted or unsubstituted with a (5 to 30-membered)heteroaryl, a tri(C1-C30)alkylsilyl, a tri(C6-C30)arylsilyl, a di(C1-C30)alkyl(C6-C30)arylsilyl, a (C1-C30)alkyldi(C6-C30)arylsilyl, an amino, a mono- or di-(C1-C30)alkylamino, a mono- or di-(C6-C30)arylamino, a (C1-C30)alkyl(C6-C30)arylamino, a (C1-C30)alkylcarbonyl, a (C1-C30)alkoxycarbonyl, a (C6-C30)arylcarbonyl, a di(C6-C30)arylboronyl, a di(C1-C30)alkylboronyl, a (C1-C30)alkyl(C6-C30)arylboronyl, a (C6-C30)aryl(C1-C30)alkyl, and a (C1-C30)alkyl(C6-C30)aryl.

4. The organic electroluminescent compound according to claim 1, wherein Ar₁ is selected from a substituted or unsubstituted phenyl, a substituted or unsubstituted naphthyl, a substituted or unsubstituted biphenyl, a substituted or unsubstituted anthracenyl, a substituted or unsubstituted terphenyl, a substituted or unsubstituted phenylnaphthyl, a substituted or unsubstituted naphthylphenyl, a substituted or unsubstituted fluorenyl, a substituted or unsubstituted spiro bifluorenyl, a substituted or unsubstituted pyridyl, a substituted or unsubstituted pyrimidinyl, a substituted or unsubstituted triazinyl, a substituted or unsubstituted quinolyl, a substituted or unsubstituted isoquinolyl, a substituted or unsubstituted quinoxalinyl, a substituted or unsubstituted quinazolinyl, a substituted or unsubstituted dibenzofuranyl, or a substituted or unsubstituted dibenzothiophenyl.

5. The organic electroluminescent compound according to claim 1, wherein the compound represented by formula 1 is selected from the group consisting of:

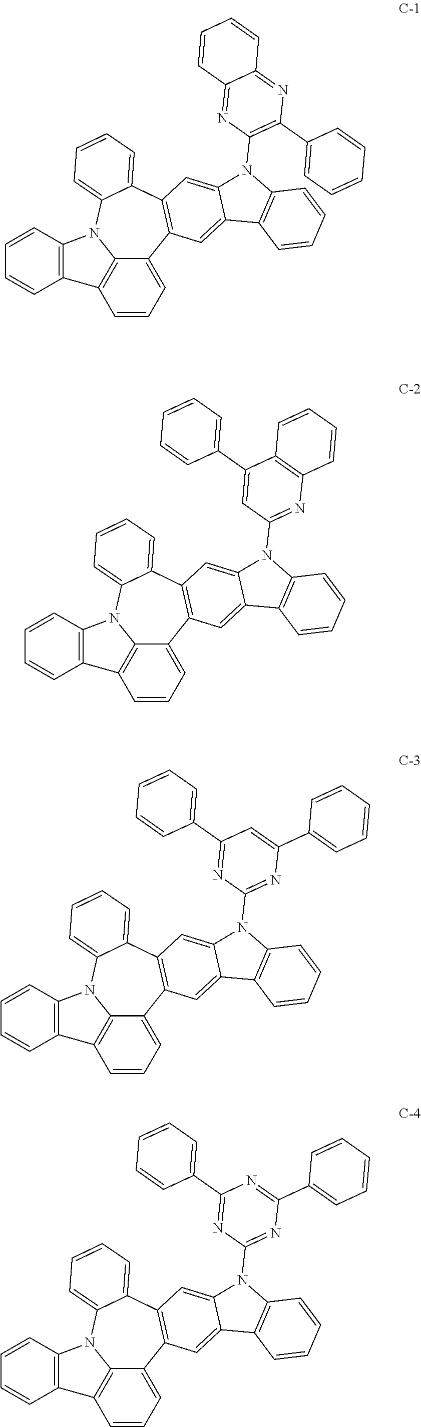 [SMILES: c1ccc(-c2nc3ccccc3nc2-n2c3ccccc3c3cc4c(cc32)-c2ccccc2-n2c3ccccc3c3cccc-4c32)cc1 ; c1ccc(-c2cc(-n3c4ccccc4c4cc5c(cc43)-c3ccccc3-n3c4ccccc4c4cccc-5c43)nc3ccccc23)cc1 ; c1ccc(-c2cc(-c3ccccc3)nc(-n3c4ccccc4c4cc5c(cc43)-c3ccccc3-n3c4ccccc4c4cccc-5c43)n2)cc1 ; c1ccc(-c2nc(-c3ccccc3)nc(-n3c4ccccc4c4cc5c(cc43)-c3ccccc3-n3c4ccccc4c4cccc-5c43)n2)cc1]

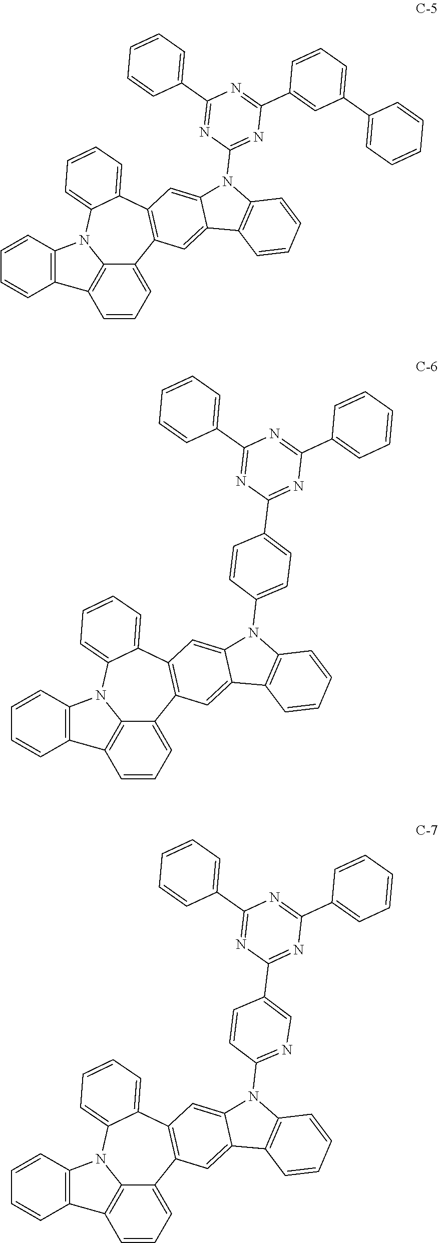 [SMILES: c1ccc(-c2cccc(-c3nc(-c4ccccc4)nc(-n4c5ccccc5c5cc6c(cc54)-c4ccccc4-n4c5ccccc5c5cccc-6c54)n3)c2)cc1 ; c1ccc(-c2nc(-c3ccccc3)nc(-c3ccc(-n4c5ccccc5c5cc6c(cc54)-c4ccccc4-n4c5ccccc5c5cccc-6c54)cc3)n2)cc1 ; c1ccc(-c2nc(-c3ccccc3)nc(-c3ccc(-n4c5ccccc5c5cc6c(cc54)-c4ccccc4-n4c5ccccc5c5cccc-6c54)nc3)n2)cc1]

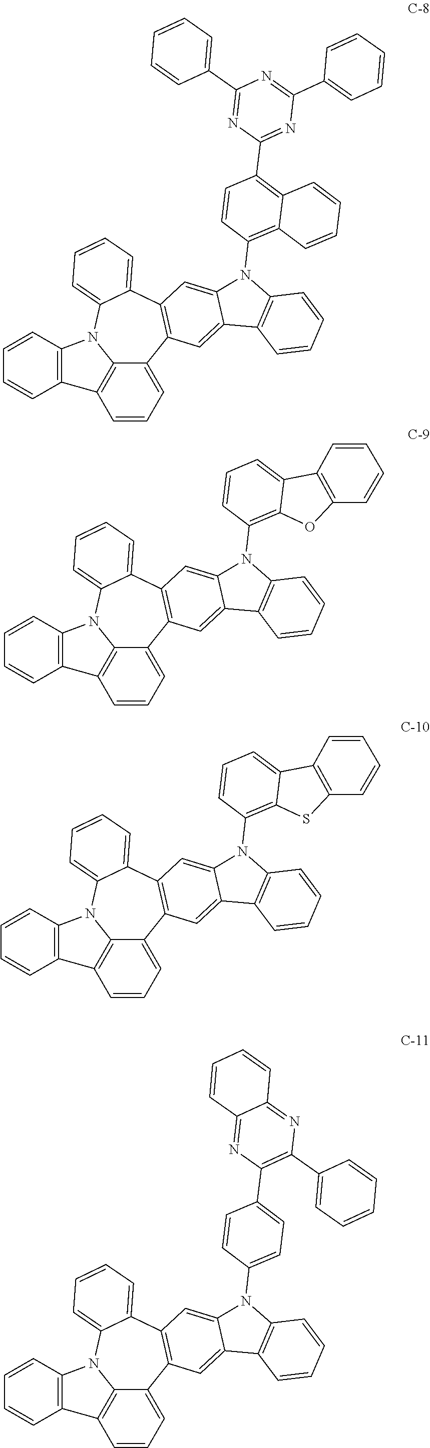 [SMILES: c1ccc(-c2nc(-c3ccccc3)nc(-c3ccc(-n4c5ccccc5c5cc6c(cc54)-c4ccccc4-n4c5ccccc5c5cccc-6c54)c4ccccc34)n2)cc1 ; c1ccc2c(c1)-c1cc3c(cc1-c1cccc4c5ccccc5n-2c14)c1ccccc1n3-c1cccc2c1oc1ccccc12 ; c1ccc2c(c1)-c1cc3c(cc1-c1cccc4c5ccccc5n-2c14)c1ccccc1n3-c1cccc2c1sc1ccccc12 ; c1ccc(-c2nc3ccccc3nc2-c2ccc(-n3c4ccccc4c4cc5c(cc43)-c3ccccc3-n3c4ccccc4c4cccc-5c43)cc2)cc1]

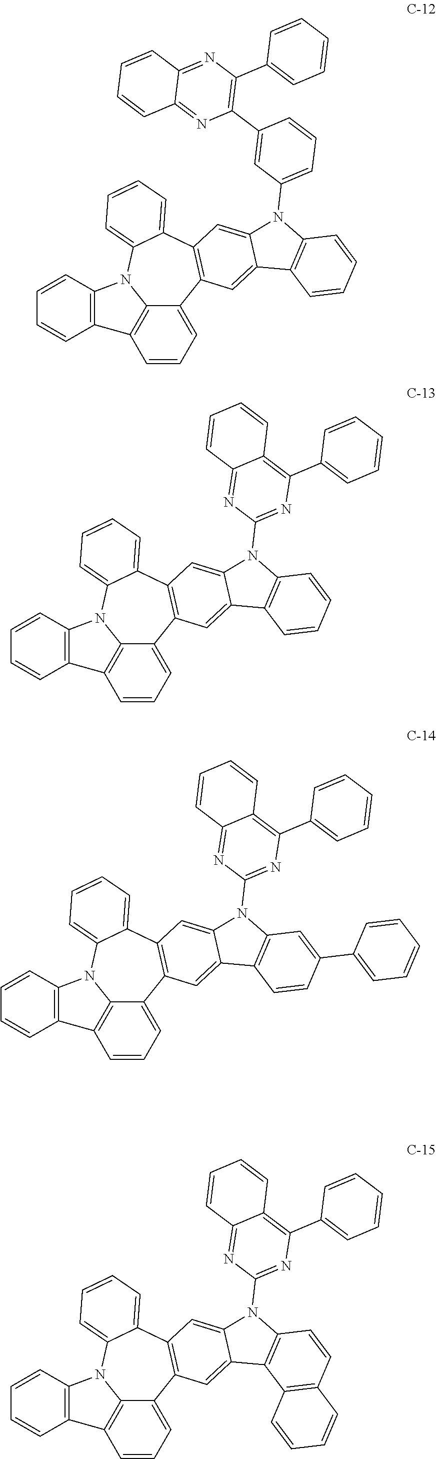 [SMILES: c1ccc(-c2nc3ccccc3nc2-c2cccc(-n3c4ccccc4c4cc5c(cc43)-c3ccccc3-n3c4ccccc4c4cccc-5c43)c2)cc1 ; c1ccc(-c2nc(-n3c4ccccc4c4cc5c(cc43)-c3ccccc3-n3c4ccccc4c4cccc-5c43)nc3ccccc23)cc1 ; c1ccc(-c2ccc3c4cc5c(cc4n(-c4nc(-c6ccccc6)c6ccccc6n4)c3c2)-c2ccccc2-n2c3ccccc3c3cccc-5c32)cc1 ; c1ccc(-c2nc(-n3c4cc5c(cc4c4c6ccccc6ccc43)-c3cccc4c6ccccc6n(c34)-c3ccccc3-5)nc3ccccc23)cc1]

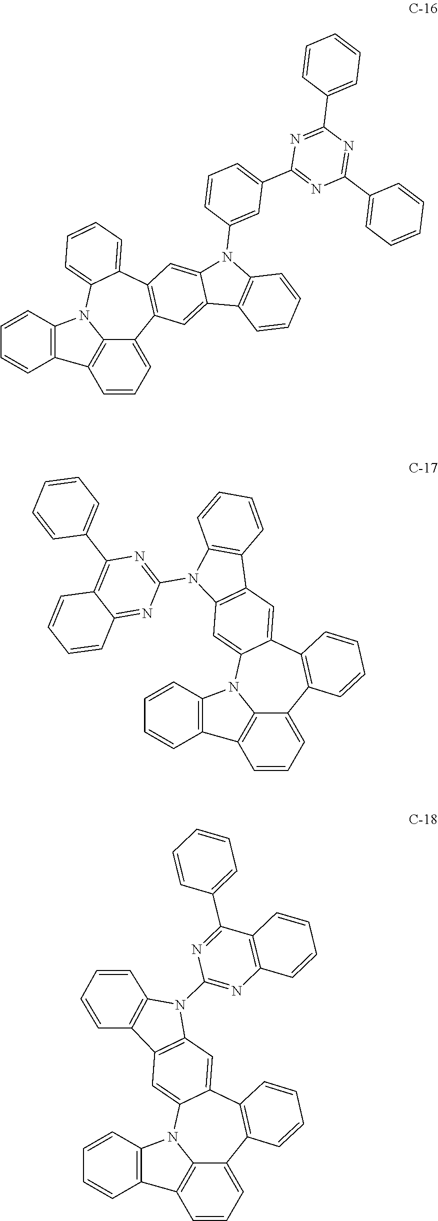 [SMILES: c1ccc(-c2nc(-c3ccccc3)nc(-c3cccc(-n4c5ccccc5c5cc6c(cc54)-c4ccccc4-n4c5ccccc5c5cccc-6c54)c3)n2)cc1 ; c1ccc(-c2nc(-n3c4ccccc4c4cc5c(cc43)-n3c4ccccc4c4cccc(c43)-c3ccccc3-5)nc3ccccc23)cc1 ; c1ccc(-c2nc(-n3c4ccccc4c4cc5c(cc43)-c3ccccc3-c3cccc4c6ccccc6n-5c34)nc3ccccc23)cc1]

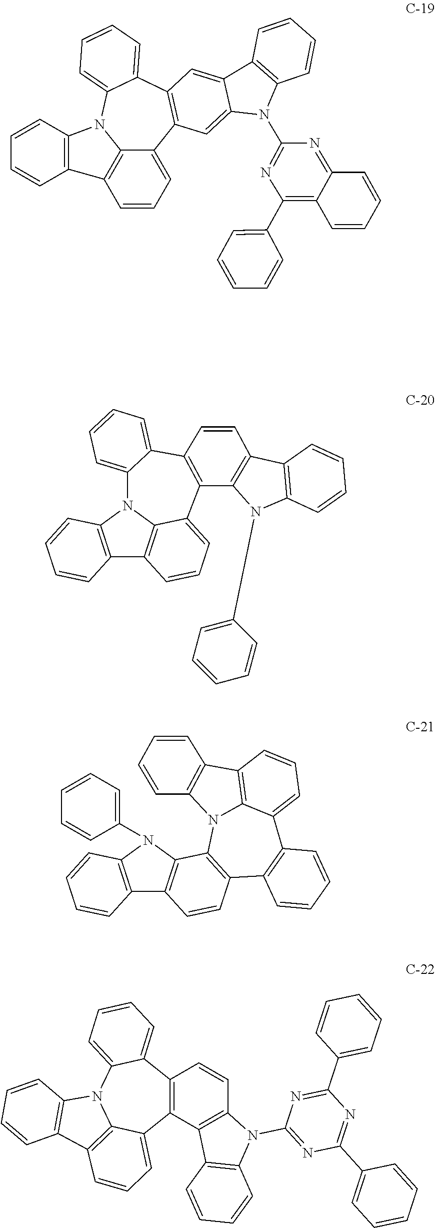 [SMILES: c1ccc(-c2nc(-n3c4ccccc4c4cc5c(cc43)-c3cccc4c6ccccc6n(c34)-c3ccccc3-5)nc3ccccc23)cc1 ; c1ccc(-n2c3ccccc3c3ccc4c(c32)-c2cccc3c5ccccc5n(c23)-c2ccccc2-4)cc1 ; c1ccc(-n2c3ccccc3c3ccc4c(c32)-n2c3ccccc3c3cccc(c32)-c2ccccc2-4)cc1 ; c1ccc(-c2nc(-c3ccccc3)nc(-n3c4ccccc4c4c5c(ccc43)-c3ccccc3-n3c4ccccc4c4cccc-5c43)n2)cc1]

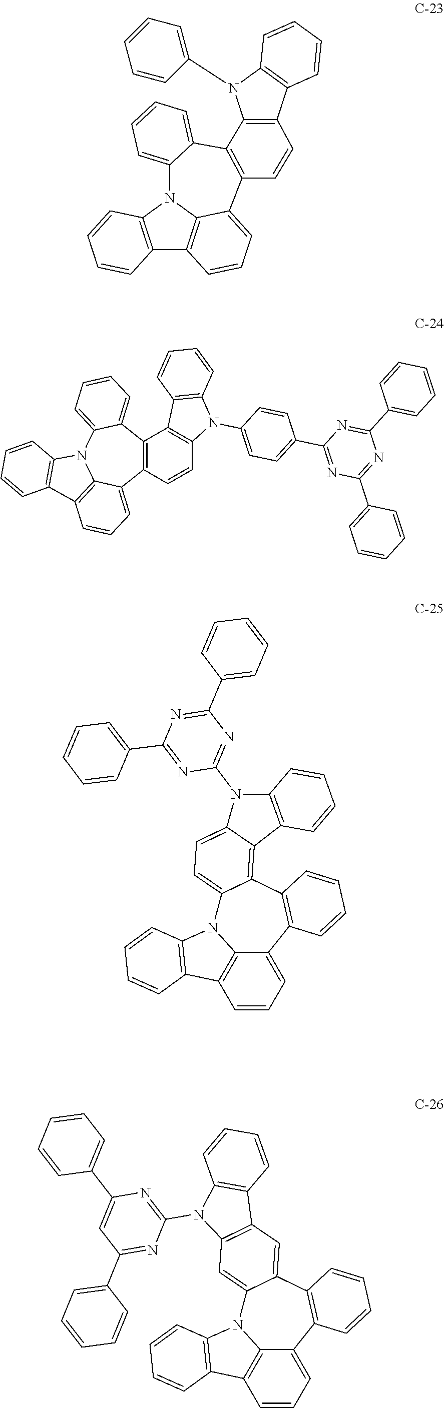 [SMILES: c1ccc(-n2c3ccccc3c3ccc4c(c32)-c2ccccc2-n2c3ccccc3c3cccc-4c32)cc1 ; c1ccc(-c2nc(-c3ccccc3)nc(-c3ccc(-n4c5ccccc5c5c6c(ccc54)-c4cccc5c7ccccc7n(c45)-c4ccccc4-6)cc3)n2)cc1 ; c1ccc(-c2nc(-c3ccccc3)nc(-n3c4ccccc4c4c5c(ccc43)-n3c4ccccc4c4cccc(c43)-c3ccccc3-5)n2)cc1 ; c1ccc(-c2cc(-c3ccccc3)nc(-n3c4ccccc4c4cc5c(cc43)-n3c4ccccc4c4cccc(c43)-c3ccccc3-5)n2)cc1]

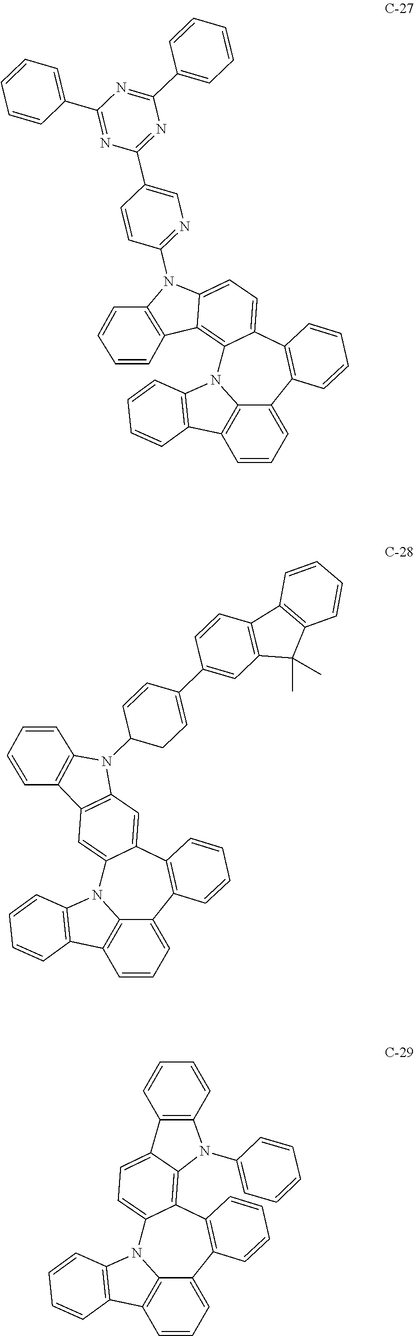 [SMILES: c1ccc(-c2nc(-c3ccccc3)nc(-c3ccc(-n4c5ccccc5c5c6c(ccc54)-c4ccccc4-c4cccc5c7ccccc7n-6c45)nc3)n2)cc1 ; CC1(C)c2ccccc2-c2ccc(C3=CCC(n4c5ccccc5c5cc6c(cc54)-c4ccccc4-c4cccc5c7ccccc7n-6c45)C=C3)cc21 ; c1ccc(-n2c3ccccc3c3ccc4c(c32)-c2ccccc2-c2cccc3c5ccccc5n-4c23)cc1]

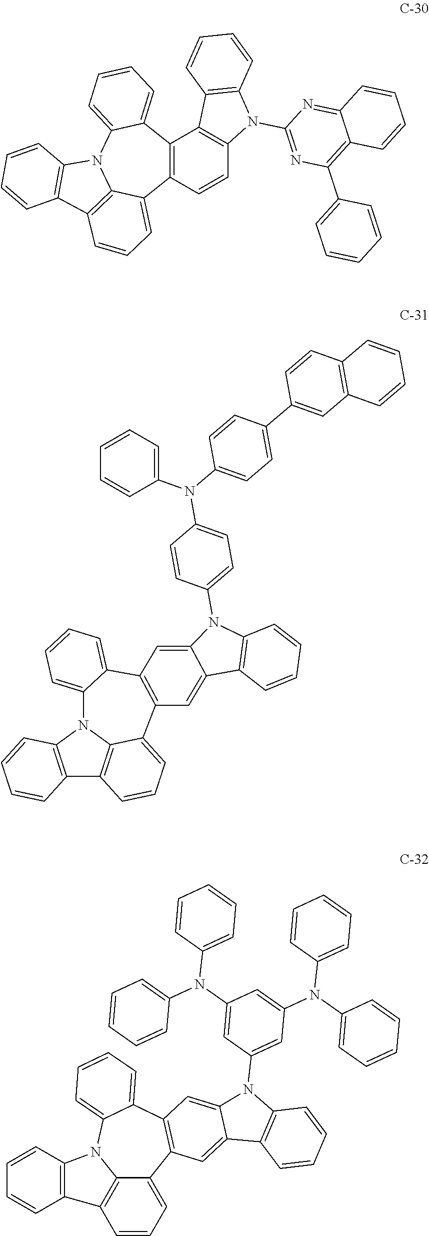 [SMILES: c1ccc(-c2nc(-n3c4ccccc4c4c5c(ccc43)-c3cccc4c6ccccc6n(c34)-c3ccccc3-5)nc3ccccc23)cc1 ; c1ccc(N(c2ccc(-c3ccc4ccccc4c3)cc2)c2ccc(-n3c4ccccc4c4cc5c(cc43)-c3ccccc3-n3c4ccccc4c4cccc-5c43)cc2)cc1 ; c1ccc(N(c2ccccc2)c2cc(N(c3ccccc3)c3ccccc3)cc(-n3c4ccccc4c4cc5c(cc43)-c3ccccc3-n3c4ccccc4c4cccc-5c43)c2)cc1]

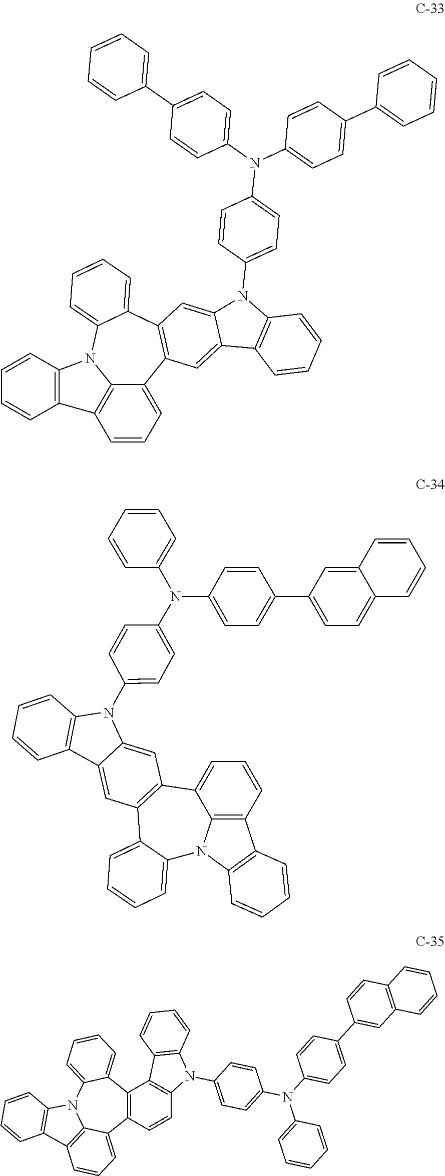 [SMILES: c1ccc(-c2ccc(N(c3ccc(-c4ccccc4)cc3)c3ccc(-n4c5ccccc5c5cc6c(cc54)-c4ccccc4-n4c5ccccc5c5cccc-6c54)cc3)cc2)cc1 ; c1ccc(N(c2ccc(-c3ccc4ccccc4c3)cc2)c2ccc(-n3c4ccccc4c4cc5c(cc43)-c3cccc4c6ccccc6n(c34)-c3ccccc3-5)cc2)cc1 ; c1ccc(N(c2ccc(-c3ccc4ccccc4c3)cc2)c2ccc(-n3c4ccccc4c4c5c(ccc43)-c3cccc4c6ccccc6n(c34)-c3ccccc3-5)cc2)cc1]

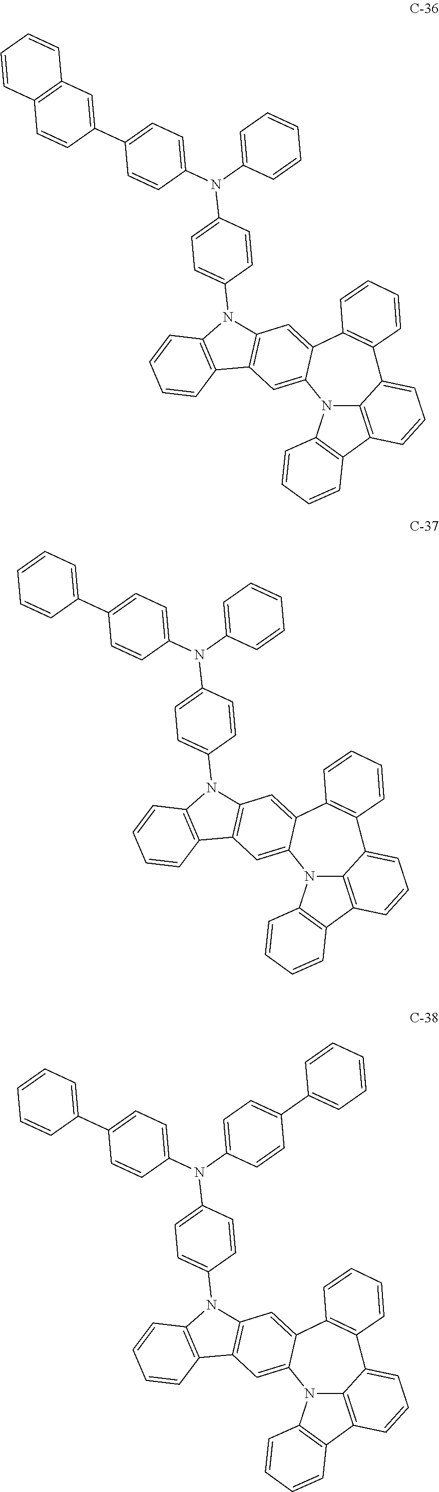 [SMILES: c1ccc(N(c2ccc(-c3ccc4ccccc4c3)cc2)c2ccc(-n3c4ccccc4c4cc5c(cc43)-c3ccccc3-c3cccc4c6ccccc6n-5c34)cc2)cc1 ; c1ccc(-c2ccc(N(c3ccccc3)c3ccc(-n4c5ccccc5c5cc6c(cc54)-c4ccccc4-c4cccc5c7ccccc7n-6c45)cc3)cc2)cc1 ; c1ccc(-c2ccc(N(c3ccc(-c4ccccc4)cc3)c3ccc(-n4c5ccccc5c5cc6c(cc54)-c4ccccc4-c4cccc5c7ccccc7n-6c45)cc3)cc2)cc1]

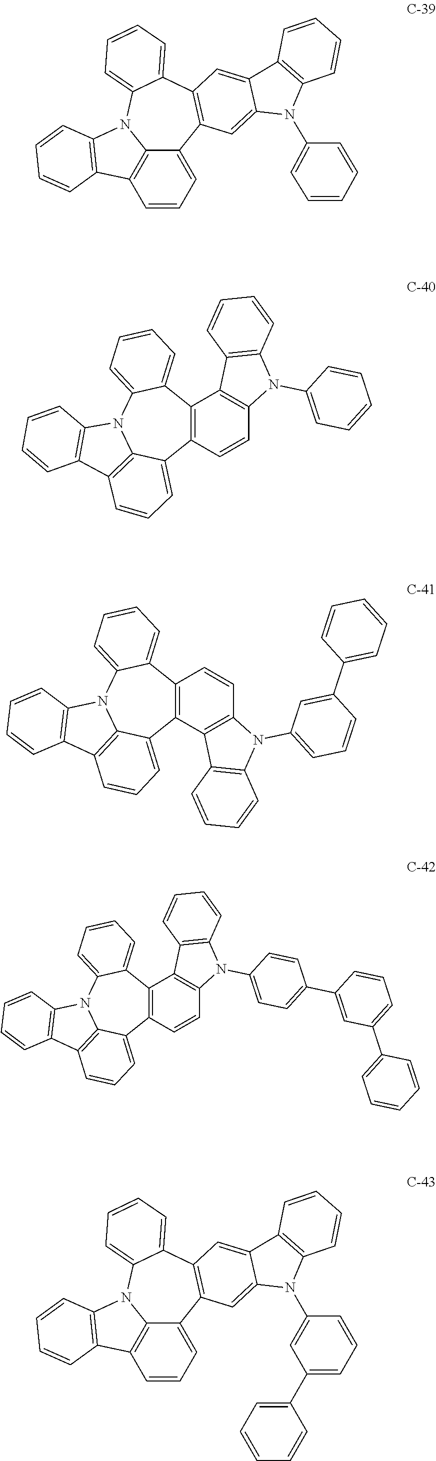 [SMILES: c1ccc(-n2c3ccccc3c3cc4c(cc32)-c2cccc3c5ccccc5n(c23)-c2ccccc2-4)cc1 ; c1ccc(-n2c3ccccc3c3c4c(ccc32)-c2cccc3c5ccccc5n(c23)-c2ccccc2-4)cc1 ; c1ccc(-c2cccc(-n3c4ccccc4c4c5c(ccc43)-c3ccccc3-n3c4ccccc4c4cccc-5c43)c2)cc1 ; c1ccc(-c2cccc(-c3ccc(-n4c5ccccc5c5c6c(ccc54)-c4cccc5c7ccccc7n(c45)-c4ccccc4-6)cc3)c2)cc1 ; c1ccc(-c2cccc(-n3c4ccccc4c4cc5c(cc43)-c3cccc4c6ccccc6n(c34)-c3ccccc3-5)c2)cc1]

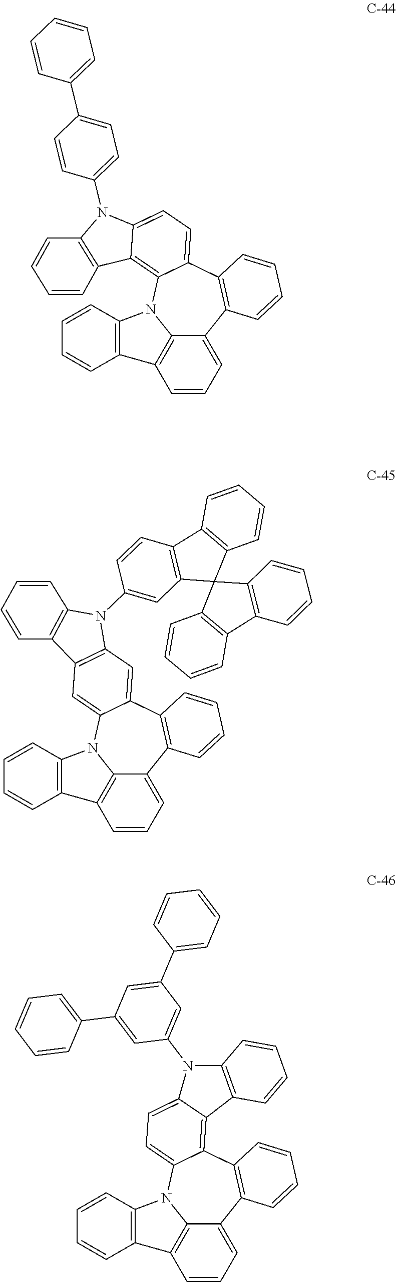 [SMILES: c1ccc(-c2ccc(-n3c4ccccc4c4c5c(ccc43)-c3ccccc3-c3cccc4c6ccccc6n-5c34)cc2)cc1 ; c1ccc2c(c1)-c1cc3c(cc1-n1c4ccccc4c4cccc-2c41)c1ccccc1n3-c1ccc2c(c1)C1(c3ccccc3-c3ccccc31)c1ccccc1-2 ; c1ccc(-c2cc(-c3ccccc3)cc(-n3c4ccccc4c4c5c(ccc43)-n3c4ccccc4c4cccc(c43)-c3ccccc3-5)c2)cc1]

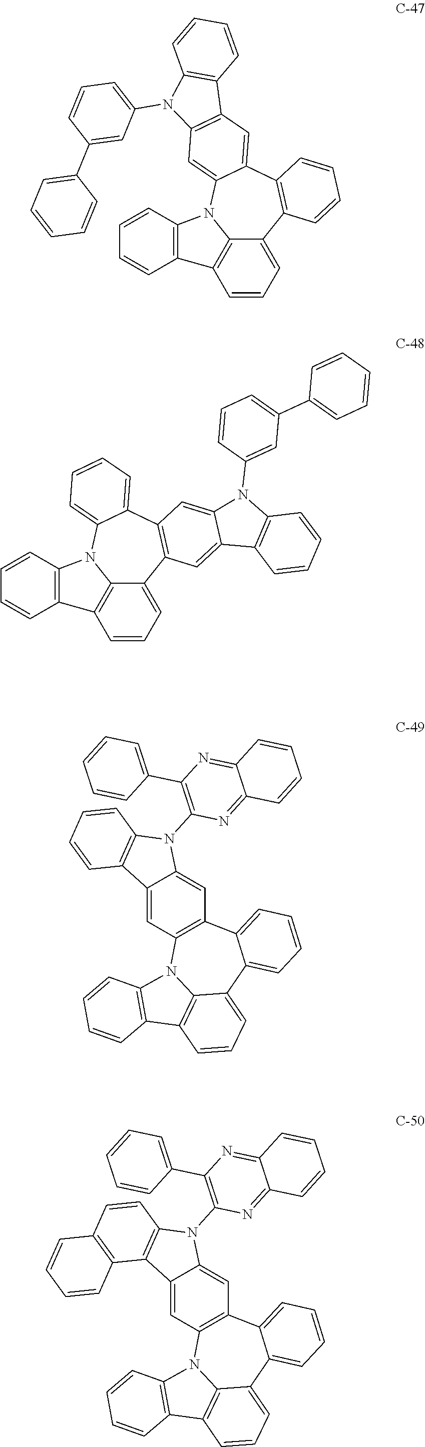 [SMILES: c1ccc(-c2cccc(-n3c4ccccc4c4cc5c(cc43)-n3c4ccccc4c4cccc(c43)-c3ccccc3-5)c2)cc1 ; c1ccc(-c2cccc(-n3c4ccccc4c4cc5c(cc43)-c3ccccc3-n3c4ccccc4c4cccc-5c43)c2)cc1 ; c1ccc(-c2nc3ccccc3nc2-n2c3ccccc3c3cc4c(cc32)-c2ccccc2-c2cccc3c5ccccc5n-4c23)cc1 ; c1ccc(-c2nc3ccccc3nc2-n2c3cc4c(cc3c3c5ccccc5ccc32)-n2c3ccccc3c3cccc(c32)-c2ccccc2-4)cc1]

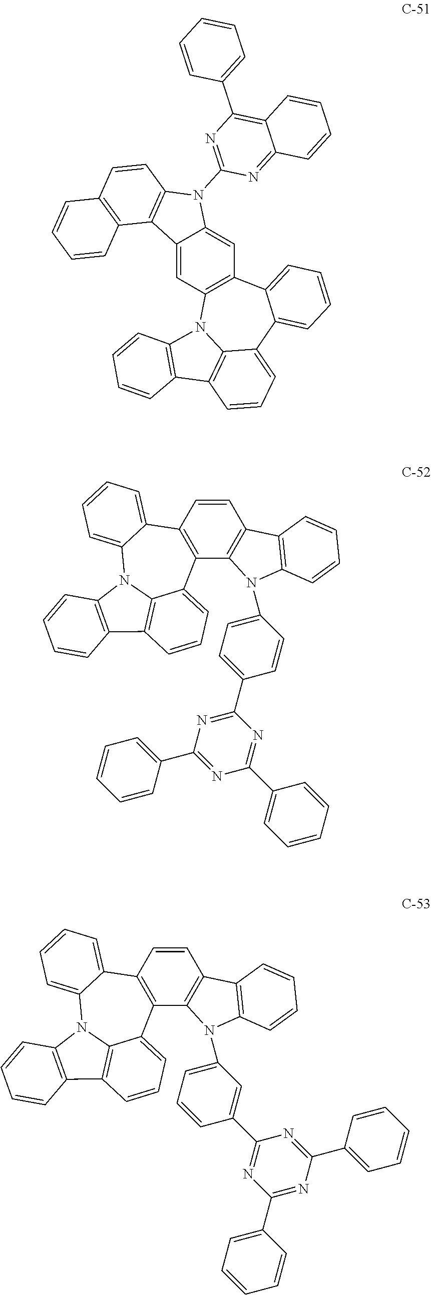 [SMILES: c1ccc(-c2nc(-n3c4cc5c(cc4c4c6ccccc6ccc43)-n3c4ccccc4c4cccc(c43)-c3ccccc3-5)nc3ccccc23)cc1 ; c1ccc(-c2nc(-c3ccccc3)nc(-c3ccc(-n4c5ccccc5c5ccc6c(c54)-c4cccc5c7ccccc7n(c45)-c4ccccc4-6)cc3)n2)cc1 ; c1ccc(-c2nc(-c3ccccc3)nc(-c3cccc(-n4c5ccccc5c5ccc6c(c54)-c4cccc5c7ccccc7n(c45)-c4ccccc4-6)c3)n2)cc1]

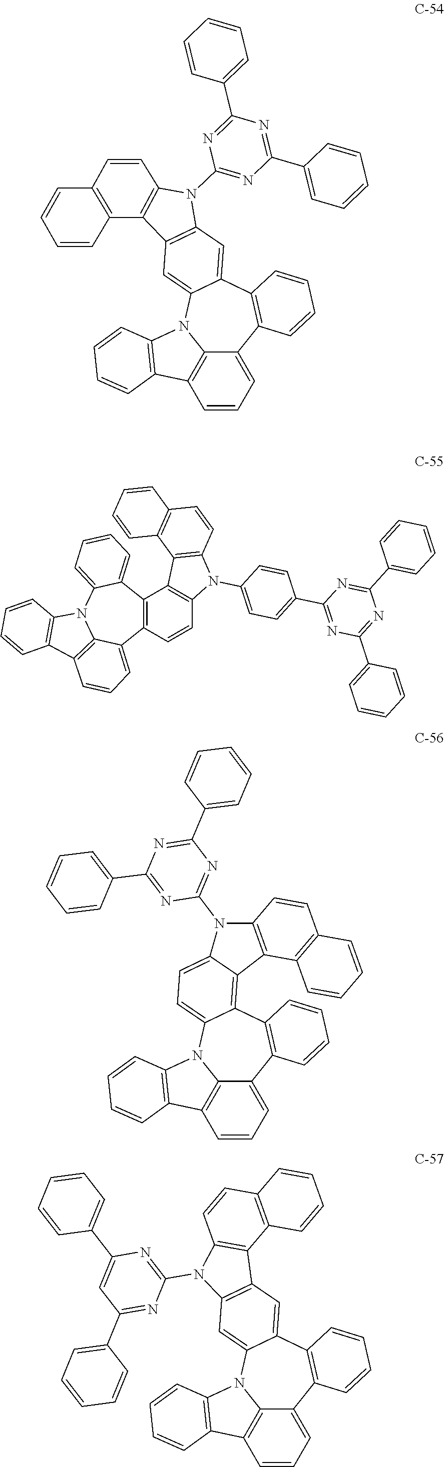

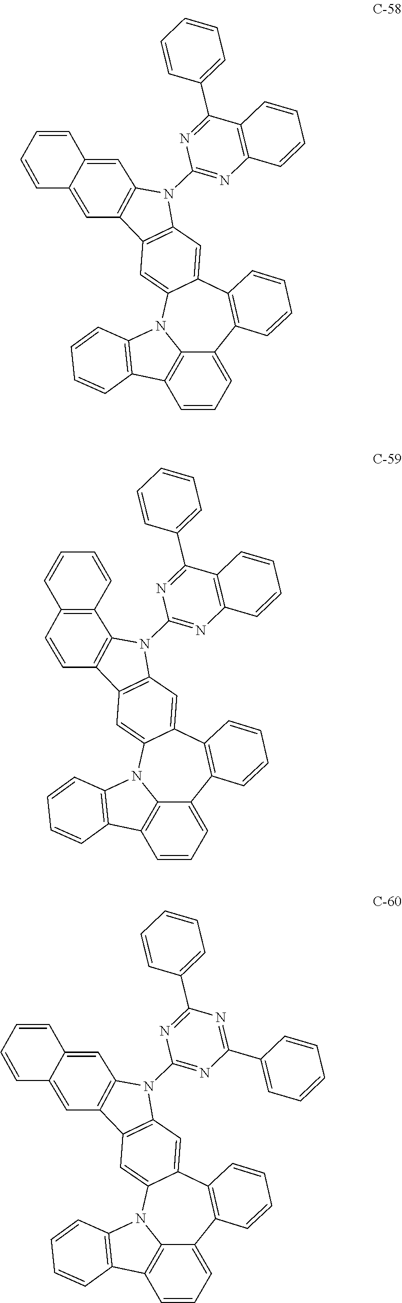 [SMILES: c1ccc(-c2nc(-n3c4cc5c(cc4c4cc6ccccc6cc43)-n3c4ccccc4c4cccc(c43)-c3ccccc3-5)nc3ccccc23)cc1 ; c1ccc(-c2nc(-n3c4cc5c(cc4c4ccc6ccccc6c43)-n3c4ccccc4c4cccc(c43)-c3ccccc3-5)nc3ccccc23)cc1 ; c1ccc(-c2nc(-c3ccccc3)nc(-n3c4cc5c(cc4c4cc6ccccc6cc43)-n3c4ccccc4c4cccc(c43)-c3ccccc3-5)n2)cc1]

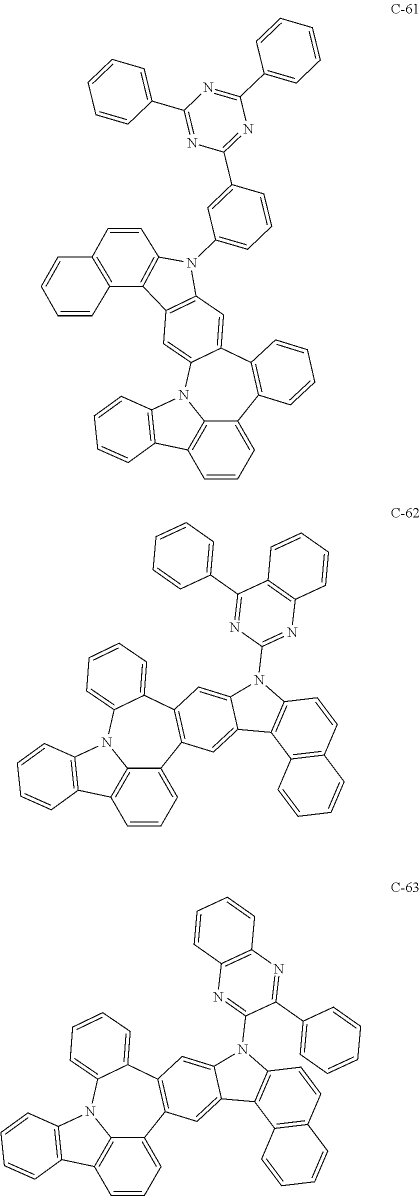 [SMILES: c1ccc(-c2nc(-c3ccccc3)nc(-c3cccc(-n4c5cc6c(cc5c5c7ccccc7ccc54)-n4c5ccccc5c5cccc(c54)-c4ccccc4-6)c3)n2)cc1 ; c1ccc(-c2nc(-n3c4cc5c(cc4c4c6ccccc6ccc43)-c3cccc4c6ccccc6n(c34)-c3ccccc3-5)nc3ccccc23)cc1 ; c1ccc(-c2nc3ccccc3nc2-n2c3cc4c(cc3c3c5ccccc5ccc32)-c2cccc3c5ccccc5n(c23)-c2ccccc2-4)cc1]

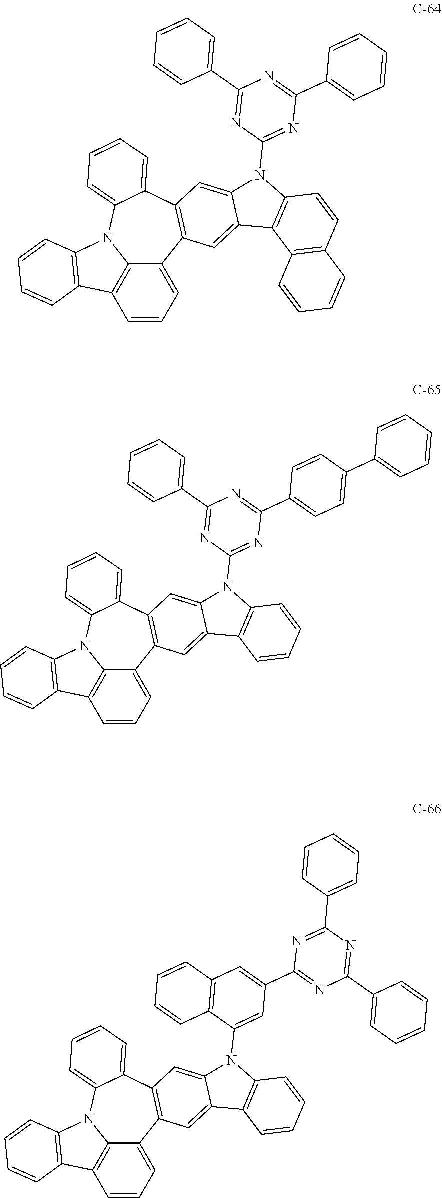 [SMILES: c1ccc(-c2nc(-c3ccccc3)nc(-n3c4cc5c(cc4c4c6ccccc6ccc43)-c3cccc4c6ccccc6n(c34)-c3ccccc3-5)n2)cc1 ; c1ccc(-c2ccc(-c3nc(-c4ccccc4)nc(-n4c5ccccc5c5cc6c(cc54)-c4ccccc4-n4c5ccccc5c5cccc-6c54)n3)cc2)cc1 ; c1ccc(-c2nc(-c3ccccc3)nc(-c3cc(-n4c5ccccc5c5cc6c(cc54)-c4ccccc4-n4c5ccccc5c5cccc-6c54)c4ccccc4c3)n2)cc1]

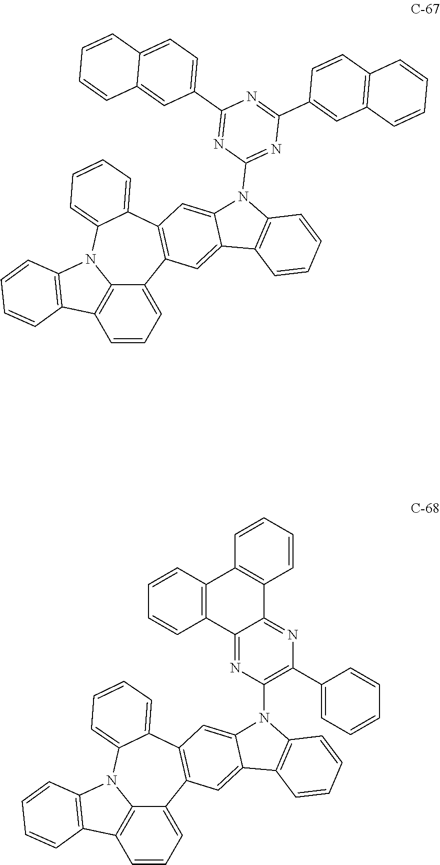 [SMILES: c1ccc2c(c1)-c1cc3c(cc1-c1cccc4c5ccccc5n-2c14)c1ccccc1n3-c1nc(-c2ccc3ccccc3c2)nc(-c2ccc3ccccc3c2)n1 ; c1ccc(-c2nc3c4ccccc4c4ccccc4c3nc2-n2c3ccccc3c3cc4c(cc32)-c2ccccc2-n2c3ccccc3c3cccc-4c32)cc1]

6. An organic electroluminescent device comprising the organic electroluminescent compound according to claim 1.
